(19) United States
(12) Patent Application Publication
(10) Pub. No.: US 2021/0298243 A1
(43) Pub. Date: Sep. 30, 2021

(54) UV-B INDUCED PLANT PATHOGEN RESISTANCE

(71) Applicant: Biolumic Limited, Palmerston North (NZ)

(72) Inventors: Emily Smith, Palmerston North (NZ); Jason WARGENT, Palmerston North (NZ)

(21) Appl. No.: 17/315,012

(22) Filed: May 7, 2021

Related U.S. Application Data
(63) Continuation of application No. PCT/IB2019/001422, filed on Nov. 8, 2019.
(60) Provisional application No. 62/758,324, filed on Nov. 9, 2018.

(51) Int. Cl. A01G 7/04; A01C 1/02; A01G 22/00

(52) U.S. Cl. CPC A01G 7/045; A01G 22/00; A01C 1/02

(57) ABSTRACT

Provided herein are methods, compositions, and devices relating to administration of UV-B to a plant seed, plant seedling, or plant material to reduce disease and induce disease resistance.

### CROSS-REFERENCE

This application is a continuation of International Patent Application No. PCT/IB2019/001422, filed on Nov. 8, 2019 which claims the benefit of U.S. Provisional Application No. 62/758,324 filed on Nov. 9, 2018, which is incorporated herein by reference in its entirety.

### BACKGROUND

There is an important societal and commercial impetus to find ways of improving yield and quality of crops, primarily for human consumption in a safe and sustainable manner. There is an aim to move away from chemical agents or pesticides. The method of treating plant material for sowing with UV-B irradiation is described as an effective method in reducing disease and improving pathogen resistance.

### BRIEF SUMMARY

The disclosure is summarized in part by the claims as attached hereto. It is understood that the disclosure further encompasses material not explicitly recited in the claims attached hereto, and that alternate claim language is consistent with and supported by the disclosure herein.

Provided herein are methods for reducing disease in a crop, comprising: administering light enriched for UV-B to a seed or seedling at least 1 day prior to disease exposure, wherein a dose of UV-B is administered in a range of about 0.1 kJ m⁻² h⁻¹ to about 20 kJ m⁻² h⁻¹; and wherein disease incidence, symptoms of disease, disease severity, disease damage, or combinations thereof is reduced by at least about 5%. Further provided herein are methods further comprising concurrently priming the seed using a priming medium and administering the light enriched for the UV-B. Further provided herein are methods, wherein the priming medium is water, polyethylene glycol, or a combination thereof. Further provided herein are methods, wherein the light enriched for UV-B comprises a wavelength in a range of about 280 nm to about 290 nm. Further provided herein are methods, wherein the light enriched for UV-B comprises a wavelength peaking at 280 nm. Further provided herein are methods, wherein the light enriched for UV-B comprises a wavelength peaking at 300 nm. Further provided herein are methods, wherein the dose of UV-B is in a range of about 0.3 kJ m⁻² h⁻¹ to about 3.0 kJ m⁻² h⁻¹. Further provided herein are methods, wherein the dose of UV-B is in a range of about 2.0 kJ m⁻² h⁻¹ to about 12.0 kJ m⁻² h⁻¹. Further provided herein are methods, wherein the dose of UV-B is in a range of about 0.1 kJ m⁻² h⁻¹ to about 1.0 kJ m⁻² h⁻¹. Further provided herein are methods, wherein the dose of UV-B is about 0.1 kJ m⁻² h⁻¹, about 0.2 kJ m⁻² h⁻¹, about 0.3 kJ m⁻² h⁻¹, about 0.4 kJ m⁻² h⁻¹, about 0.5 kJ m⁻² h⁻¹, about 0.6 kJ m⁻² h⁻¹, about 0.7 kJ m⁻² h⁻¹, about 0.8 kJ m⁻² h⁻¹, about 0.9 kJ m⁻² h⁻¹, or about 1.0 kJ m⁻² h⁻¹. Further provided herein are methods, wherein the light enriched for UV-B comprises a dose of UV-B in a range of about 2 kJ m⁻² d⁻¹ to about 10 kJ m⁻² d⁻¹. Further provided herein are methods, wherein the light enriched for UV-B comprises a dose of UV-B in a range of about 1.2 kJ m⁻² d⁻¹ to about 7 kJ m⁻² d⁻¹. Further provided herein are methods, wherein a duration of administering UV-B is at least 10 hours, at least 15 hours, at least 20 hours, at least 25 hours, or at least 30 hours. Further provided herein are methods, wherein a duration of administering UV-B is at least 1 day or at least 14 days. Further provided herein are methods, wherein a duration of administering UV-B is about 1 day, about 2 days, about 3 days, about 4 days, about 5 days, about 6 days, or about 7 days. Further provided herein are methods, wherein a photoperiod of the light administered is 10 hours. Further provided herein are methods, wherein the light enriched for UV-B is administered at least 2 days, 3 days, 4 days, 5 days, 6 days, 7 days, 8 days, 9 days, or 10 days prior to the disease exposure. Further provided herein are methods, wherein the disease incidence, symptoms of disease, disease severity, disease damage, or combinations thereof is reduced by at least about 10%, at least about 15%, at least about 30%, at least about 50%, or at least about 80%. Further provided herein are methods, wherein sporulation is reduced, number of spores released is reduced, or a combination thereof. Further provided herein are methods, wherein the sporulation, the number of spores released, or the combination thereof is reduced by at least about 10%, at least about 15%, at least about 30%, at least about 50%, or at least about 80%. Further provided herein are methods, wherein the disease incidence is reduced at least 1 day, 2 days, 3 days, 4 days, 5 days, 6 days, 7 days, 8 days, 9 days, 10 days, 11 days, 12 days, 13 days, or 14 days post exposure. Further provided herein are methods, wherein the disease is caused by a bacterium, insect pathogen, or combinations thereof. Further provided herein are methods, wherein the disease exposure occurs after the seed is sown. Further provided herein are methods, wherein administering light enriched for UV-B induces an increase in expression of one or more metabolites. Further provided herein are methods, wherein the one or more metabolites is a phenolic compound. Further provided herein are methods, wherein the one or more metabolites is a flavonoid. Further provided herein are methods, wherein the one or more metabolites is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), methyl 9-(alpha-D-galactosyloxy)nonanoate, or combinations thereof. Further provided herein are methods, wherein the one or more metabolites is quercetin 3-O (6-malonyl)-glucoside, kaempferol-3 glucuronide, 1,3 dicaffeolyquinic acid, or chlorogenic acid.

Provided herein are methods for reducing disease propagation from a first plant to a second plant, comprising: a) administering light enriched for UV-B to a first plant material; b) administering light enriched for UV-B to a second plant material; c) sowing the first plant material; and d) sowing the second material in proximity to the first plant material, wherein the disease propagation between the first plant to the second plant is reduced by at least 50%. Provided herein are methods for improving subsequent plant performance, comprising: determining whether a plant material will be susceptible to disease by: obtaining or having obtained the plant material, wherein the plant material is administered light enriched for UV-B; and performing or having performed an assay on the plant material to determine expression of one or more metabolites; and if the plant material has expression of the one or more metabolites above a threshold expression of the one or more metabolites derived from a cohort of plant material not administered light enriched for UV-B, then sowing the plant material. Further provided herein are methods, wherein the plant material is a seed or seedling. Further provided herein are methods, wherein the one or more metabolites is a phenolic compound. Further provided herein are methods, wherein the one or more metabolites is a flavonoid. Further provided herein are methods, wherein the one or more metabolites is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), methyl 9-(alpha-D-galactosyloxy)nonanoate, or combinations thereof. Further provided herein are methods, wherein the one or more metabolites is quercetin 3-O (6-malonyl)-glucoside, kaempferol-3 glucuronide, 1,3 dicaffeolyquinic acid, or chlorogenic acid. Further provided herein are methods, wherein the threshold expression is a percentage increase in the expression of the one or more metabolites as compared to the one or more metabolites derived from a cohort of plant material not administered light enriched for UV-B. Further provided herein are methods, wherein the percentage increase is at least 30%. Further provided herein are methods, wherein the threshold expression is a flavonoid index. Further provided herein are methods, wherein the light enriched for UV-B comprises a wavelength in a range of about 280 nm to about 290 nm. Further provided herein are methods, wherein the light enriched for UV-B comprises a wavelength peaking at 280 nm. Further provided herein are methods, wherein the light enriched for UV-B comprises a wavelength peaking at 300 nm. Further provided herein are methods, wherein a dose of UV-B is in a range of about 0.1 kJ m⁻² h⁻¹ to about 20 kJ m⁻² h⁻¹. Further provided herein are methods, wherein a duration of administering UV-B is at least 10 hours, at least 15 hours, at least 20 hours, at least 25 hours, or at least 30 hours. Further provided herein are methods, wherein a duration of administering UV-B is in a range of about 1 day, about 2 days, about 3 days, about 4 days, about 5 days, about 6 days, or about 7 days. Further provided herein are methods, wherein the light enriched for UV-B comprises a dose of UV-B in a range of about 1.2 kJ m⁻² d⁻¹ to about 7 kJ m⁻² d⁻¹. Further provided herein are methods, wherein a photoperiod of the light administered is 10 hours. Further provided herein are methods, wherein the light comprises blue light, red light, or a combination thereof. Further provided herein are methods, wherein the plant performance comprises reduction in disease incidence, reduction in symptoms of disease, reduction in disease severity, reduction in disease damage, or combinations thereof. Further provided herein are methods, wherein the reduction in disease incidence, reduction in symptoms of disease, reduction in disease severity, reduction in disease damage, or combinations thereof comprises a reduction by at least about 5%, at least about 10%, at least about 15%, at least about 30%, at least about 50%, or at least about 80%. Further provided herein are methods, wherein the disease is caused by a bacterium, insect, pathogen, or combinations thereof.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings.

FIG. 1 depicts a schema for how UV light can control valuable traits in agriculture.

FIG. 2 depicts a schema for multiple UV-B response pathways of plants.

FIG. 3 depicts a schema for mechanisms by which UV-B induces morphogenic changes through a UVR8 dependent pathway.

FIG. 4 depicts a schema of defensive features of a plant induced in response to UV-B.

FIG. 5 depicts an analysis of a relationship between UV-B dose and tolerance subsequent infection.

FIG. 6 depicts a graph of reduced disease severity in UV-B pre-treated seedlings.

FIG. 7 depicts a graph of a relationship between flavonoid level and spore count.

FIG. 8 depicts a graph of the effect of UV-B treatment on the intensity quercetin 3-O (6-malonyl)-glucoside levels.

FIG. 9 depicts an analysis of the correlation between quercetin 3-O (6-malonyl)-glucoside and spore count.

FIG. 10 depicts a graph of the effect of quercetin 3-O (6-malonyl)-glucoside infiltration on spore count.

FIG. 11 depicts a graph of the effect of UV-B treatment on the intensity of kaempferol-3 glucuronide.

FIG. 12 depicts an analysis of the correlation between kaempferol-3 glucuronide levels and spore count.

FIG. 13 depicts a graph of the effect of UV-B treatment on intensity of 1,3 dicaffeoylquinic acid.

FIG. 14 depicts an analysis of the correlation between 1,3 dicaffeoylquinic acid and spore count.

FIG. 15 depicts a graph of the effect of UV-B treatment on intensity of chlorogenic acid.

FIG. 16 depicts an analysis of the correlation between chlorogenic acid and spore count.

FIG. 17 depicts a scree plot comparing eigenvalues against component number.

FIG. 18 depicts a graph of principle component analysis of LC-MS metabolomic data.

FIG. 19 depicts a graph of the intensity levels of a representative pattern of one metabolomic feature in various UV-B treated and untreated cultivars.

FIG. 20 depicts a graph of the intensity levels of a representative pattern of one metabolomic feature in different UV-B treated and untreated cultivars with high levels in UV-B treated El Dorado cultivar.

FIG. 21 depicts a graph of the intensity levels of a representative pattern of two metabolomic feature in various UV-B treated and untreated cultivars.

FIG. 22 depicts an analysis of the correlation between feature 19j intensity and spore count.

FIG. 23 depicts a graph of the intensity of feature 19j levels in UV-B treated and untreated lettuce.

FIG. 24 depicts an analysis of the correlation between feature 19h intensity and spore count.

FIG. 25 depicts a graph of the intensity of feature 19h levels in UV-B treated and untreated lettuce.

FIG. 26 depicts a graph of the intensity levels of a representative pattern of three metabolomic feature in various UV-B treated and untreated cultivars.

FIG. 27 depicts a graph of disease incidence in time in cultivars treated using various doses of UV-B radiation in a first experiment.

FIG. 28 depicts a graph of disease severity in cultivars treated using various doses of UV-B radiation in a first experiment.

FIGS. 29A-29B depict graphs of disease incidence over time in cultivars treated using various doses of UV-B radiation in a second experiment.

FIG. 30 depicts a graph of disease severity in cultivars treated using various doses of UV-B radiation in a second experiment.

FIG. 31 depicts an analysis of infectibility in cultivars treated using various doses of UV-B radiation in a second experiment.

FIG. 32 depicts graphs of disease incidence over time in cultivars treated using various doses of UV-B radiation in a third experiment.

FIG. 33 depicts a graph of disease severity in cultivars treated using various doses of UV-B radiation in a third experiment.

FIG. 34 depicts a graph of the disease severity progression rate in cultivars treated using various doses of UV-B radiation in a third experiment.

FIG. 35 depicts an analysis of infectibility in cultivars treated using various doses of UV-B radiation in a third experiment.

FIG. 36 depicts a graph of disease incidence over time in cultivars treated using various dose of UV-B radiation in a fourth experiment.

FIG. 37 depicts a graph of disease severity in cultivars treated using various doses of UV-B radiation in a fourth experiment.

FIG. 38 depicts a graph of disease severity progression rate in cultivars treated using various doses of radiation in a fourth experiment.

FIG. 39 depicts an analysis of infectibility in cultivars treated using various doses of UV-B radiation in a fourth experiment.

FIG. 40 depicts a graph of spore count in UV-B treated and untreated cultivars.

FIG. 41 depicts a graph of disease incidence in UV-B treated and untreated plants from a secondary infection assay.

FIG. 42 depicts an analysis of degree of infection reduction in UV-B treated and untreated plants from a secondary infection assay.

FIG. 43 depicts a graph of damage ratings of UV-B treated and untreated plants from a secondary infection assay.

FIG. 44 depicts a graph of pooled number of spores harvested per lettuce cultivar.

FIG. 45 depicts an analysis of the correlation between flavonoid index and number of spores per plant.

FIG. 46 depicts an analysis of the correlation between levels of flavonoids and number of spores per plant.

FIG. 47 depicts an analysis of the correlation between spore count and flavonoid in both UV-B treated and untreated plants.

FIGS. 48A-48B depict graphs of the intensity of identified secondary metabolite compounds in response to UV treatment in multiple lettuce cultivars.

FIGS. 49A-49B depict graphs of the correlation of intensity of features with spore count in UV-B treated and untreated cultivars.

FIG. 50 depicts a graph of the levels of spores in UV-B treated and untreated plants across various genotypes.

FIG. 51 depicts a graph of results of injecting compounds into leaves on disease suppression.

FIG. 52 depicts an exemplary device for administering UV-B.

FIG. 53 depicts a second exemplary device for administering UV-B.

FIG. 54 depicts a computer system consistent with the disclosure herein.

### DETAILED DESCRIPTION

Disclosed herein are methods, devices, and recipes for treating a plant seed, a plant seedling, or other plant material to reduce disease in subsequent crops or plants. Methods, devices, and recipes described herein comprise administering ultraviolet (UV) irradiation prior to sowing. In some instances, light enriched for UV-B is administered.

UV-B Administration

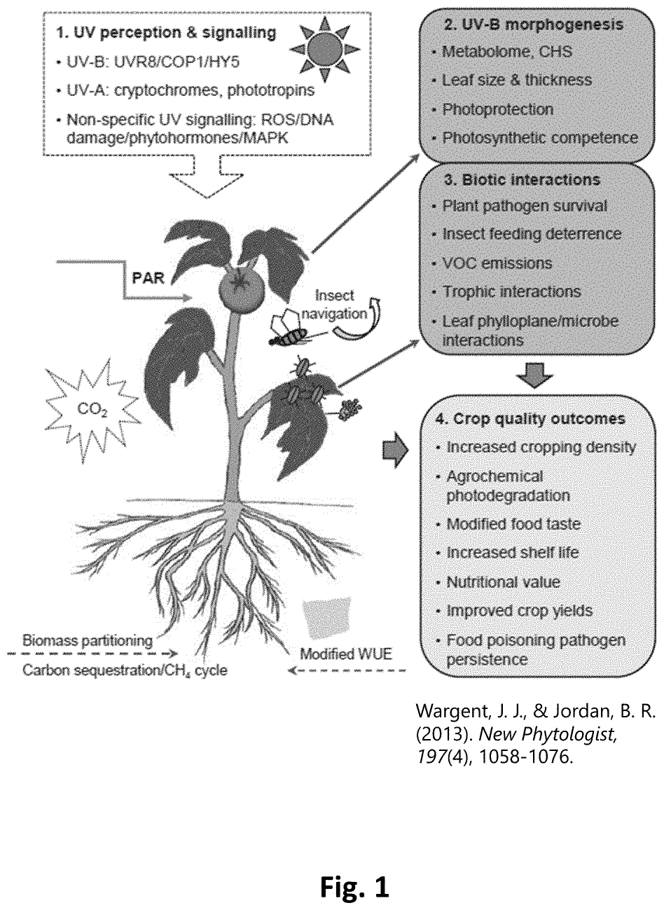

The UV-B response in plants is mostly a protective response. See FIG. 1. UV-B is a short wavelength, high energy waveband. High levels can damage the plant (e.g. DNA damage). As UV levels increase, e.g. winter to spring, flavonoids are increased to absorb UV light and protect the plant. The UV-B response affects the agronomical traits of the plant. The UV-B response can result in an increase to flavonoids, which affects taste, nutrition, pathogen resistance, and insect deterrence. The UV-B response can also produce plants that are smaller, more uniform size hardier, and have increased crop density. The dose of UV-B will greatly influence whether positive or negative traits are achieved.

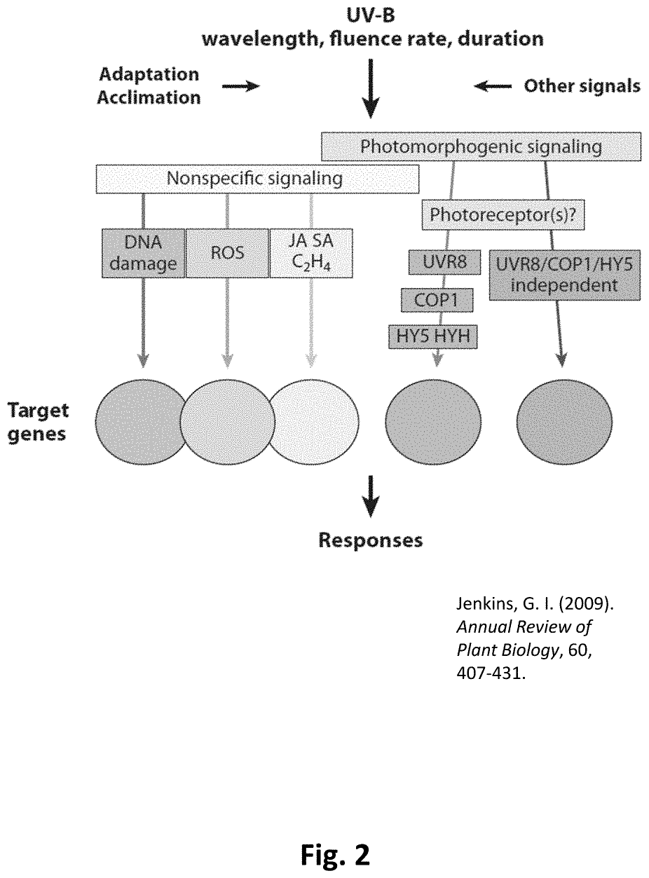

In some instances, UV-B dose is a mixture of wavelength (between 280 nm and 310 nm), fluence rate, and duration. For example, a short wavelength with a low intensity over a low time period can cause a morphogenic does but increase the intensity or duration and it will quickly result in a wounding response. As the plant increase UV-B protectants (acclimation), higher doses, in some instances, are required to induce a response. There are two major pathways, non-specific and specific/photomorphogenic. See FIG. 2. The nonspecific pathway is comparable to a wounding pathway and is thought to involve ROS signaling, the formation of pyrimidine dimers and MAPK cascade. The nonspecific pathway results in reduced plant size, increased JA/SA as well as PR proteins. The specific/photomorphogenic pathway uses photoreceptors to induce the phenylpropanoid pathway and other reduction of plant size in a more conservative way. Although it is suggested photoropins can sense UV-B light, there is only one known UV-B specific photoreceptor: UVR8.

Methods as described herein comprise administration of UV-B in a range of about 280 nm to about 320 nm. In some cases, UV-B is administered at 280 nm (±5 nm), 286 nm (±5 nm), 294 nm (±5 nm), or about 317 nm. The UV-B can be about 280 nm, about 281 nm, about 282 nm, about 283 nm, about 284 nm, about 285 nm, about 286 nm, about 287 nm, about 288 nm, about 289 nm, about 290 nm, about 291 nm, about 292 nm, about 293 nm, about 294 nm, about 295 nm, about 296 nm, about 297 nm, about 298 nm, about 299 nm, about 300 nm, about 301 nm, about 302 nm, about 303 nm, about 304 nm, about 305 nm, about 306 nm, about 307 nm, about 308 nm, about 309 nm, about 310 nm, about 311 nm, about 312 nm, about 313 nm, about 314 nm, about 315 nm, about 316 nm, about 317 nm, about 318 nm, about 319 nm, or about 320 nm. In some cases, UV-B is peaking at 280 nm (±5 nm), 286 nm (±5 nm), 294 nm (±5 nm), or about 317 nm. The UV-B can be peaking at about 280 nm, about 281 nm, about 282 nm, about 283 nm, about 284 nm, about 285 nm, about 286 nm, about 287 nm, about 288 nm, about 289 nm, about 290 nm, about 291 nm, about 292 nm, about 293 nm, about 294 nm, about 295 nm, about 296 nm, about 297 nm, about 298 nm, about 299 nm, about 300 nm, about 301 nm, about 302 nm, about 303 nm, about 304 nm, about 305 nm, about 306 nm, about 307 nm, about 308 nm, about 309 nm, about 310 nm, about 311 nm, about 312 nm, about 313 nm, about 314 nm, about 315 nm, about 316 nm, about 317 nm, about 318 nm, about 319 nm, or about 320 nm. In some instances, the UV-B is administered or peaking in a range of about 280 nm to about 290 nm, about 280 nm to about 300 nm, about 280 nm to about 310 nm, about 280 nm to about 320 nm, about 290 nm to about 300 nm, about 290 nm to about 310 nm, about 290 nm to about 320 nm, about 300 nm to about 310 nm, about 300 nm to about 320 nm, or about 310 nm to about 320 nm. In some instances, the UV-B is administered or peaking in a range of 280 nm (±5 nm) to 284 nm (±5 nm), 279 nm (±5 nm) to about 288 nm, about 289 nm to about 300 nm, or 286 nm (±5 nm) to about 305 nm. In some instances, UV-B is peaking at 280 nm. In some instances, UV-B is peaking at 300 nm.

Optionally, the wavelength within the 280-310 nm range during the method treatment for a given plant species is altered. In some instances, a combination of different wavelengths within the UV-B spectrum is concurrently used.

In some instances, LED lights are configured to administer a peak irradiance wavelength of light, for instance center around 280 nm or 300 nm. In some instances, the light source is a LED. Often LED lights are configured to administer a peak irradiance wavelength of light, for instance at about 280 nm, a range within 10 nm, 9 nm, 8 nm, 7 nm, 6 nm, 5 nm, 4 nm, 3 nm, 2 nm, or 1 nm of 280 nm, or exactly 280 nm, at about 300 nm, a range within 10 nm, 9 nm, 8 nm, 7 nm, 6 nm, 5 nm, 4 nm, 3 nm, 2 nm, or 1 nm of 300 nm, or exactly 300 nm. Alternately, LED lights are configured to administer light at a standard white light spectrum which is supplemented by light in the UV-B range, for example at about 280 nm, a range within 10 nm, 9 nm, 8 nm, 7 nm, 6 nm, 5 nm, 4 nm, 3 nm, 2 nm, or 1 nm of 280 nm, or exactly 280 nm, at about 286 nm, a range within 10 nm, 9 nm, 8 nm, 7 nm, 6 nm, 5 nm, 4 nm, 3 nm, 2 nm, or 1 nm of 286 nm, or exactly 286 nm.

Various doses of UV-B are contemplated herein. In some instances, the dose is about 0.1 kJ m⁻² h⁻¹ to about 20 kJ m⁻² h⁻¹. In some instances, the dose is about 0.1 kJ m⁻² h⁻¹ to about 1.0 kJ m⁻² h⁻¹. In some instances, the dose is about 0.01 kJ m⁻² h⁻¹, about 0.025 kJ I11⁻² h⁻¹, about 0.050 kJ m⁻² h⁻¹, about 0.10 kJ m⁻² h⁻¹, 0.3 kJ m⁻² h⁻¹, about 0.5 kJ m⁻² h⁻¹, about 1.0 kJ m⁻² h⁻¹, about 1.5 kJ m⁻² h⁻¹, about 2.0 kJ m⁻² h⁻¹, about 2.5 kJ m⁻² h⁻¹, about 3.0 kJ m⁻² h⁻¹, about 3.5 kJ m⁻² h⁻¹, about 4.0 kJ m⁻² h⁻¹, about 4.5 kJ m⁻² h⁻¹, about 5.0 kJ m⁻² h⁻¹, about 5.5 kJ m⁻² h⁻¹, about 6.0 kJ m⁻² h⁻¹, about 7.0 kJ m⁻² h⁻¹, about 8.0 kJ m⁻² h⁻¹, about 9.0 kJ m⁻² h⁻¹, about 10.0 kJ m⁻² h⁻¹, about 11.0 kJ m⁻² h⁻¹, or about 12.0 kJ m⁻² h⁻¹. In some instances, the dose is at least or about 0.1 kJ m⁻² h⁻¹, 0.3 kJ m⁻² h⁻¹, 0.5 kJ m⁻² h⁻¹, 0.7 kJ m⁻² h⁻¹, 1.0 kJ m⁻² h⁻¹, 1.5 kJ m⁻² h⁻¹, 2.0 kJ m⁻² h⁻¹, 2.5 kJ m⁻² h⁻¹, 3.0 kJ m⁻² h⁻¹, 3.5 kJ m⁻² h⁻¹, 4.0 kJ m⁻² h⁻¹, 4.5 kJ m⁻² h⁻¹, 5.0 kJ m⁻² h⁻¹, 5.5 kJ m⁻² h⁻¹, 6.0 kJ m⁻² h⁻¹, 6.5 kJ m⁻² h⁻¹, 7.0 kJ m⁻² h⁻¹, 7.5 kJ m⁻² h⁻¹, 8.0 kJ m⁻² h⁻¹ to at least or about 9.0 kJ m⁻² h⁻¹, 9.5 kJ m⁻² h⁻¹, 10.0 kJ m⁻² h⁻¹, 11 kJ m⁻² h⁻¹, 12 kJ m⁻² h⁻¹, 13 kJ m⁻² h⁻¹, 14 kJ m⁻² h⁻¹, 15 kJ m⁻² h⁻¹, 16 kJ m⁻² h⁻¹, 18 kJ m⁻² h⁻¹, 20 kJ m⁻² h⁻¹, 22 kJ m⁻² h⁻¹, 24 kJ m⁻² h⁻¹, 26 kJ m⁻² h⁻¹, 28 kJ m⁻² h⁻¹, 30 kJ m⁻² h⁻¹. In some instances, the dose of UV-B is in a range of about 0.3 kJ m⁻² h⁻¹ to about 3.0 kJ m⁻² h⁻¹. In some instances, the dose of UV-B is in a range of about 2.0 kJ m⁻² h⁻¹ to about 12.0 kJ m⁻² h⁻¹.

In some instances, the dose is about 0.1 kJ m⁻² d⁻¹ to about 20 kJ m⁻² d⁻¹. In some instances, the dose is 0.3 kJ m⁻² d⁻¹, about 0.5 kJ m⁻² d⁻¹, about 1.0 kJ m² d⁻¹, about 1.5 kJ m² d⁻¹, about 2.0 kJ m⁻² d⁻¹, about 2.5 kJ m⁻² d⁻¹, about 3.0 kJ m⁻² d⁻¹, about 3.5 kJ m⁻² d⁻¹, about 4.0 kJ m⁻² d⁻¹, about 4.5 kJ m⁻² d⁻¹, about 5.0 kJ m⁻² d⁻¹, about 5.5 kJ m⁻² d⁻¹, about 6.0 kJ m⁻² d⁻¹, about 7.0 kJ m⁻² d⁻¹, about 8.0 kJ m⁻² d⁻¹, about 9.0 kJ m⁻² d⁻¹, about 10.0 kJ m⁻² d⁻¹, about 11.0 kJ m⁻² d⁻¹, or about 12.0 kJ m⁻² d⁻¹. In some instances, the dose is at least or about 0.1 kJ m⁻² d⁻¹, 0.3 kJ m⁻² d⁻¹, 0.5 kJ m⁻² d⁻¹, 0.7 kJ m⁻² d⁻¹, 1.0 kJ m⁻² d⁻¹, 1.5 kJ m⁻² d⁻¹, 2.0 kJ m⁻² d⁻¹, 2.5 kJ m⁻² d⁻¹, 3.0 kJ m⁻² d⁻¹, 3.5 kJ m⁻² d⁻¹, 4.0 kJ m⁻² d⁻¹, 4.5 kJ m⁻² d⁻¹, 5.0 kJ m⁻² d⁻¹, 5.5 kJ m⁻² d⁻¹, 6.0 kJ m⁻² d⁻¹, 6.5 kJ m⁻² d⁻¹, 7.0 kJ m⁻² d⁻¹, 7.5 kJ m⁻² d⁻¹, 8.0 kJ m⁻² d⁻¹ to at least or about 9.0 kJ m⁻² d⁻¹, 9.5 kJ m⁻² d⁻¹, 10.0 kJ m⁻² d⁻¹, 11 kJ m⁻² d⁻¹, 12 kJ m² d⁻¹, 13 kJ m⁻² d⁻¹, 14 kJ m⁻² d⁻¹, 15 kJ m⁻² d⁻¹, 16 kJ m⁻² d⁻¹, 18 kJ m⁻² d⁻¹, 20 kJ m⁻² d⁻¹, 22 kJ m⁻² d⁻¹, 24 kJ m⁻² d⁻¹, 26 kJ m⁻² d⁻¹, 28 kJ m⁻² d⁻¹, 30 kJ m⁻² d⁻¹. In some instances, the dose of UV-B is in a range of about 0.3 kJ m⁻² d⁻¹ to about 3.0 kJ m⁻² d⁻¹. In some instances, the dose of UV-B is in a range of about 2.0 kJ m⁻² d⁻¹ to about 12.0 kJ m⁻² d⁻¹.

Various irradiances of UV-B may be used. In some instances, the irradiance of UV-B is at least or about 0.01 μmol m⁻² s⁻¹, 0.02 μmol m⁻² s⁻¹, 0.05 μmol m⁻² s⁻¹, 0.075 μmol m⁻² s⁻¹, 0.10 μmol m⁻² s⁻¹, 0.2 μmol m⁻²s⁻¹, 0.5 μmol m⁻² s⁻¹, 0.75 μmol m² s⁻¹, 1.0 μmol m² s⁻¹, 1.5 μmol m⁻² s⁻¹, 2.0 μmol m⁻² s⁻¹, 2.5 μmol m⁻² s⁻¹, 3.0 μmol m⁻² s⁻¹, 3.5 μmol m⁻² s⁻¹, or 4.0 μmol m⁻² s⁻¹. In some instances, the irradiance of UV-B is in a range of about 0.01 μmol m⁻² s⁻¹ to about 1.0 μmol m⁻² s⁻¹. In some instances, the irradiance of UV-B is about 0.1 μmol m² s⁻¹, about 0.2 μmol m² s⁻¹, about 0.3 μmol m⁻² s⁻¹, about 0.4 μmol m⁻² s⁻¹, about 0.5 μmol m⁻² s⁻¹, about 0.6 μmol m⁻² s⁻¹, about 0.7 μmol m⁻² s⁻¹, about 0.8 μmol m⁻² s⁻¹, about 0.9 μmol m⁻² s⁻¹, or about 1.0 μmol m⁻² s⁻¹.

A number of UV-B administration durations are consistent with the disclosure herein. For example, a length of time of UV-B irradiation is up to 72 hours, up to 60 hours, up to 48 hours, up to 36 hours, up to 24 hours, up to 23 hours, up to 22 hours, up to 21 hours, up to 20 hours, up to 19 hours, up to 18 hours, up to 17 hours, up to 16 hours, up to 15 hours, up to 14 hours, up to 13 hours, up to 12 hours, up to 11 hours, up to 10 hours, up to 9 hours, up to 8 hours, up to 7 hours, up to 6 hours, up to 5 hours, up to 4 hours, up to 3 hours, up to 2 hours, up to 1 hour, or less than one hour. In some instances, UV-B treatment is about 1 hour, 2 hours, 3 hours, 4 hours, 5 hours, 6 hours, 7 hours, 8 hours, 9 hours, 10 hours, 12 hours, 14 hours, 16 hours, 18 hours, 20 hours, 24 hours, 30 hours, 32 hours, 50 hours, 72 hours, or more than 72 hours. Some treatments are for less than about or at least 1 minute, 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes, 30 minutes, 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, 44 minutes, 45 minutes, 46 minutes, 47 minutes, 48 minutes, 49 minutes, 50 minutes, 51 minutes, 52 minutes, 53 minutes, 54 minutes, 55 minutes, 56 minutes, 57 minutes, 58 minutes, 59 minutes, 60 minutes, or more than 60 minutes. In some instances, UV-B administration duration is in a range of about 0 hours to about 60 hours or about 5 hours to about 30 hours. In some instances, UV-B administration duration is at least or about 10 hours, 15 hours, 20 hours, 25 hours, or 30 hours. In some instances, UV-B treatment is about 1 day, 2 days, 3 days, 4 days, 5 days, 6 days, 7 days, 8 days, 9 days, 10 days, 12 days, 14 days, 16 days, 18 days, 20 days, 24 days, 30 days, 32 days, 50 days, 72 days, or more than 72 days. In some instances, UV-B treatment is in a range of about 1 day to about 30 days, about 2 days to about 25 days, about 4 days to about 20 days, about 6 days to about 18 days, or about 8 days to about 16 days. In some instances, UV-B treatment is about 5 days to about 20 days or about 2 days to about 30 days. In some instances, UV-B treatment is less than about 2 days. In some instances, UV-B treatment is more than about 30 days. In some instances, UV-B treatment is about 14 days.

Various dosages of UV-B are contemplated herein. In some instances, the dosage is in the range of about 0.01 kJ m⁻²to about 368 kJ m⁻². In some instances, the dosage is about 0.01 kJ m⁻²-368 kJ m⁻², 0.1 kJ m⁻²-300 kJ m⁻², 1 kJ m⁻²-250 kJ m⁻², 10 kJ m⁻²-200 kJ m⁻², 100 kJ m⁻²-150 kJ m⁻², 200 kJ m⁻²-300 kJ m², 250 kJ m⁻²-350 kJ m⁻², or 300 kJ m⁻²-368 kJ m⁻². In some instances, the dosage is in the range of about 0.1 to about 12 kJ m⁻². In some instances, the dosage is about 13 kJ m⁻². The light treatment may be at a dose of about 13 kJ m⁻², exactly 13 kJ m², or at least 13 kJ m⁻². In some instances, the dosage is about 37 kJ m⁻². In some instances, the dosage is about 69 kJ m⁻². In some instances, the dosage is about 78 kJ m⁻². In some instances, the dosage is about 98 kJ m⁻². In some instances, the dosage is about 100 kJ m⁻². The light treatment may be at a dose of about 100 kJ m⁻², exactly 100 kJ m⁻², or more than 100 kJ m⁻². In some instances, the dosage is about 125 kJ m⁻². In some instances, the dosage is about 204 kJ m⁻². The light treatment may be at a dose range of about 13 kJ m⁻² to 100 kJ m⁻². The UV-B can be at a dose in a range of about 1 kJ m⁻²-1000 kJ m⁻², 10 kJ m⁻²-800 kJ m⁻², 20 kJ m⁻²-600 kJ m⁻², 30 kJ m⁻²-400 kJ m⁻², 50 kJ m⁻²-200 kJ m⁻², 100 kJ m⁻²-150 kJ m⁻², 30 kJ m⁻²-60 kJ m⁻², or 150 kJ m⁻²-250 kJ m⁻². In some instances, the UV-B is in a range of 0 kJ m⁻²-20 kJ m⁻², 20 kJ m⁻²-40 kJ m⁻², 40 kJ m⁻²-60 kJ m⁻², 60 kJ m⁻²-80 kJ m⁻², or 80 kJ m⁻²-100 kJ m⁻².

UV-B administration may occur at a time prior to induction of disease. In some instances, UV-B administration occurs prior to disease exposure. In some instances, UV-B administration occurs prior to symptoms of a disease being visible. In some instances, UV-B administration occurs at least or about 1 day, 2 days, 3 days, 4 days, 5 days, 6 days, 7 days, 8 days, 9 days, 10 days, 12 days, 14 days, 16 days, 18 days, 20 days, 24 days, 30 days, 32 days, 50 days, 72 days, or more than 72 days prior to induction of disease, symptoms of a disease being visible, disease exposure, or combinations thereof. In some instances, UV-B administration occurs at least or about 1 week, 2 weeks, 3 weeks, 4 weeks, 5 weeks, 6 weeks, 7 weeks, 8 weeks, or more before prior to induction of disease, symptoms of a disease being visible, disease exposure, or combinations thereof.

Induction of disease, disease exposure, or symptoms of disease being visible may occur at a time following a plant seed, plant seedling, or plant material being sown. In some instances, induction of disease, disease exposure, or symptoms of disease occurs 1 day, 2 days, 3 days, 4 days, 5 days, 6 days, 7 days, 8 days, 9 days, 10 days, 12 days, 14 days, 16 days, 18 days, 20 days, 24 days, 30 days, 32 days, 50 days, 72 days, or more than 72 days after the plant seed, plant seedling, or plant material is sown. In some instances, UV-B administration occurs 1 day, 2 days, 3 days, 4 days, 5 days, 6 days, 7 days, 8 days, 9 days, 10 days, 12 days, 14 days, 16 days, 18 days, 20 days, 24 days, 30 days, 32 days, 50 days, 72 days, or more than 72 days before the plant seed, plant seedling, or plant material is sown. In some instances, UV-B administration occurs at least or about 1 week, 2 weeks, 3 weeks, 4 weeks, 5 weeks, 6 weeks, 7 weeks, 8 weeks, or more before the plant seed, plant seedling, or plant material is sown. In some instances, UV-B administration occurs in a range of about 1 day to about 30 days, about 2 days to about 25 days, about 4 days to about 20 days, about 6 days to about 18 days, or about 8 days to about 16 days before the plant seed, plant seedling, or plant material is sown.

UV-B administration may be accomplished in a single dose. In some embodiments, the UV-B administration is a single or multitude time point treatment. In cases of multitude time point treatment, UV-B administration may be separated by any appropriate interval. In some instances, UV-B administration is separated by intervals of less than, about, exactly, or at least 1 minute, 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes, 30 minutes, 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, 44 minutes, 45 minutes, 46 minutes, 47 minutes, 48 minutes, 49 minutes, 50 minutes, 51 minutes, 52 minutes, 53 minutes, 54 minutes, 55 minutes, 56 minutes, 57 minutes, 58 minutes, 59 minutes, or 60 minutes. In some instances, UV-B administration is separated by intervals of or less than, about, exactly or at least 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 24 hours, 25 hours, 26 hours, 27 hours, 28 hours, 29 hours, 30 hours, 31 hours, 32 hours, 33 hours, 34 hours, 35 hours, 36 hours, 37 hours, 38 hours, 39 hours, 40 hours, 41 hours, 42 hours, 43 hours, 44 hours, 45 hours, 46 hours, 47 hours, 48 hours, 49 hours, 50 hours, 51 hours, 52 hours, 53 hours, 54 hours, 55 hours, 56 hours, 57 hours, 58 hours, 59 hours, 60 hours, or more than 60 hours.

In some instances, the method includes exposing a plant seed, a plant seedling, or a plant material to cyclic exposure of UV-B light. For example, the UV-B exposure is provided as about 12 hours on, 12 hours off over a period of seven days. In some instances, the UV-B exposure is provided as about 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, or 23 hours on and 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, or 23 hours off. In some instances, the UV-B exposure is for a period of at least or about 1 day, 2 days, 3 days, 4 days, 5 days, 6 days, 7 days, 8 days, 9 days, 10 days, 11 days, 12 days, 13 days, or 14 days. In some instances, the UV-B exposure is for a period of at least or about 1 week, 2 weeks, 3 weeks, 4 weeks, 5 weeks, 6 weeks, 7 weeks, 8 weeks, or more. In another example, the UV-B exposure may be provided 10 minutes per day for a week. It should be appreciated that different conditions may suit different plant varieties and/or specific outcomes desired by the grower.

Cyclic exposure of UV-B light may comprise various numbers of cycles per day. In some instances, the number of cycles per day is at least or about 50, 100, 150, 200, 250, 300, 350, 400, 450, 500, 550, 600, 650, 700, 750, 800, 850, 900, 950, 1000, or more than 1000 cycles per day. In some instances, the number of cycles per day is in a range of about 50 to about 100, about 100 to about 900, about 200 to about 800, about 300 to about 700, or about 400 to about 600 cycles per day. In some instances, the number of cycles per day is in a range of about 380 to about 500 or about 250 to about 600 cycles per day. In some instances, the number of cycles per day is less than about 250 cycles per day. In some instances, the number of cycles per day is more than about 250 cycles per day. In some instances, the number of cycles per day is about 430 cycles per day. In some instances, the number of cycles per day is about 433 cycles per day.

Methods, devices, and recipes as described herein, in some embodiments, comprise administration of UV-B light for various photoperiods. In some instances, the photoperiod is at least or about 5 minutes, 10 minutes, 20 minutes, 30 minutes, 45 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, or 23 hours on and 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or 24 hours. In some instances, the photoperiod is in a range of about 5 minutes to about 20 hours, about 30 minutes to about 18 hours, about 1 hour to about 16 hours, or about 4 hours to about 12 hours. In some instances, the photoperiod is at least or about 5 minutes, 10 minutes, 20 minutes, 30 minutes, 45 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, or 23 hours on and 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or 24 hours for at least or about 1 day, 2 days, 3 days, 4 days, 5 days, 6 days, 7 days, 8 days, 9 days, 10 days, 11 days, 12 days, 13 days, or 14 days.

In some instances, a regularity of light exposure varies. In some instances, the light is enriched or supplemented using UV-B. In some instances, the light exposure is at least or about 20, 30, 40, 50, 60, 70, 80, 90, 100, 120, 140, 160, 180, 200, 220, 240, 260, 280, 300, 320, 340, 360, 380, 400, or more than 400 seconds. In some instances, the light exposure is in a range of about 20 to about 300, about 40 to about 200, about 60 to about 140, about 80 to about 100, or about 90 to about 180 seconds. In some instances, the light exposure is less than 20 seconds. In some instances, the light exposure is more than 300 seconds. In some instances, the light exposure is about 130 seconds. In some instances, the light exposure is about 133 seconds.

Described herein are methods for administering UV-B to a plant material, wherein the method includes maintaining the temperature in a range of about 12° C. to about 35° C. during the treatment. In some instances, the temperature is maintained at least or about 5° C., 6° C., 7° C., 8° C., 9° C., 10° C., 11° C., 12° C., 13° C., 14° C., 15° C., 16° C., 17° C., 18° C., 20° C., 22° C., 24° C., 26° C., 28° C., 30° C., 32° C., 34° C., 36° C., 38° C., 40° C., or more than 40° C. The temperature may be maintained in a range of about 5° C. to about 40° C., about 10° C. to about 30° C., or about 15° C. to about 25° C. In some instances, the temperature is maintained to avoid temperature damage to the seedlings during the treatment stage.

In some instances, when UV-B is co-administered with light of another wavelength, UV-B is enriched as compared to the light of another wavelength. In some instances, UV-B is enriched at least or about 15%, 20%, 25%, 30%, 35%, 40%, 45%, 50%, 60%, 70%, 80%, 90%, 100%, 125%, 150%, 175%, 200%, 225%, 250%, 275%, 300%, or more than 300% more than the light of another wavelength. In some instances, UV-B is supplemented. In some instances, UV-B is the predominant wavelength during light administration. In some instances, UV-B comprises at least or about 15%, 20%, 25%, 30%, 35%, 40%, 45%, 50%, 60%, 70%, 80%, 90%, 100% of light for light administration.

Described herein are methods for administering UV-B to a plant seed, a plant seedling, or a plant material, wherein the method, in some embodiments, comprises administration of visible light in the range of about 400 to about 800 nm. The visible light may be administered concurrently with the UV light, or separately. In some cases, visible light is administered at about or up to 500 μmol m⁻² s⁻¹. In some instances, visible light is administered at about or up to 400 μmol m⁻² s⁻¹, about or up to 300 μmol m⁻² s⁻¹, about or up to 200 μmol m⁻² s⁻¹, about or up to 100 μmol m⁻² s⁻¹, about or up to 50 μmol m⁻² s⁻¹, or about or less than 50 μmol m⁻² s⁻¹. Often visible light is administered at about 50 μmol m⁻² s⁻¹. In some instances, visible light is administered at about or up to 215 μmol m⁻² s⁻¹. In some cases, about 20 μmol m⁻² s⁻¹ of visible light is administered. Often the visible light can have a photon number in a range of 10 μmol m⁻² s⁻¹-550 μmol m⁻² s⁻¹, 20 μmol m⁻² s⁻¹-500 μmol m⁻² s⁻¹, 40 μmol m⁻² s⁻¹-450 μmol m⁻² s⁻¹, 45 μmol m⁻² s⁻¹-400 μmol m⁻² s¹, 50 μmol m⁻² s⁻¹-350 μmol m⁻² s⁻¹, 100 μmol m⁻² s⁻¹-300 μmol m⁻² s⁻¹, or 100 μmol m⁻² s⁻¹-200 μmol m⁻² s⁻¹.

Described herein are methods for administering UV-B to a plant seed, a plant seedling, or a plant material, wherein the method, in some embodiments, comprises administration of blue visible light. In some instances, blue visible light helps avoid possible deleterious effects of UV damage to DNA. In some instances, blue light is beneficial for photo-repair. In some instances, blue visible light or blue light is administered or is peaking in a range of about 450 (±5 nm) to about 500 nm or about 455 to about 492 nm. In some instances, blue visible light or blue light is administered or is peaking at least or about 430 nm, 435 nm, 440 nm, 445 nm, 450 nm, 455 nm, 460 nm, 465 nm, 470 nm, 475 nm, 480 nm, 485 nm, or 490 nm. In some instances, blue visible light or blue light is administered or is peaking in a range of 430 nm to 480 nm or 440 nm to 460 nm. In some instances, blue visible light or blue light is administered or is peaking at about 450 nm. In some instances, blue visible light or blue light is administered or is peaking at about 453 nm.

Irradiance of blue light includes, but is not limited to, 5, 10, 20 30, 40, 50, 60, 70, 80, 90, 100, 200, 300, 400, 500, 600, 700, 800, 900, 1000, 2000, 3000, 4000, 5000, 6000, or more than 6000 μmol m⁻² s⁻¹. The irradiance of blue light may be in a range of about 5 to about 5000, about 5 to about 2000, about 20 to about 800, about 40 to about 600, about 60 to about 400, about 80 to about 200, about 30 to about 130, or about 33 to about 133 μmol m⁻² s⁻¹. In some instances, the irradiance of blue light is about 60 μmol m⁻² s⁻¹. In some instances, the irradiance of blue light is about 66 μmol m⁻² s⁻¹.

Described herein are methods for administering UV-B to a plant seed, a plant seedling, or a plant material, wherein the method, in some embodiments, comprises administration of red visible light. In some instances, the benefits of red visible light are complementary effects on plant growth, such as regulation of stem growth. Red visible light or red light may be administered or is peaking in a range of about 655 to about 680 nm, about 620 nm to about 690 nm, or about 640 nm to about 680 nm. In some instances, red visible light or red light is administered or is peaking at 620 nm (±5 nm), about 630 nm, about 640 nm, about 660 nm, about 670 nm, about 680 nm, about 690 nm, about 700 nm, about 710 nm, about 720 nm, about 730 nm, about 740 nm, or about 750 nm (±5 nm). In some instances, red visible light or red light is administered or is peaking at about 660 nm. In some instances, red visible light or red light is administered or is peaking at about 659 nm.

Irradiance of red light includes, but is not limited to, 5, 10, 20 30, 40, 50, 60, 70, 80, 90, 100, 200, 300, 400, 500, 600, 700, 800, 900, 1000, 2000, 3000, 4000, 5000, 6000, or more than 6000 μmol m⁻² s⁻¹. The irradiance of red light may be in a range of about 5 to about 5000, about 30 to about 3000, about 20 to about 800, about 40 to about 600, about 60 to about 400, about 66 to about 266, about 70 to about 300, about 80 to about 200, or about 30 to about 130 limo' m⁻² s⁻¹. In some instances, the irradiance of red light is about 130 μmol m⁻² s⁻¹. In some instances, the irradiance of red light is about 133 μmol m⁻² s⁻¹.

UV-B Treatment for Reducing Disease

Described herein are methods, devices, and recipes for administering UV-B to a plant seed, plant seedling, plant material, or combinations thereof to reduce subsequent disease. In some instances, methods, devices, and recipes as described herein result in reduction in disease incidence, reduction in symptoms of disease, reduction in disease severity, reduction in sporulation, reduction in number of spores, reduction in disease propagation, or combinations thereof. In some instances, methods, devices, and recipes as described herein result in improved resistance in a subsequent crop or plant derived from a plant seed, plant seedling, or plant material treated using methods, devices, and recipes as described herein.

Methods, devices, and recipes as described herein, in some embodiments, result in reduction in disease incidence. In some instances, reduction in disease incidence comprises a delay in disease incidence. In some instances, the reduction in disease incidence comprises a reduction in a number of resultant plants or crops having the disease. In some instances, the reduction in disease incidence is at least or about 2%, 5%, 10%, 15%, 20%, 25%, 30%, 35%, 40%, 45%, 50%, 55%, 60%, 65%, 70%, 75%, 80%, 85%, 90%, 95%, or more than 95%. In some instances, the reduction in disease incidence is in the range of about 5%-100%, 10%-90%, 20%-80%, 30%-70%, 40%-60%, 50%-95%, 65%-85%, or 75%-95%. In some instances, the reduction in disease incidence is by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold. In some instances, disease incidence is delayed by at least or about 1 day, 2 days, 3 days, 4 days, 5 days, 6 days, 7 days, 2 weeks, 3 weeks, 1 month, 2 months, 3 months, 4 months, 6 months, 8 months, 12 months, or more than 12 months. In some instances, disease incidence is determined by a number of plants displaying disease symptoms divided by a total number of plants.

Reduction in symptoms of disease may result using methods, devices, and recipes as described herein. Symptoms of disease can be local or systemic. In some instances, the symptoms of disease are microscopic. In some instances, the symptoms of disease are macroscopic. Symptoms of disease can include, but are not limited to, leaf spots, galls, cankers, wilting, yellowing, discoloring, dwarfing, and necrosis. In some instances, the reduction in disease symptoms is at least or about 2%, 5%, 10%, 15%, 20%, 25%, 30%, 35%, 40%, 45%, 50%, 55%, 60%, 65%, 70%, 75%, 80%, 85%, 90%, 95%, or more than 95%. In some instances, the reduction in disease symptoms is in the range of about 5%-100%, 10%-90%, 20%-80%, 30%-70%, 40%-60%, 50%-95%, 65%-85%, or 75%-95%. In some instances, the reduction in disease symptoms is by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold.

Described herein are methods, devices, and recipes for reducing disease severity. In some instances, reduction in disease severity comprises delayed disease incidence, reduced visual disease rating, lower spore count, or combinations thereof. In some instances, disease incidence is determined by a percentage or number of plants infected. In some instances, the reduction in disease severity is at least or about 2%, 5%, 10%, 15%, 20%, 25%, 30%, 35%, 40%, 45%, 50%, 55%, 60%, 65%, 70%, 75%, 80%, 85%, 90%, 95%, or more than 95%. In some instances, the reduction in disease severity in the range of about 5%-100%, 10%-90%, 20%-80%, 30%-70%, 40%-60%, 50%-95%, 65%-85%, or 75%-95%. In some instances, the reduction in disease severity is by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold.

Reducing disease, in some embodiments, comprises a reduction in sporulation severity, reduction in number of spores, or a combination thereof. In some instances, methods, devices, and recipes as described herein result in a reduction of sporulation severity such that there are little or no signs of spores. In some instances, methods, devices, and recipes described herein result such that a percentage of spores covering one, two, three, or more than three leaves is about or no more than 10%, 15%, 20%, 25%, 30%, 35%,40%, 45%, 50%, 55%, or 60%. In some instances, the reduction in sporulation severity, reduction in number of spores, or a combination thereof is at least or about 2%, 5%, 10%, 15%, 20%, 25%, 30%, 35%, 40%, 45%, 50%, 55%, 60%, 65%, 70%, 75%, 80%, 85%, 90%, 95%, or more than 95%. In some instances, the reduction in sporulation severity, reduction in number of spores, or a combination thereof in the range of about 5%-100%, 10%-90%, 20%-80%, 30%-70%, 40%-60%, 50%-95%, 65%-85%, or 75%-95%. In some instances, the reduction in sporulation severity, reduction in number of spores, or a combination thereof is by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold.

Methods, devices, and recipes as described herein, in some embodiments, result in reduction in disease propagation. In some instances, a crop or plant sown from a plant seed, plant seedling, or plant material treated using UV-B according to methods described herein result in a limited spread of disease. In some instances, the spread of disease is reduced in each subsequent generation when a plant seed, plant seedling, or plant material is treated using UV-B. In some instances, each subsequent infection is further reduced as compared to the previous infection when a plant seed, plant seedling, or plant material is treated using UV-B. In some instances, the spread of disease is reduced between at least two plants, when the at least two plants are derived from a plant seed, plant seedling, or plant material treated using UV-B. For example, disease propagation is reduced from a first plant to a second plant when light enriched for UV-B is administered to a first seed, first seedling, or first plant material prior to sowing and when light enriched for UV-B is administered to a second seed, second seedling, or second plant material prior to sowing. In some instances, the disease propagation between the first plant and the second plant is reduced by at least or about 2%, 5%, 10%, 15%, 20%, 25%, 30%, 35%, 40%, 45%, 50%, 55%, 60%, 65%, 70%, 75%, 80%, 85%, 90%, 95%, or more than 95%. In some instances, the disease propagation between the first plant and the second plant is reduced in the range of about 5%-100%, 10%-90%, 20%-80%, 30%-70%, 40%-60%, 50%-95%, 65%-85%, or 75%-95%. In some instances, the disease propagation between the first plant and the second plant is reduced by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold.

In some instances, methods, devices, and recipes result in improved disease resistance in a crop or plant derived from a plant seed, plant seedling, or plant material treated using UV-B. In some instances, the improved disease resistance is by at least or about 2%, 5%, 10%, 15%, 20%, 25%, 30%, 35%, 40%, 45%, 50%, 55%, 60%, 65%, 70%, 75%, 80%, 85%, 90%, 95%, or more than 95%. In some instances, the improved disease resistance is in the range of about 5%-100%, 10%-90%, 20%-80%, 30%-70%, 40%-60%, 50%-95%, 65%-85%, or 75%-95%. In some instances, the improved disease resistance is by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold.

Disease reduction, including, but not limited to, reduction in disease incidence, reduction in symptoms of disease, reduction in disease severity, reduction in sporulation, reduction in number of spores released, and reduction in disease propagation, may be determined by comparison of UV-B irradiated plant seed, plant seedling, or plant material to non-UV-B irradiated plant seed, plant seedling, or plant material. In some instances, disease reduction is determined in the resultant crops from UV-B irradiated plant seed, plant seedling, or plant material that are compared to crops grown under similar conditions but from plant seed, plant seedling, or plant material that are not administered UV-B using methods described herein. Similar conditions may be similar environment or similar growing conditions. Environmental factors include, but are not limited to, sun exposure, temperature, soil composition, soil moisture, wind, humidity, and soil pH. Growing conditions include, but are not limited to, amount of watering, amount of pesticide, amount of herbicide, amount of insecticide, duration of priming, duration of germination, and timing of sowing. In some instances, the resultant crops are compared to crops grown at a same time. For example, the crops grown at the same time are grown on an adjacent or nearby field. In some instances, the resultant crops are compared to crops from a previous growing season. In some instances, a yield of the resultant crops is compared to a comparable crop. In some instances, yield from a comparable crop is referred to standard yield. In some instances, the comparable crop is a crop that is grown at a same time or subject to similar growing conditions.

Disease reduction may be determined by comparison of a field comprising UV-B irradiated plant seed, plant seedling, or plant material to a field comprising non-UV-B irradiated plant seed, plant seedling, or plant material. In some instances, disease reduction is determined in the resultant crops of a field from UV-B irradiated plant seed, plant seedling, or plant material that are compared to a field comprising crops grown under similar conditions but from plant seed, plant seedling, or plant material that are not administered UV-B using methods described herein. Similar conditions may be similar environment or similar growing conditions. Environmental factors include, but are not limited to, sun exposure, temperature, soil composition, soil moisture, wind, humidity, and soil pH. Growing conditions include but are not limited to, amount of watering, amount of pesticide, amount of herbicide, amount of insecticide, duration of priming, duration of germination, and timing of sowing. In some instances, the field comprising UV-B irradiated plant seed, plant seedling, or plant material is compared to the field comprising non-UV-B irradiated plant seed, plant seedling, or plant material grown at a same time. The fields may be adjacent fields or nearby fields. The fields may be fields of comparable size. In some instances, the field comprising UV-B irradiated plant seed, plant seedling, or plant material is compared to a field comprising non-UV-B irradiated plant seed, plant seedling, or plant material from a previous growing season. In some instances, the field comprising UV-B irradiated plant seed, plant seedling, or plant material is compared to a historical average of fields comprising non-UV-B irradiated plant seed, plant seedling, or plant material. In some instances, the field comprising UV-B irradiated plant seed, plant seedling, or plant material is compared to an expected average yield for a field comprising non-UV-B irradiated plant seed, plant seedling, or plant material. In some instances, the expected average yield for a field is based on a national average. In some instances, the expected average yield for a field is based on a historical average for a particular growing region.

Plant disease can be caused by a bacterium, insect, pathogen, fungi, virus, nematode, mycoplasma, or combinations thereof. In some instances, the plant disease is caused by a filamentous pathogen. In some instances, the disease is caused by Magnaporthe oryzae, Cochliobolus miyabeanus, Rhizoctonia solum, Gibberella fujikumoi, Phythiurn sp., Rhizopus chinensis, Rhizopus oryzae, Trichoderma violet, Erysiphe graminis, Fusarium graminearum, E avenaceum, F. curumorum, F. asiaticum, P. irraisum, P. hordei, Typhula sp., Micronetriella nivalis, Ustilagotritici, U nuda, Tselitia caries, Septoria tritici, Leptosphaeria nodorum, Pyrenophora teresdrichtler, Pyrenophora tritici-repentis, Pyrenophora tritici-repentis, Typhula ishikariensis, Typhala incarnata, Sclerotinia borealis, Microchiumum nivale, Gloeocercospora sorghi, Puccinia polysora, fusarium graminearum, cochliobulus heterostrophus, Cercospora zaea-maydis, Fusarium moniliforme, Colletotrichum gramicola, Fusarium solani, Rhizotonia solani, Penicillium digitatum, P. italicum, Phytophthora parasitetica, Phytophthora, Valsa ceratosperperma, Podosperaera leukotricha, Alternaria alterotrope violet, Colletotrichum acutatum, Phytophactora cattum, Diplocarpon man, Venturia nashicola, V pirina, Gymnosporangium haraeumum, Monilinia fracticola, Elsinoe ampelina, Cladosporium carpophilum, Colletorichum gloeosporioids, Uncinula necator, Phakopsoropodibola pesticide, Plasmopara viticola, Botrytis cinerea, Colletotrichum orbiculare, Elsinoe fawceti, Sphaerotheca furiginea, Mycosphaerella meloniis, Fusarium oxysporum, Cladosporium fulvum, Stemphyllium lycoperici, Phomopsis vexans, Erysiphe cichoacearum, Alternaria japonica, Cercosporella brassicae, Plasmodiophora brassicae, Peronospora parasitica, Alternaria brassicae, Erysiphe cichoracearumum, Leptosphaeria maculans, Puccinia allii, Fusarium oxysoporum Botrytis Botrytis squamosa, Fusarium oxysoporum, Fusarium solani, Cercospora kikuchii, Elsinoe glycines, Diaporthe phaseolum, Septoria glycines, Phytophthora sojae, Rhizoctonia solani Rhizoctonia solani, Fusarium sorghum, Colletotrichum scab, Sclerotinia sclerotiorum, Botrytis cinerea, Uromyces phaseolii, Colletotrichum phaseolum, Botrytis cinereaa, Sclerotinia sclerotiorum, Colletotrichum lindemthianum, Fusarium oxysporum, Aphanomyces euthesis Cercospora personata, Cercospora arachidicola, Sclerotium rolfsii, Erysiphe pisi, Fusarium solani, Alternaria solani, Phytophthora infestans, Spongospora subterranea, Phytophthora erythroseptica, Sphaerotheca humuli, Glomerella singulata, Exobasidium reticulatum, Elsinoe leucospila, Pestarotropis sp., Colletotrichum theae-sinensis, Rhizoctonia solani Alternaria longipes, Erysiphe cichoaceracum, Colletotrichum tabacum, Peronospora tabacina, Phytophthiati Cercospora beticola, Thanatephorus cucumeris, Aphanomyces cochlioides, Diplocarpon rosae, Sphaerotheca pannosa, Peronospora sparsa, Septoria chrysanthemi-indici, Septoria chrysanthemi-indici, Bremia lactucae, Alternaria brassicicola, Sclerotinia homeocarpa, Rhizotonia solani, Mycosphaelacolusellae sp. Plasmopara halstedii, Alternaria helianthii, Sclerotium rolfsii, Rhizoctonia solani, Phythium aphanidermatum, Pythium debarianum, Pythium graminicola, Pythium irregulari, Pythium ultimatum, Botrytrice disease, Rhizoctonia solani, or combinations thereof. In some instances, the disease is caused by Bremia lactucae.

Methods, devices, and recipes described herein, in some embodiments, are used for reducing plant disease. In some instances, the disease is rice blast, sesame leaf blight, blight, idiopathic seedling, powdery mildew, red mold disease, snow rot, naked smut, maggot stalk, eye-spot disease, leaf blight, net leaf disease, yellow spot, snow rot, foot disease, leopard crest disease, southern rust, grey leaf spot, Fusarium head blight, anthracnose, seedling blight, black spot disease, fruit rot disease, brown rot disease, Monilia mary rot, powdery mildew, spotted leaf disease, brown spot disease, red scab, black scab, late rot, rust disease, gray mold, anthracnose, vine blight, vine scab, white spot disease, root-knot disease, downy mildew, or mung disease. In some instances, the plant disease is downy mildew disease.

Mechanism of Action

Methods, devices, and recipes as described herein, in some embodiments, result in disease reduction, disease resistance, or a combination thereof. In some instances, disease reduction or disease resistance is a result of activation of defense pathways involving genes and proteins important for disease reduction and disease resistance.

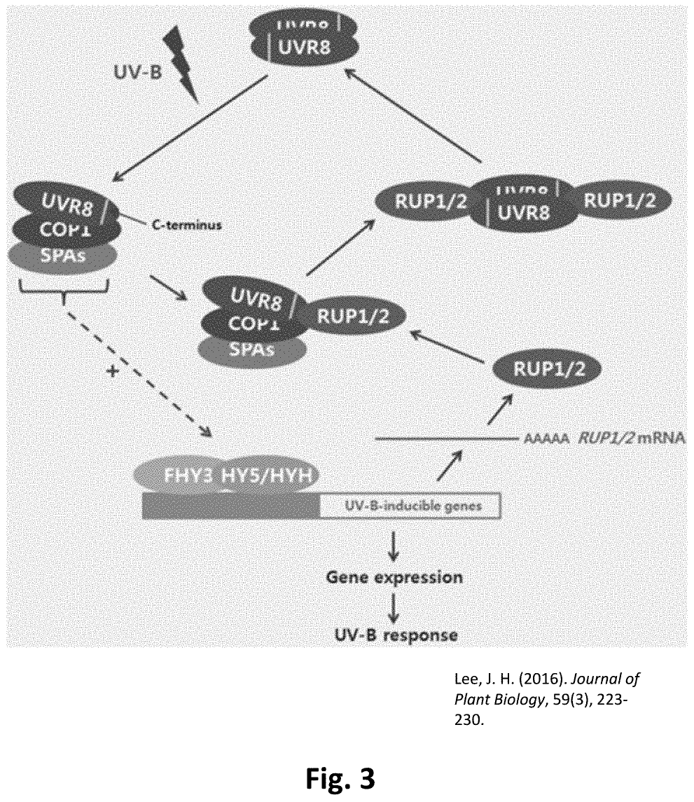

UVR8 is a dimer in natural state. See FIG. 3. Each monomer forms a seven-bladed (3-propeller fold protein. The dimer is held together by salt bridges. UVR8 differs from other plant photoreceptors as it lacks an external cofactor as a chromophore. Instead UVR8 has key tryptophan aromatic amino acid which can absorb UV-B light with a maximum absorption of 280-300 nm. When UV-B light is applied, the key tryptophan becomes excited and causes a dissociation of the UVR8 dimer, creating an active monomer (due to exposed C terminal) which can induce UV-B response genes. The active UVR8 monomer is free to bind to COP1. COP1 is a known E3 ubiquitin ligase which works with SPA1 (SUPPRESSOR OF PHYA) to target many photomorphogenesis promoting transcription factors for degradation. This includes HY5 (ELONGATED HYPOCOTYL5), which is a key transcription factor in expression of a large number of UV-B response genes.

A suggested theory is that binding of the UVR8 monomer to the COP1-SPA1 complex inactivates the ubiquitinase activity and results in lower amounts of COP1 in the nucleus. Therefore, degradation of HY5 as well as the closely related protein HY5 HOMOLOG (HYH) in the nucleus is reduced. HY5 is then able to accumulate and induce expression of a large number of UV-B related genes. COP1 may also positively regulate HY5 through an unknown manner.

HY5 induces a number of genes responsible for the previously described morphogenic and chemical responses in a UVR8 dependent manner. HY5 also regulates expression of repressors of the UVR8 dependent responses; RUP1 and RUP2 (Repressor of UV-B Photomorphogenesis) to provide a balanced response. RUP1/2 proteins use the same binding site as COP1-SPA to the C terminal of the UVR8 monomer. Upon reception of UV-B light, RUP1/2 are increased in abundance, resulting in displacement of COP1-SPA complex as the RUP proteins compete to bind to the UVR8 monomers. Once bound, RUP1/2 facilitates the redimerization of UVR8 into base dimer by creating a negative feedback loop.

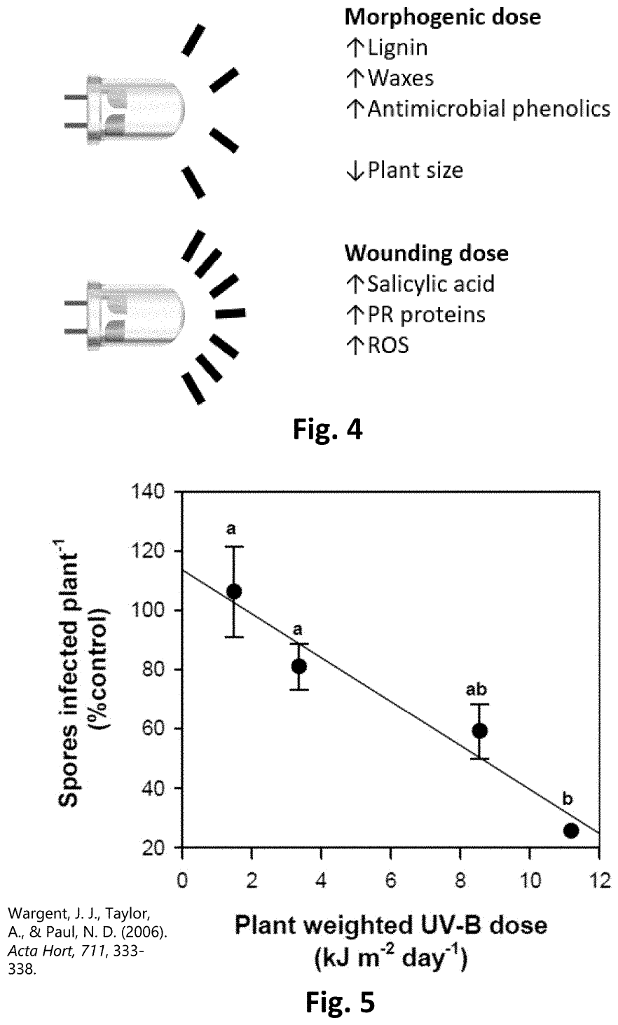

The mechanism of UV-B induced disease tolerance is not well understood. UV-B light can increase a number of defensive features such as: lignin, which serves to strengthen cell wall to reduce fungal penetration; waxes which serves to trap spores and reduce penetration; flavonoids, which may be toxic to pathogens or incorporated as barrier strengthening+phytoalexins; salicylic acid which serves as a defense hormone and SAR and hypersensitive response; PR proteins which serves to inhibit pathogen enzymes; and ROS toxic and induce defense response. See FIG. 4. One of the possible responses to UV-B light is a reduction of disease severity UV-B pre-treated Arabidopsis had reduced lesions caused by botrytis. UV-B pre-treated lettuce showed a reduced number of Bremia spores with increasing doses of UV-B treatment. See FIG. 5.

Described herein are methods, systems, and recipes for reducing disease and improving disease resistance by modulating gene expression of genes involved in reducing disease or improving disease resistance. In some instances, methods, systems, and recipes increase gene expression of genes involved in reducing disease or improving disease resistance. In some instances, methods, systems, and recipes decrease gene expression of genes involved in reducing disease or improving disease resistance.

Genes that are modulated by UV-B and involved in reducing disease or improving disease resistance may be involved in various pathways. Exemplary pathways include, but are not limited to, stachyose biosynthesis, kaempferol glycoside biosynthesis, quercetin glycoside biosynthesis, glycosides biosynthesis, syringetin biosynthesis, chlorogenic acid biosynthesis I, ajugose biosynthesis II, chlorogenic acid biosynthesis II, anthocyanidin modification, phenylpropanoid biosynthesis, stachyose degradation, flavonoid biosynthesis, and flavanol biosynthesis.

In some embodiments, methods, systems, and devices relating to UV-B reduce disease or improve resistance by inducing production of metabolites. In some instances, the metabolites are phenolic compounds. In some instances, methods, systems, and devices relating to UV-B increase metabolites. In some instances, methods, systems, and devices relating to UV-B increase metabolites by at least or about 5%, 10%, 15%, 20%, 25%, 30%, 35%, 40%, 45%, 50%, 55%, 60%, 65%, 70%, 75%, 80%, 85%, 90%, 95%, or more than 95%. In some instances, methods, systems, and devices relating to UV-B increase metabolites in the range of about 5%-100%, 10%-90%, 20%-80%, 30%-70%, 40%-60%, 50%-95%, 65%-85%, or 75%-95%. In some instances, methods, systems, and devices relating to UV-B increases a phenolic compound, a metabolite, or combinations thereof by at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold. In some instances, methods, systems, and devices relating to UV-B increase metabolites as compared to a seed, seedling, plant material, or resultant crop or plant that is not treated using UV-B.

Exemplary metabolites include, but are not limited to, sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), and methyl 9-(alpha-D-galactosyloxy)nonanoate. In some instances, the metabolite is quercetin 3-0 (6-malonyl)-glucoside, kaempferol-3 glucuronide, 1,3 dicaffeolyquinic acid, or chlorogenic acid.

Metabolites may be used for determining subsequent plants or crops having reduced disease or improved disease resistance. In some instances, expression or levels of metabolites is used to determine whether a plant material will be susceptible to disease. In some instances, the expression or levels of the metabolites or flavonoid index indicate susceptibility of the plant material to disease. For example, if the expression or level of the metabolite or flavonoid index is at least or about 0.5-fold, 1.0-fold, 1.5-fold, 2.0-fold, 2.5-fold, 3.0-fold, 3.5-fold, 4.0-fold, 5.0-fold, 6.0-fold, 7.0-fold, 8.0-fold, 9.0-fold, 10-fold, or more than 10-fold increased as compared to a control, then the plant material is less susceptible to disease. In some instances, if the expression or level of the metabolite or flavonoid index is at least or about 5%, 10%, 15%, 20%, 25%, 30%, 35%, 40%, 45%, 50%, 55%, 60%, 65%, 70%, 75%, 80%, 85%, 90%, 95%, or more than 95% higher as compared to a control, then the plant material is less susceptible to disease. In some instances, if the expression or level of the metabolite or flavonoid index is in the range of about 5%-100%, 10%-90%, 20%-80%, 30%-70%, 40%-60%, 50%-95%, 65%-85%, or 75%-95% higher as compared to a control, then the plant material is less susceptible to disease. In some instances, the control is a plant seed, plant seedling, plant material, or plant or crop derived from the plant seed, plant seedling, or plant material, wherein the plant seed, plant seedling, or plant material was not treated using UV-B. In some instances, the metabolite is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), or methyl 9-(alpha-D-galactosyloxy)nonanoate. In some instances, the phenolic compound or metabolite is quercetin 3-0 (6-malonyl)-glucoside, kaempferol-3 glucuronide, 1,3 dicaffeolyquinic acid, or chlorogenic acid.

Metabolites can be measured in various ways. In some instances, a quantitative measurement is made of the metabolites. For example, a Dualex is used to measure the metabolites.

Application to Different Types of Plant Materials and Plants

Application to a number of plant seeds, plant seedlings, or plant materials is consistent with the disclosure herein. Exemplary plant materials subjected to treatments herein include runners, post-seedling plants, leaves, roots, shoot meristems, whole plant application, such as whole plants grown hydroponically or aeroponically. In some cases plant material is selected from the group consisting of fruit and vegetables. In some instances, the plant seed, plant seedling, or plant material is selected from the group consisting of green lettuce, red lettuce, tomato, cucumber, broccoli, herb crops, cannabis, strawberry and eggplant. In some instances, the plant seed, plant seedling, or plant material is a commercially important crop. The method may also be applicable to a wide variety of other crop types without limitation.

In some instances, the plant seed, plant seedling, or plant material is lettuce. In some instances, the lettuce cultivar is Calicel, Casino, Desert Storm, El Dorado, Falcon, Greenway, Iceberg, La Brilliante, Pedrola, Pavane, or Salinas.

Various cultivation systems for use with methods and devices as described herein may be used. For example, the plant seed, plant seedling, or plant material is grown in soil. In some instances, the plant seed, plant seedling, or plant material is grown using hydroponics or aeroponics. Plants can be grown in controlled greenhouse conditions, such as conventional greenhouse conditions or vertical farming conditions. Alternately, plants are grown outdoors.

Device

A number of devices are consistent with the implementation of the methods and treatment recipes as disclosed herein. In some instances, the device has the ability to administer a pre-defined UV dose regime such as those described in the present application and wherein parameters preferably used in the present disclosure may be easily adjusted and controlled. In some instances, a computer is in communication with a device to automatically control a treatment parameter.

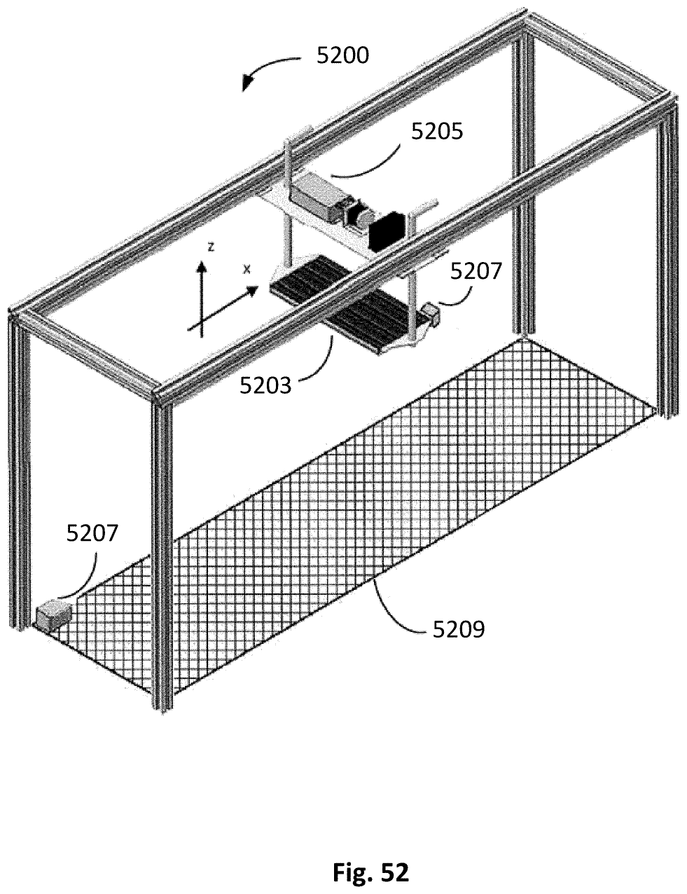

An exemplary device is seen in FIG. 52. The device 5200 comprises a light source 5203 for administering light to a target area 5209. In some instances, the light source administers light enriched for UV-B. In some instances, the lighting source administers only UV-B. In some instances, the light source administers UV-B in combination with other light. The lighting source may remain stationary or may move in any one of X, Y, or Z direction. The device further comprises a processor 5205 for providing information to the light source 5203 or to a lighting controller. The device further comprises sensors 5207. The sensors 5207 are configured to detect at least one of directionality of a light source, position of a light source, humidity, pressure, temperature, dosage, intensity, or irradiance during UV-B administration.

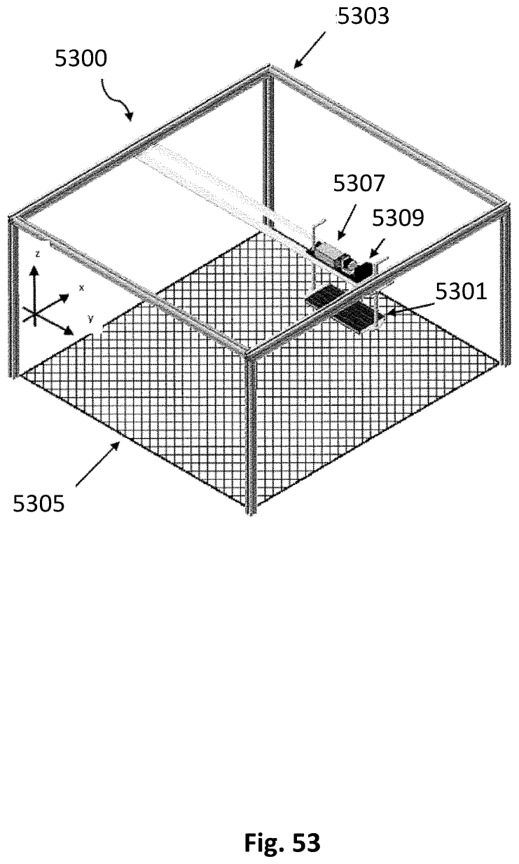

A second exemplary device is seen in FIG. 53. Device 5300 provides conveyance of lighting array 5301 in X, Y and Z directions. The lighting source may remain stationary or may move in any one of X, Y, or Z direction. The device 5300 includes a gantry 5303. The device 5300 is configured to direct light onto a target area 5305. Microprocessor and associated electronic drive circuitry 5307 control one or more characteristics of the light emitted by the light emitters. The microprocessor and associated drive circuitry 5307 is configured to control the light intensity, the spectral content, the directionality of and the duration of time over which light is emitted by the light emitters in accordance with a predefined dosage regime as described herein. The predefined dosage regime may be programmed into the microprocessor or an associated media readable by the microprocessor. Programming of the microprocessor with new or additional dosage regimes could be achieved in any number of ways, such as, but not limited to, the addition of additional media such as a memory module, programming of the media readable by the microprocessor or the microprocessor's memory by way of USB or wireless technology or by entering an additional dosage regime by way of a user interface associated with the microprocessor.

In some instances, the devices and systems as described herein comprise one or more light emitters. In some instances, the light emitters are attached to a lighting module. In some instances, the lighting module forms a heat-sink or comprise drive circuitry. The lighting module and attached light emitters may be positioned above the target area such that the light emitted from the light emitters is directed downwards onto the target area and, in use, any plants within the target area.

Movement of the lighting module may be performed by an electronic actuator. An exemplary electronic actuator is seen FIG. 53. The electronic actuator 5309 is in a form of a vertical adjustment motor. In some instances, by moving the lighting module closer towards the target area the intensity of light on the target area is increased and by moving the lighting module further away from the target area the intensity of light is reduced. In some embodiments the vertical adjustability of the lighting array may be performed manually rather than being automatically adjusted by the system.

In some instances, the device includes a moving conveyor which alters the relative position of at least one light emitter and the target area during the treatment. In this way a large number of plant seeds, plant seedlings, or plant materials may be conveniently and accurately treated during the treatment phase as the conveyor moves the position of the light emitters.

In some instances, the device administers UV light according to the present disclosure via light emitting diodes (LEDs).

In some instances, the device is configured to co-administer visible light with UV light, which is beneficial for the reasons discussed above.

Some such devices are configured to administer various treatment conditions and combinations of treatments as described herein. For example, the device controls at least one of treatment distance from plant to light source (mm), speed of moving light source (mm/second), light source timing cycles (regularity of each exposure, seconds), number of cycles per day, irradiance of UV-B cm⁻² s¹), peak wavelength of UV-B, irradiance of red light (μmol m⁻² s⁻¹), peak wavelength of red light (nm), irradiance of blue light (μmol m⁻² s⁻¹), peak wavelength of blue light (nm), and total days of treatment.

In some instances, the device is configured to regulate or to hold its light source at a fixed or otherwise determined distance of a light source to a plant seed, plant seedling, or plant material. In some instances, the distance from the plant seed, plant seedling, or plant material and the light source is in a range of about 5 to about 200, about 10 to about 160, about 20 to about 140, about 30 to about 120, or about 40 to about 60 mm. In some instances, the distance from the plant seed, plant seedling, or plant material and the light source is about 50 mm. In some instances, the distance from the plant seed, plant seedling, or plant material and the light source is about 70 mm.

In some instances, the device controls a movement of a light source. In some instances, the speed of a moving light source is at least or about 20, 30, 40, 50, 60, 70, 80, 90, 100, 120, 140, 160, 180, 200, or more than 200 millimeters per second (mm/second). In some instances, the speed of a moving light source is in a range of about 5 to about 200, about 10 to about 160, about 20 to about 100, or about 40 to about 60 mm/second. In some instances, the speed of a moving light source is about 50 mm/second.

Devices herein are configured to administer UV light, alone or in combination with visible light, at a range of wavelengths consistent with wavelength disclosures throughout the present disclosure, such as UV-B at or peaking in a range of about 280 nm to about 290 nm, about 280 nm to about 300 nm, about 280 nm to about 310 nm, about 280 nm to about 320 nm, about 290 nm to about 300 nm, about 290 nm to about 310 nm, about 290 nm to about 320 nm, about 300 nm to about 310 nm, about 300 nm to about 320 nm, or about 310 nm to about 320 nm. In some instances, the UV-B is administered or peaking in a range of 280 nm (±5 nm) to 284 nm (±5 nm), 279 nm (±5 nm) to about 288 nm, about 289 nm to about 300 nm, or 286 nm (±5 nm) to about 305 nm. In some instances, UV-B is peaking at 280 nm. In some instances, UV-B is peaking at 300 nm.

Devices herein are configured for continuous, single administration or regular repeating light such as cyclic exposure of UV-B light. In some instances, cyclic exposure of UV-B light comprises at least or about 50, 100, 150, 200, 250, 300, 350, 400, 450, 500, 550, 600, 650, 700, 750, 800, 850, 900, 950, 1000, or more than 1000 cycles per day. In some instances, the number of cycles per day is more than about 250 cycles per day. In some instances, the number of cycles per day is about 430 cycles per day.

Devices are often configured to administer a set duration of treatment. For example, UV-B treatment is about 1 day, 2 days, 3 days, 4 days, 5 days, 6 days, 7 days, 8 days, 9 days, 10 days, 12 days, 14 days, 16 days, 18 days, 20 days, 24 days, 30 days, 32 days, 50 days, 72 days, or more than 72 days. In some instances, UV-B treatment is in a range of about 1 day to about 30 days, about 2 days to about 25 days, about 4 days to about 20 days, about 6 days to about 18 days, or about 8 days to about 16 days. In some instances, the device controls light exposure. In some instances, the light exposure is at least or about 20, 30, 40, 50, 60, 70, 80, 90, 100, 120, 140, 160, 180, 200, 220, 240, 260, 280, 300, 320, 340, 360, 380, 400, or more than 400 seconds. In some instances, the light exposure is in a range of about 20 to about 300, about 40 to about 200, about 60 to about 140, about 80 to about 100, or about 90 to about 180 seconds. The light exposure may comprise light enriched or supplemented with UV-B.

Devices as described herein may be configured to administer a specified dose or irradiance of light. For example, the device is configured to administer various irradiances of UV-B. In some instances, the irradiance of UV-B is at least or about 0.01 μmol m⁻² s⁻¹, 0.02 μmol m⁻² s⁻¹, 0.05 μmol m⁻² s⁻¹, 0.075 μmol m⁻² s⁻¹, 0.10 μmol m⁻² s⁻¹, 0.2 μmol m⁻² s⁻¹, 0.5 μmol m⁻² s⁻¹, 0.75 μmol m⁻² s⁻¹, 1.0 μmol m⁻² s⁻¹, 1.5 μmol m⁻² s⁻¹, 2.0 μmol m⁻² s⁻¹, 2.5 μmol m⁻² s⁻¹, 3.0 μmol m⁻² s⁻¹, 3.5 μmol m⁻² s⁻¹, or 4.0 μmol m⁻² s⁻¹. In some instances, the irradiance of UV-B is in a range of about 0.01 μmol m⁻² s⁻¹ to about 1.0 μmol m⁻² s⁻¹. In some instances, the irradiance of UV-B is about 0.1 μmol m⁻² s⁻¹, about 0.2 μmol m⁻² s⁻¹, about 0.3 μmol m⁻² s⁻¹, about 0.4 μmol m⁻² s⁻¹, about 0.5 μmol m⁻² s⁻¹, about 0.6 μmol m⁻² s⁻¹, about 0.7 μmol m⁻² s⁻¹, about 0.8 μmol m⁻² s⁻¹, about 0.9 μmol m⁻² s⁻¹, or about 1.0 μmol m⁻² s⁻¹.

Devices as described herein, in some embodiments, administer a specified dose. In some instances, the dose is about 0.1 kJ m⁻² h⁻¹ to about 20 kJ m⁻² h⁻¹. In some instances, the dose is about 0.1 kJ m⁻² h⁻¹ to about 1.0 kJ m⁻² h⁻¹. In some instances, the dose is about 0.01 kJ m⁻² h⁻¹, about 0.025 kJ m⁻² h⁻¹, about 0.050 kJ m⁻² h⁻¹, about 0.10 kJ m⁻² h⁻¹, 0.3 kJ m⁻² h⁻¹, about 0.5 kJ m⁻² h⁻¹, about 1.0 kJ m⁻² h⁻¹, about 1.5 kJ m⁻² h⁻¹, about 2.0 kJ m⁻² h⁻¹, about 2.5 kJ m⁻² h⁻¹, about 3.0 kJ m⁻² h⁻¹, about 3.5 kJ m⁻² h⁻¹, about 4.0 kJ m⁻² h⁻¹, about 4.5 kJ m⁻² h⁻¹, about 5.0 kJ m⁻² h⁻¹, about 5.5 kJ m⁻² h⁻¹, about 6.0 kJ m⁻² h⁻¹, about 7.0 kJ m⁻² h⁻¹, about 8.0 kJ m⁻² h⁻¹, about 9.0 kJ m⁻² h⁻¹, about 10.0 kJ m⁻² h⁻¹, about 11.0 kJ m⁻² h⁻¹, or about 12.0 kJ m⁻² h⁻¹. In some instances, the dose is at least or about 0.1 kJ m⁻² h⁻¹, 0.3 kJ m⁻² h⁻¹, 0.5 kJ m⁻² h⁻¹, 0.7 kJ m⁻² h⁻¹,1.0 kJ m⁻² h⁻¹, 1.5 kJ m⁻² h⁻¹, 2.0 kJ m⁻² h⁻¹, 2.5 kJ m⁻² h⁻¹, 3.0 kJ m⁻² h⁻¹, 3.5 kJ m⁻² h⁻¹, 4.0 kJ m⁻² h⁻¹, 4.5 kJ m⁻² h¹, 5.0 kJ m⁻² h⁻¹, 5.5 kJ m⁻² h⁻¹, 6.0 kJ m⁻² h⁻¹, 6.5 kJ m⁻² h⁻¹, 7.0 kJ m⁻² h⁻¹, 7.5 kJ m⁻² h⁻¹, 8.0 kJ m⁻² h⁻¹ to at least or about 9.0 kJ m⁻² h⁻¹, 9.5 kJ m⁻² h⁻¹, 10.0 kJ m⁻² h⁻¹, 11 kJ m⁻² h⁻¹, 12 kJ m⁻² h⁻¹, 13 kJ m⁻² h⁻¹, 14 kJ m⁻² h⁻¹, 15 kJ m⁻² h⁻¹, 16 kJ m⁻² h⁻¹, 18 kJ m⁻² h⁻¹, 20 kJ m⁻² h⁻¹, 22 kJ m⁻² h⁻¹, 24 kJ m⁻² h⁻¹, 26 kJ m⁻² h⁻¹, 28 kJ m⁻² h⁻¹, 30 kJ m⁻² h⁻¹. In some instances, the dose of UV-B is in a range of about 0.3 kJ m⁻² h⁻¹ to about 3.0 kJ m⁻² h⁻¹. In some instances, the dose of UV-B is in a range of about 2.0 kJ m⁻² h⁻¹ to about 12.0 kJ m⁻² h⁻¹.

In some instances, the dose is about 0.1 kJ m⁻² d⁻¹ to about 20 kJ m⁻² d⁻¹. In some instances, the dose is 0.3 kJ m⁻² d⁻¹, about 0.5 kJ m⁻² d⁻¹, about 1.0 kJ m⁻² d⁻¹, about 1.5 kJ m⁻² d⁻¹, about 2.0 kJ m⁻² d⁻¹, about 2.5 kJ m⁻² d⁻¹, about 3.0 kJ m⁻² d⁻¹, about 3.5 kJ m⁻² d⁻¹, about 4.0 kJ m⁻² d⁻¹, about 4.5 kJ m⁻² d⁻¹, about 5.0 kJ m⁻² d⁻¹, about 5.5 kJ m⁻² d⁻¹, about 6.0 kJ m⁻² d⁻¹, about 7.0 kJ m⁻² d⁻¹, about 8.0 kJ m⁻² d⁻¹, about 9.0 kJ m⁻² d⁻¹, about 10.0 kJ m⁻² d⁻¹, about 11.0 kJ m⁻² d⁻¹, or about 12.0 kJ m⁻² d⁻¹. In some instances, the dose is at least or about 0.1 kJ m⁻² d⁻¹, 0.3 kJ m⁻² d⁻¹, 0.5 kJ m⁻² d⁻¹, 0.7 kJ m⁻² d⁻¹, 1.0 kJ m⁻² d⁻¹, 1.5 kJ m⁻² d⁻¹, 2.0 kJ m⁻² d⁻¹, 2.5 kJ m⁻² d⁻¹, 3.0 kJ m⁻² d⁻¹, 3.5 kJ m⁻² d⁻¹, 4.0 kJ m⁻² d⁻¹, 4.5 kJ m⁻² d⁻¹, 5.0 kJ m⁻² d⁻¹, 5.5 kJ m⁻² d⁻¹, 6.0 kJ m⁻² d⁻¹, 6.5 kJ m₋₂ d⁻¹, 7.0 kJ m⁻² d⁻¹, 7.5 kJ m⁻² d⁻¹, 8.0 kJ m⁻² d⁻¹ to at least or about 9.0 kJ m⁻² d⁻¹, 9.5 kJ m⁻² d⁻¹, 10.0 kJ m⁻² d⁻¹, 11 kJ m⁻² d⁻¹, 12 kJ m⁻² d⁻¹, 13 kJ m⁻² d⁻¹, 14 kJ m⁻² d⁻¹, 15 kJ m⁻² d⁻¹, 16 kJ m⁻² d⁻¹, 18 kJ m⁻² d⁻¹, 20 kJ m⁻² d⁻¹, 22 kJ m⁻² d⁻¹, 24 kJ m⁻² d⁻¹, 26 kJ m⁻² d⁻¹, 28 kJ m⁻² d⁻¹, 30 kJ m⁻² d⁻¹. In some instances, the dose of UV-B is in a range of about 0.3 kJ m⁻² d⁻¹ to about 3.0 kJ m⁻² d⁻¹. In some instances, the dose of UV-B is in a range of about 2.0 kJ m⁻² d⁻to about 12.0 kJ m⁻² d⁻¹.

The device may be configured to administer UV-B alone or UV-B in conjunction with at least one of blue light and red light. In some instances, the blue light is administered or is peaking at least or about 430 nm, 435 nm, 440 nm, 445 nm, 450 nm, 455 nm, 460 nm, 465 nm, 470 nm, 475 nm, 480 nm, 485 nm, or 490 nm. In some instances, blue light is administered or is peaking in a range of 430 nm to 480 nm or 440 nm to 460 nm. In some instances, blue visible light or blue light is administered or is peaking at about 450 nm. Irradiance of blue light includes, but is not limited to, 5, 10, 20, 30, 40, 50, 60, 70, 80, 90, 100, 200, 300, 400, 500, 600, 700, 800, 900, 1000, 2000, 3000, 4000, 5000, 6000, or more than 6000 μmol m⁻² s⁻¹. In some instances, red visible light or red light is administered or is peaking at 620 nm (±5 nm), about 630 nm, about 640 nm, about 660 nm, about 670 nm, about 680 nm, about 690 nm, about 700 nm, about 710 nm, about 720 nm, about 730 nm, about 740 nm, or about 750 nm (±5 nm). In some instances, red visible light or red light is administered or is peaking at about 660 nm. Irradiance of red light includes, but is not limited to, 5, 10, 20, 30, 40, 50, 60, 70, 80, 90, 100, 200, 300, 400, 500, 600, 700, 800, 900, 1000, 2000, 3000, 4000, 5000, 6000, or more than 6000 μmol m⁻² s⁻¹.

In some instances, devices and systems comprise a computer processor or use of the same. In some instances, the computer processor provides information to the lighting controller. In some instances, the computer processor comprises a computer program. In some instances, the computer program includes a sequence of instructions, executable in the digital processing device's CPU, written to provide a UV-B regimen to a seed, seedling, or other plant material. In some instances, computer readable instructions are implemented as program modules, such as functions, features, Application Programming Interfaces (APIs), data structures, and the like, for administering UV-B to the seed, seedling, or other plant material.

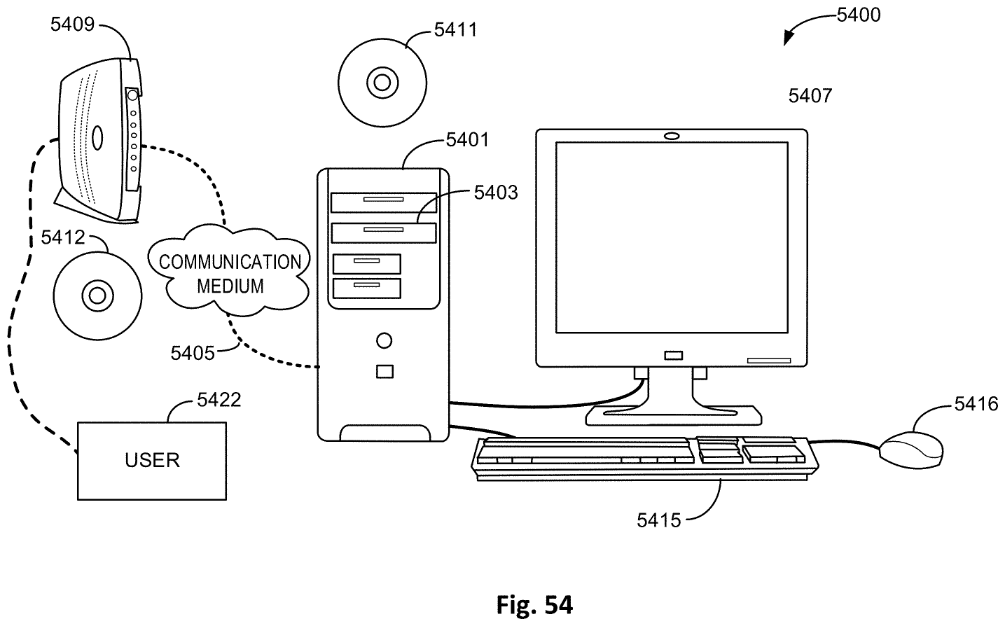

An exemplary computer system is seen in FIG. 54. The computer system 5400 may be understood as a logical apparatus that can read instructions from media 5411 and/or a network port 5405, which can optionally be connected to server 5409 having fixed media 5412. The system can include a CPU 5401, disk drives 5403, optional input devices such as keyboard 5415 and/or mouse 5416 and optional monitor 5407. Data communication can be achieved through the indicated communication medium to a server at a local or a remote location. The communication medium can include any means of transmitting and/or receiving data. For example, the communication medium can be a network connection, a wireless connection or an internet connection. Such a connection can provide for communication over the World Wide Web. It is envisioned that data relating to the present disclosure can be transmitted over such networks or connections for reception and/or review by a user 5422 as illustrated in FIG. 54.

Devices and systems as described herein may further comprise a sensor. In some instances, the sensor detects directionality of a light source, position of a light source, humidity, pressure, temperature, dosage, intensity, or irradiance during UV-B administration. In some instances, the sensor provides information to a lighting controller such that the directionality of a light source, position of a light source, humidity, pressure, temperature, dosage, intensity, or irradiance can be adjusted.

Definitions

Throughout this disclosure, various embodiments are presented in a range format. It should be understood that the description in range format is merely for convenience and brevity and should not be construed as an inflexible limitation on the scope of any embodiments. Accordingly, the description of a range should be considered to have specifically disclosed all the possible subranges as well as individual numerical values within that range to the tenth of the unit of the lower limit unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual values within that range, for example, 1.1, 2, 2.3, 5, and 5.9. This applies regardless of the breadth of the range. The upper and lower limits of these intervening ranges may independently be included in the smaller ranges, and are also encompassed within the disclosure, subject to any specifically excluded limit in the stated range. Where the stated range includes one or both of the limits, ranges excluding either or both of those included limits are also included in the disclosure, unless the context clearly dictates otherwise.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” in reference to a number or range of numbers is understood to mean the stated number and numbers +/−10% thereof, or 10% below the lower listed limit and 10% above the higher listed limit for the values listed for a range.

### Numbered Embodiments

Numbered embodiment 1 comprises a method for reducing disease in a crop, comprising: administering light enriched for UV-B to a seed or seedling at least 1 day prior to disease exposure, wherein a dose of UV-B is administered in a range of about 0.1 kJ m⁻² h⁻¹ to about 20 kJ m⁻² h⁻¹; and wherein disease incidence, symptoms of disease, disease severity, disease damage, or combinations thereof is reduced by at least about 5%. Numbered embodiment 2 comprises the method of numbered embodiment 1, further comprising concurrently priming the seed using a priming medium and administering the light enriched for the UV-B. Numbered embodiment 3 comprises the method of numbered embodiments 1-2, wherein the priming medium is water, polyethylene glycol, or a combination thereof. Numbered embodiment 4 comprises the method of numbered embodiments 1-3, wherein the light enriched for UV-B comprises a wavelength in a range of about 280 nm to about 290 nm. Numbered embodiment 5 comprises the method of numbered embodiments 1-4, wherein the light enriched for UV-B comprises a wavelength peaking at 280 nm. Numbered embodiment 6 comprises the method of numbered embodiments 1-5, wherein the light enriched for UV-B comprises a wavelength peaking at 300 nm. Numbered embodiment 7 comprises the method of numbered embodiments 1-6, wherein the dose of UV-B is in a range of about 0.3 kJ m⁻² h¹ to about 3.0 kJ m⁻² h⁻¹. Numbered embodiment 8 comprises the method of numbered embodiments 1-7, wherein the dose of UV-B is in a range of about 2.0 kJ m⁻² h⁻¹ to about 12.0 kJ m⁻² h⁻¹. Numbered embodiment 9 comprises the method of numbered embodiments 1-8, wherein the dose of UV-B is in a range of about 0.1 kJ m⁻² h⁻¹ to about 1.0 kJ m⁻² h⁻¹. Numbered embodiment 10 comprises the method of numbered embodiments 1-9, wherein the dose of UV-B is about 0.1 kJ m⁻² h⁻¹, about 0.2 kJ m⁻² h⁻¹, about 0.3 kJ m⁻² h⁻¹, about 0.4 kJ m⁻² h⁻¹, about 0.5 kJ m⁻² h⁻¹, about 0.6 kJ m⁻² h⁻¹, about 0.7 kJ m⁻² h⁻¹, about 0.8 kJ m⁻² h⁻¹, about 0.9 kJ m⁻² h⁻¹, or about 1.0 kJ m⁻² h⁻¹. Numbered embodiment 11 comprises the method of numbered embodiments 1-10, wherein the light enriched for UV-B comprises a dose of UV-B in a range of about 2 kJ m⁻² d⁻¹ to about 10 kJ m⁻² d⁻¹. Numbered embodiment 12 comprises the method of numbered embodiments 1-11, wherein the light enriched for UV-B comprises a dose of UV-B in a range of about 1.2 kJ m⁻² d⁻¹ to about 7 kJ m⁻² d⁻¹. Numbered embodiment 13 comprises the method of numbered embodiments 1-12, wherein a duration of administering UV-B is at least 10 hours, 15 hours, 20 hours, 25 hours, or 30 hours. Numbered embodiment 14 comprises the method of numbered embodiments 1-13, wherein a duration of administering UV-B is at least 1 day or at least 14 days. Numbered embodiment 15 comprises the method of numbered embodiments 1-14, wherein a duration of administering UV-B is about 1 day, about 2 days, about 3 days, about 4 days, about 5 days, about 6 days, or about 7 days. Numbered embodiment 16 comprises the method of numbered embodiments 1-15, wherein a photoperiod of the light administered is 10 hours. Numbered embodiment 17 comprises the method of numbered embodiments 1-16, wherein the light enriched for UV-B is administered at least 2 days, 3 days, 4 days, 5 days, 6 days, 7 days, 8 days, 9 days, or 10 days prior to the disease exposure. Numbered embodiment 18 comprises the method of numbered embodiments 1-17, wherein the disease incidence, symptoms of disease, disease severity, disease damage, or combinations thereof is reduced by at least about 10%, at least about 15%, at least about 30%, at least about 50%, or at least about 80%. Numbered embodiment 19 comprises the method of numbered embodiments 1-18, wherein sporulation is reduced, number of spores released is reduced, or a combination thereof. Numbered embodiment 20 comprises the method of numbered embodiments 1-19, wherein the sporulation, the number of spores released, or the combination thereof is reduced by at least about 10%, at least about 15%, at least about 30%, at least about 50%, or at least about 80%. Numbered embodiment 21 comprises the method of numbered embodiments 1-20, wherein the disease incidence is reduced at least 1 day, 2 days, 3 days, 4 days, 5 days, 6 days, 7 days, 8 days, 9 days, 10 days, 11 days, 12 days, 13 days, or 14 days post exposure. Numbered embodiment 22 comprises the method of numbered embodiments 1-21, wherein the disease is caused by a bacterium, insect pathogen, or combinations thereof. Numbered embodiment 23 comprises the method of numbered embodiments 1-22, wherein the disease exposure occurs after the seed is sown. Numbered embodiment 24 comprises the method of numbered embodiments 1-23, wherein administering light enriched for UV-B induces an increase in expression of one or more metabolites. Numbered embodiment 25 comprises the method of numbered embodiments 1-24, wherein the one or more metabolites is a phenolic compound. Numbered embodiment 26 comprises the method of numbered embodiments 1-25, wherein the one or more metabolites is a flavonoid. Numbered embodiment 27 comprises the method of numbered embodiments 1-26, wherein the one or more metabolites is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), methyl 9-(alpha-D-galactosyloxy)nonanoate, or combinations thereof. Numbered embodiment 28 comprises the method of numbered embodiments 1-27, wherein the one or more metabolites is quercetin 3-O (6-malonyl)-glucoside, kaempferol-3 glucuronide, 1,3 dicaffeolyquinic acid, or chlorogenic acid. Numbered embodiment 29 comprises a method for reducing disease propagation from a first plant to a second plant, comprising: a) administering light enriched for UV-B to a first plant material; b) administering light enriched for UV-B to a second plant material; c) sowing the first plant material; and d) sowing the second material in proximity to the first plant material, wherein the disease propagation between the first plant to the second plant is reduced by at least 50%. Numbered embodiment 30 comprises a method for improving subsequent plant performance, comprising: determining whether a plant material will be susceptible to disease by: obtaining or having obtained the plant material, wherein the plant material is administered light enriched for UV-B; and performing or having performed an assay on the plant material to determine expression of one or more metabolites; and if the plant material has expression of the one or more metabolites above a threshold expression of the one or more metabolites derived from a cohort of plant material not administered light enriched for UV-B, then sowing the plant material. Numbered embodiment 31 comprises the method of numbered embodiments 1-30, wherein the plant material is a seed or seedling. Numbered embodiment 32 comprises the method of numbered embodiments 1-31, wherein the one or more metabolites is a phenolic compound. Numbered embodiment 33 comprises the method of numbered embodiments 1-32, wherein the one or more metabolites is a flavonoid. Numbered embodiment 34 comprises the method of numbered embodiments 1-33, wherein the one or more metabolites is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), methyl 9-(alpha-D-galactosyloxy)nonanoate, or combinations thereof. Numbered embodiment 35 comprises the method of numbered embodiments 1-34, wherein the one or more metabolites is quercetin 3-O (6-malonyl)-glucoside, kaempferol-3 glucuronide, 1,3 dicaffeolyquinic acid, or chlorogenic acid. Numbered embodiment 36 comprises the method of numbered embodiments 1-35, wherein the threshold expression is a percentage increase in the expression of the one or more metabolites as compared to the one or more metabolites derived from a cohort of plant material not administered light enriched for UV-B. Numbered embodiment 37 comprises the method of numbered embodiments 1-36, wherein the percentage increase is at least 30%. Numbered embodiment 38 comprises the method of numbered embodiments 1-37, wherein the threshold expression is a flavonoid index. Numbered embodiment 39 comprises the method of numbered embodiments 1-38, wherein the light enriched for UV-B comprises a wavelength in a range of about 280 nm to about 290 nm. Numbered embodiment 40 comprises the method of numbered embodiments 1-39, wherein the light enriched for UV-B comprises a wavelength peaking at 280 nm. Numbered embodiment 41 comprises the method of numbered embodiments 1-40, wherein the light enriched for UV-B comprises a wavelength peaking at 300 nm. Numbered embodiment 42 comprises the method of numbered embodiments 1-41, wherein a dose of UV-B is in a range of about 0.1 kJ m⁻² h⁻¹ to about 20 kJ m⁻² h⁻¹. Numbered embodiment 43 comprises the method of numbered embodiments 1-42, wherein a duration of administering UV-B is at least 10 hours, 15 hours, 20 hours, 25 hours, or 30 hours. Numbered embodiment 44 comprises the method of numbered embodiments 1-43, wherein a duration of administering UV-B is in a range of about 1 day, about 2 days, about 3 days, about 4 days, about 5 days, about 6 days, or about 7 days. Numbered embodiment 45 comprises the method of numbered embodiments 1-44, wherein the light enriched for UV-B comprises a dose of UV-B in a range of about 1.2 kJ m⁻² d⁻¹ to about 7 kJ m⁻² d⁻¹. Numbered embodiment 46 comprises the method of numbered embodiments 1-45, wherein a photoperiod of the light administered is 10 hours. Numbered embodiment 47 comprises the method of numbered embodiments 1-46, wherein the light comprises blue light, red light, or a combination thereof. Numbered embodiment 48 comprises the method of numbered embodiments 1-47, wherein the plant performance comprises reduction in disease incidence, reduction in symptoms of disease, reduction in disease severity, reduction in disease damage, or combinations thereof. Numbered embodiment 49 comprises the method of numbered embodiments 1-48, wherein the reduction in disease incidence, reduction in symptoms of disease, reduction in disease severity, reduction in disease damage, or combinations thereof comprises a reduction by at least about 5%, at least about 10%, at least about 15%, at least about 30%, at least about 50%, or at least about 80%. Numbered embodiment 50 comprises the method of numbered embodiments 1-49, wherein the disease is caused by a bacterium, insect, pathogen, or combinations thereof.

### EXAMPLES

### Example 1

### UV-B Treatment Reduces Susceptibility of Lettuce to Disease

This example assessed UV-B pre-treatment on the susceptibility of lettuce to downy mildew disease.

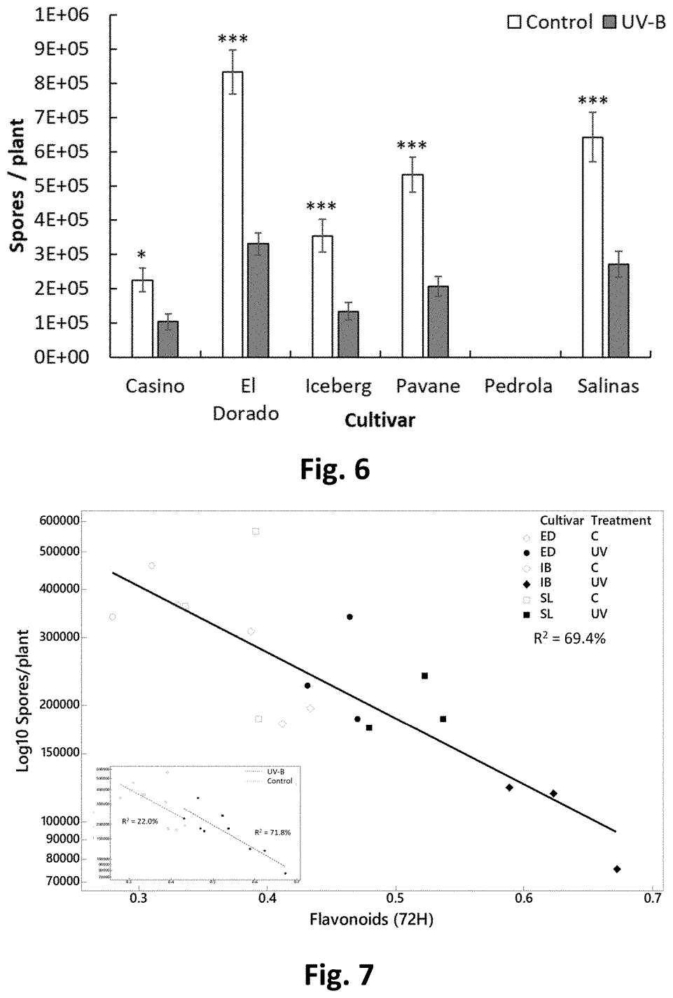

Lettuce seedlings (14 days post sowing) were pretreated with UV-B for three days for 10 hours per day. Following treatment, the seedlings were inoculated with disease. Following treatment, plants were inoculated with Bremia lactucae. Spores from resultant plants were washed off at 12 days post inoculation (DPI) for various cultivars and measured. Sporulation and damage visual ratings were also recorded. As seen in FIG. 6, UV-B pre-treatment reduced the susceptibility of lettuce to downy mildew disease. Asterisks indicate significance (T-test) level. The most consistent and highest decrease was a reduction in spore count. This reduction in spore count is meaningful in terms of the spread of disease.

The spread of disease was also measured as reduction in spores which can indicate disease spread. Healthy plants placed in the same tent as infected UV-B treated plants were compared to healthy plants placed in a tent with infected control plants. Healthy plants placed in the same tent as infected UV-B treated plants exhibited reduced disease. The spread of disease was amplified when healthy plants and infected plants were pre-treated with UV-B.

This example shows UV-B treatment reduces disease susceptibility.

### Example 2

### UV-B Treatment Increases Flavonoid and Phenolic Acid Levels in Lettuce Cultivars

This example assessed the effect of UV-B treatment on flavonoid levels in lettuce cultivars.

Different compounds were measured in lettuce cultivars that had received UV-B treatment: El Dorado (ED), Iceberg (IB) and Salinas (SL). LC-MS data indicated that several compounds had a significant correlation between spore count and compound intensity. These compounds included flavonoids. A handheld Dualex was used to measure the level of flavonoids in three cultivars of lettuce at the time of disease inoculation 72 hours post UV-B treatment start. As seen in FIG. 7, this data indicated that there was a correlation between flavonoid level and spore count.

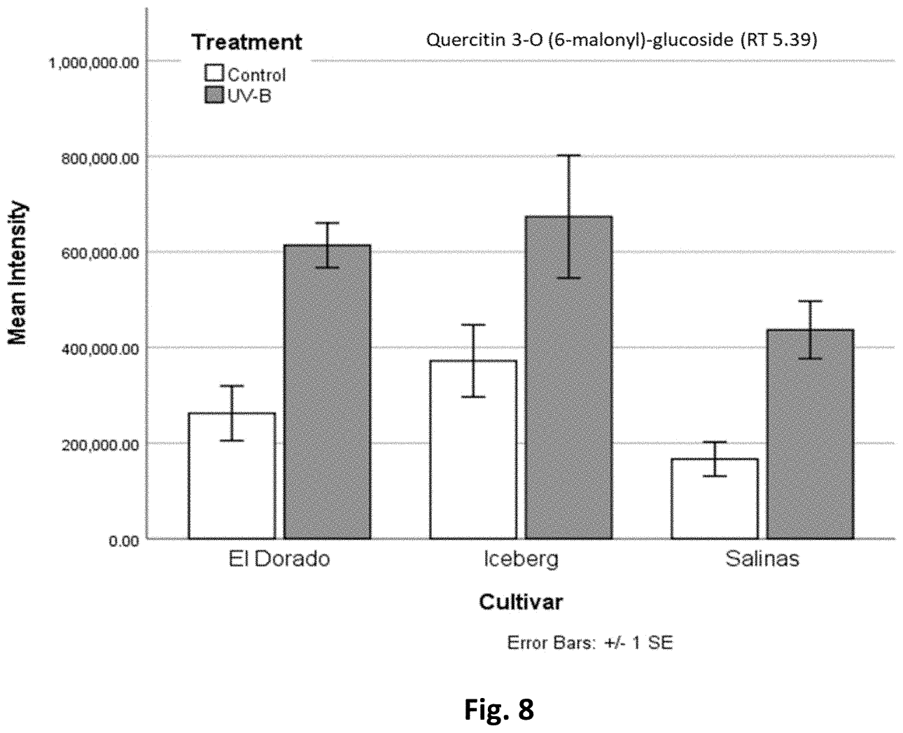

Cultivars that had received UV-B treatment contained higher levels of quercetin 3-O (6-malonyl)-glucoside as seen in FIG. 8. Table 1 contains the numerical values displayed in FIG. 8. Quercetin 3-O (6-malonyl)-glucoside levels increased 2.34-fold in the UV-B treated El Dorado cultivars compared to untreated cultivars, increased 1.81-fold in the UV-B treated Iceberg cultivars compared to untreated cultivars, and increased 2.62-fold in the UV-B treated Salinas cultivars compared to untreated cultivars.

TABLE 1
Quercetin 3-O (6-Malonyl)-Glucoside Levels in Lettuce Cultivars

| Cultivar | Treatment | Mean | S.E. | F.C. |
|---|---|---|---|---|
| ED | C | 2.62E+05 | 2.9E+04 | 2.34 |
| ED | UV | 6.14E+05 | 2.3E+04 | |
| IB | C | 3.72E+05 | 3.8E+04 | 1.81 |
| IB | UV | 6.74E+05 | 6.4E+04 | |
| SL | C | 1.67E+05 | 1.8E+04 | 2.62 |
| SL | UV | 4.37E+05 | 3.0E+04 | |

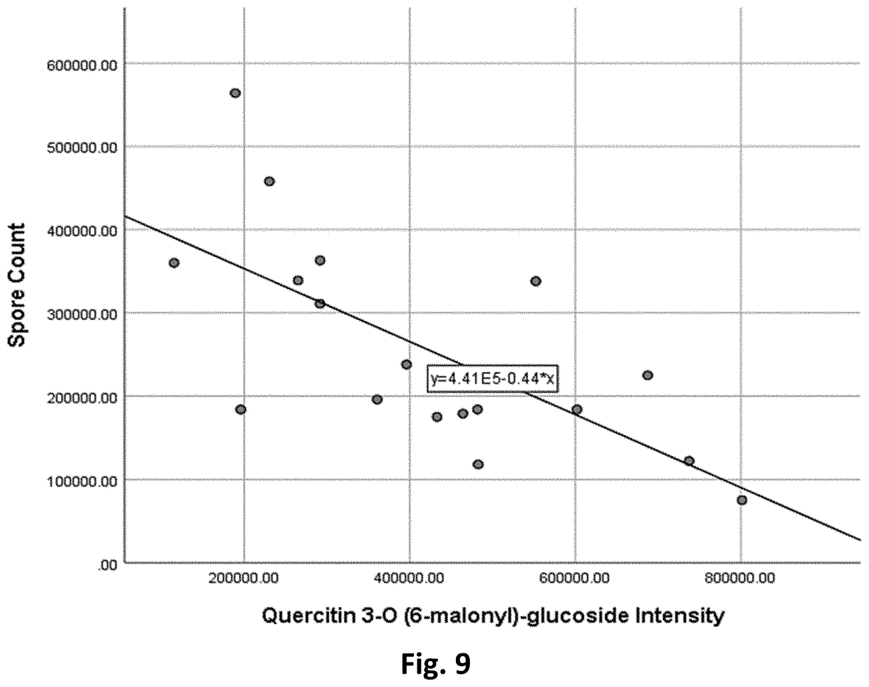

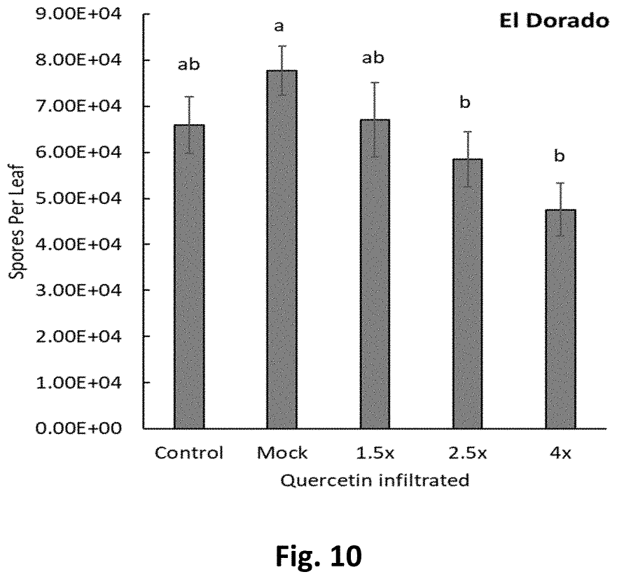

A correlation between the levels of quercetin 3-O (6-malonyl)-glucoside and spore count was observed. As quercetin 3-O (6-malonyl)-glucoside levels increased, the spore count decreased as seen in FIG. 9. The correlation between quercetin 3-O (6-malonyl)-glucoside intensity and Bremia spore count was calculated and the R square value was found to be 0.465, and the adjusted R square value was calculated as 0.432. Other correlation calculations are displayed in Table 2. Further, as seen in FIG. 10, leaf infiltration of quercetin 3-O (6-malonyl)-glucoside led to reduced Bremia spore count.

TABLE 2
Relationship Between Quercetin 3-O (6-Malonyl)-Glucoside
Intensity and Spore Count

| | | | Std. | Change Statistics | | | | |
|---|---|---|---|---|---|---|---|---|
| | | Adjusted | Error of the | R | F | | | Sig. F |
| R | R Square | R Square | Estimate | Square Change | Change | df1 | df2 | Change |
| −0.682 | 0.465 | 0.432 | 9.63E+04 | 0.465 | 13.905 | 1 | 16 | 0.002 |

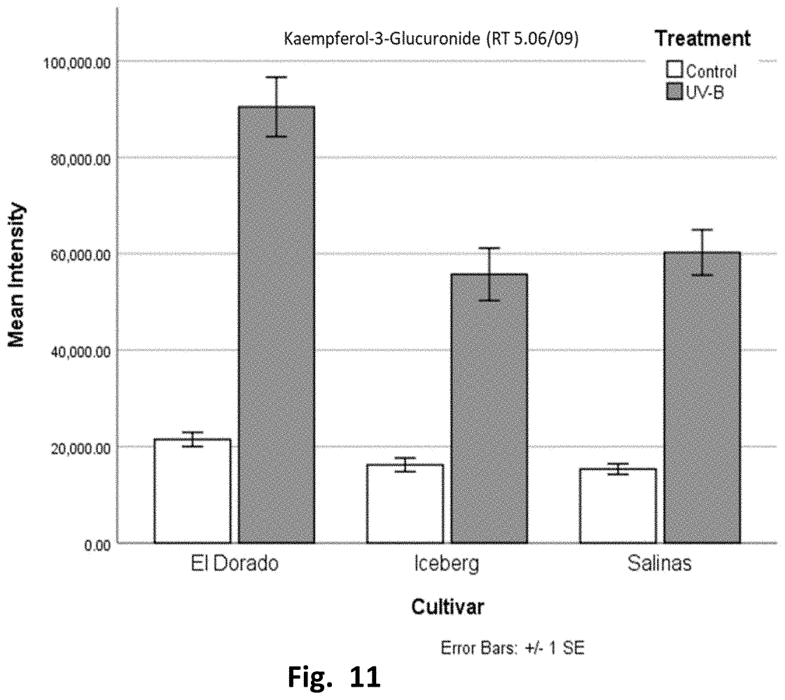

Mean intensity levels of the flavonoid kaempferol-3 glucuronide were measured in treated and untreated cultivars. In all cultivars, UV-B treated cultivars displayed higher levels of kaempferol-3 glucuronide than untreated cultivars as seen in FIG. 11 and Table 3. Kaempferol-3 glucuronide increased 4.21-fold in UV-B treated El Dorado cultivars compared to untreated cultivars, increased 3.44-fold in UV-B treated Iceberg cultivars compared to untreated cultivars, and increased 3.93-fold in UV-B treated Salinas cultivars compared to untreated cultivars.

TABLE 3
Kaempferol-3 Glucuronide Levels in Treated and
Untreated Lettuce Cultivars

| Cultivar | Treatment | Mean | S.E. | F.C. |
|---|---|---|---|---|
| ED | C | 2.15E+04 | 1.5E+03 | 4.21 |
| ED | UV | 1.62E+04 | 6.2E+03 | |
| IB | C | 1.53E+04 | 1.4E+03 | 3.44 |
| IB | UV | 9.05E+04 | 5.4E+03 | |
| SL | C | 5.57E+04 | 1.1E+03 | 3.93 |
| SL | UV | 6.03E+04 | 4.7E+03 | |

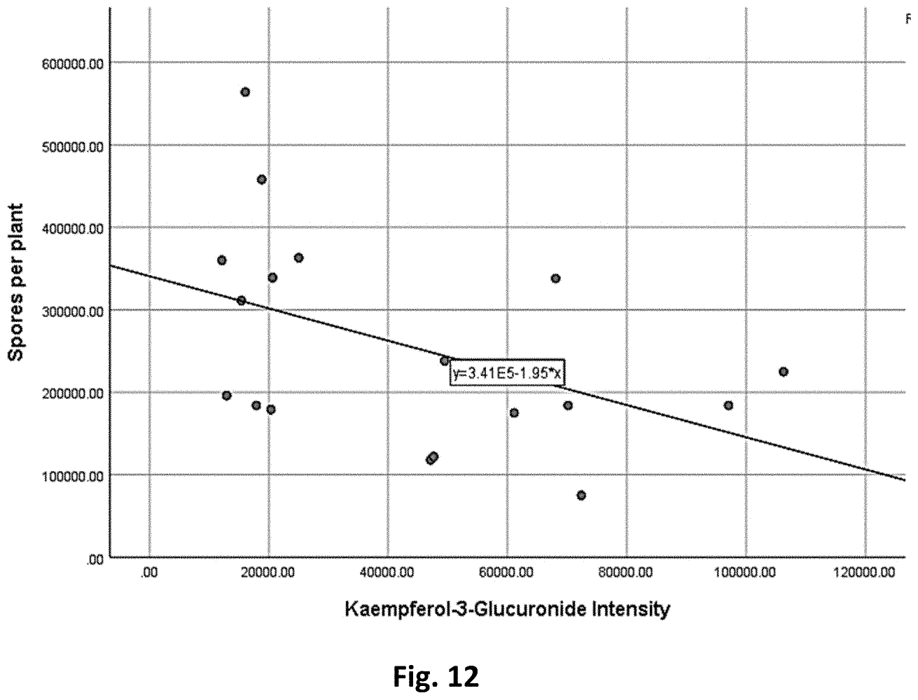

A correlation between the levels of kaempferol-3 glucuronide and spore count was observed. As kaempferol-3 glucuronide levels increased, the spore count decreased as seen in FIG. 12. The correlation between kaempferol-3 glucuronide intensity and Bremia spore count was calculated and the R square value was found to be 0.213 and the adjusted R square value was calculated as 0.163. Other correlation calculations are displayed in Table 4.

TABLE 4
Correlation Values Between Kaempferol-3 Glucuronide
Intensity and Bremia Spore Count

| | | | Std. | Change Statistics | | | | |
|---|---|---|---|---|---|---|---|---|
| | | Adjusted | Error of the | R | F | | | Sig. F |
| R | R Square | R Square | Estimate | Square Change | Change | df1 | df2 | Change |
| −0.461 | 0.213 | 0.163 | 1.17E+05 | 0.213 | 4.322 | 1 | 16 | 0.054 |

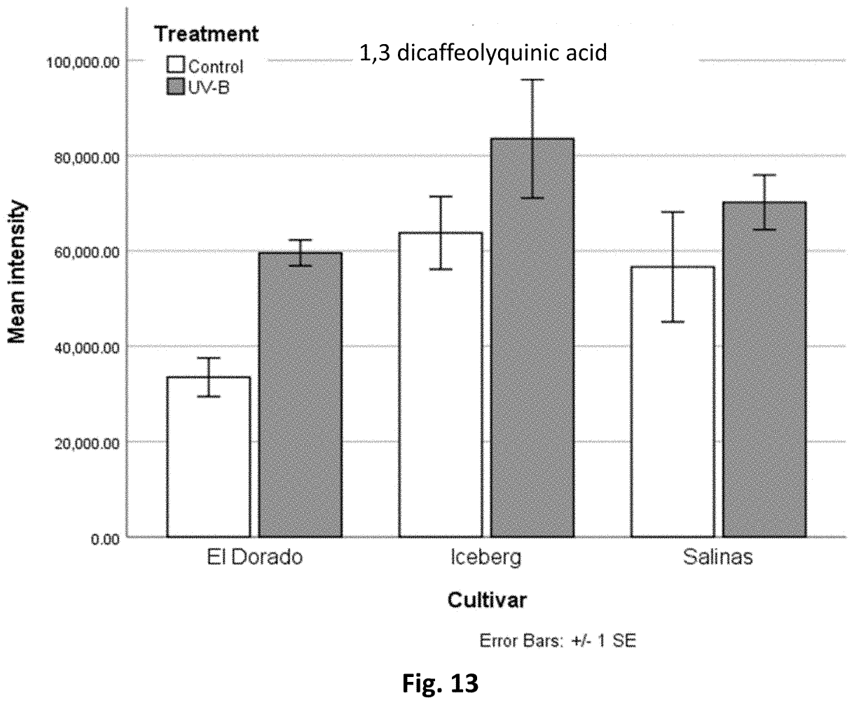

The compound 1,3 dicaffeolyquinic acid was measured in both UV-B treated and untreated cultivars of lettuce. In all cases, UV-B treated cultivars displayed a higher intensity of dicaffeolyquinic acid than untreated cultivars as seen in FIG. 13 and Table 5. Specifically, dicaffeolyquinic acid levels increased 1.78-fold in UV-B treated El Dorado cultivars compared to untreated cultivars, increased 1.31-fold in UV-B treated Iceberg cultivars compared to untreated cultivars, and increased 1.24-fold in UV-B treated Salinas cultivars compared to untreated cultivars.

TABLE 5
Levels of 1,3 Dicaffeolyquinic Acid in Treated and
Untreated Lettuce Cultivars

| Cultivar | Treatment | Mean | S.E. | F.C. |
|---|---|---|---|---|
| ED | C | 3.35E+04 | 4.0E+03 | 1.78 |
| ED | UV | 5.96E+04 | 2.7E+03 | |
| IB | C | 6.38E+04 | 7.6E+03 | 1.31 |
| IB | UV | 8.35E+04 | 1.2E+04 | |
| SL | C | 5.66E+04 | 1.2E+04 | 1.24 |
| SL | UV | 7.02E+04 | 5.7E+03 | |

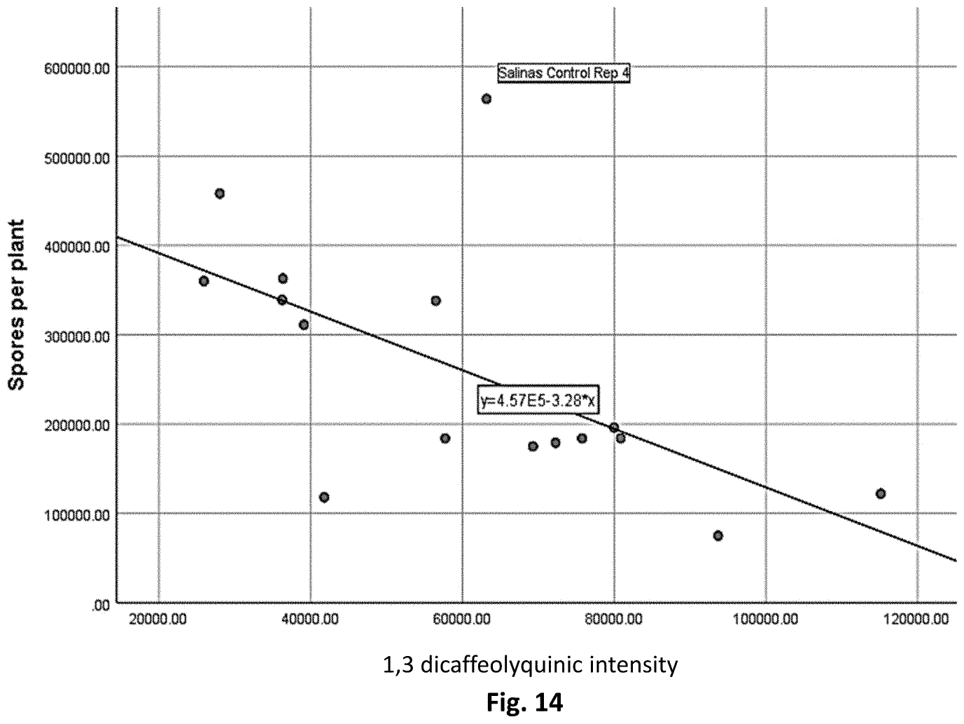

A correlation between the levels of 1,3 dicaffeolyquinic acid and spore count was observed. As 1,3 dicaffeolyquinic acid levels increased, the spore count decreased as seen in FIG. 14. The correlation between 1,3 dicaffeolyquinic acid intensity and Bremia spore count was calculated and the R square value was found to be 0.373 and the adjusted R square value was calculated as 0.334. Other correlation calculations are displayed in Table 6.

TABLE 6
Correlation Values Between 1,3 Dicaffeolyquinic Acid
Intensity and Spore Count

| | | | Std. | Change Statistics | | | | |
|---|---|---|---|---|---|---|---|---|
| | | Adjusted | Error of the | R | F | | | Sig. F |
| R | R Square | R Square | Estimate | Square Change | Change | df1 | df2 | Change |
| −0.611 | 0.373 | 0.334 | 1.04E+05 | 0.373 | 9.529 | 1 | 16 | 0.007 |

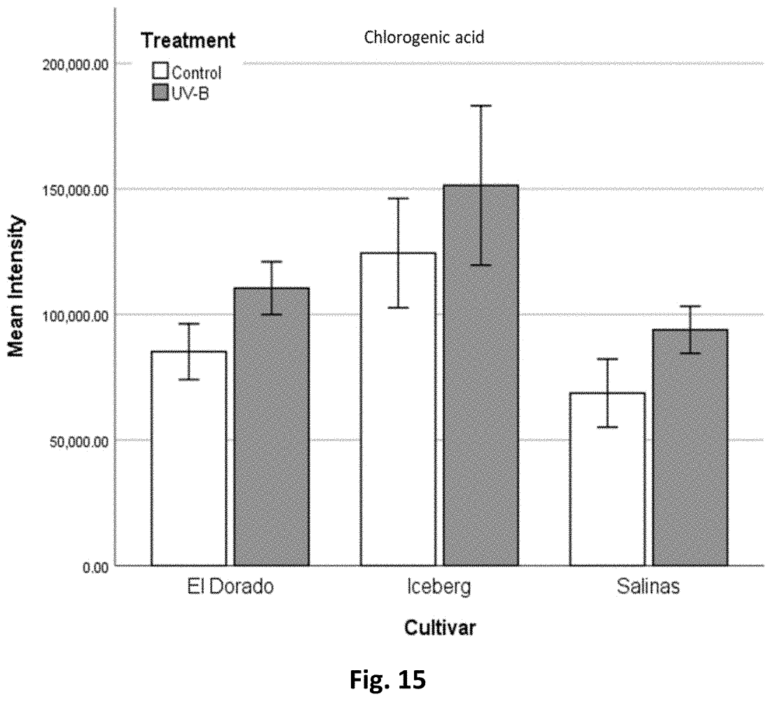

The compound chlorogenic acid was measured in both UV-B treated and untreated lettuce cultivars. In all cultivars, levels of chlorogenic acid increased under UV-B treatment as seen in FIG. 15 and Table 7. Specifically, chlorogenic acid increased 1.30-fold in UV-B treated El Dorado cultivars compared to untreated cultivars, increased 1.22-fold in UV-B treated Iceberg cultivars compared to untreated cultivars, and increased 1.37-fold in UV-B treated Salinas cultivars compared to untreated cultivars.

TABLE 7
Levels of Chlorogenic Acid in UV-B Treated and
Untreated Lettuce Cultivars

| Cultivar | Treatment | Mean | S.E. | F.C. |
|---|---|---|---|---|
| ED | C | 8.52E+04 | 1.11E+04 | 1.30 |
| ED | UV | 1.11E+05 | 1.05E+04 | |
| IB | C | 1.24E+05 | 2.18E+04 | 1.22 |
| IB | UV | 1.51E+05 | 3.18E+04 | |
| SL | C | 6.87E+04 | 1.35E+04 | 1.37 |
| SL | UV | 9.39E+04 | 9.35E+03 | |

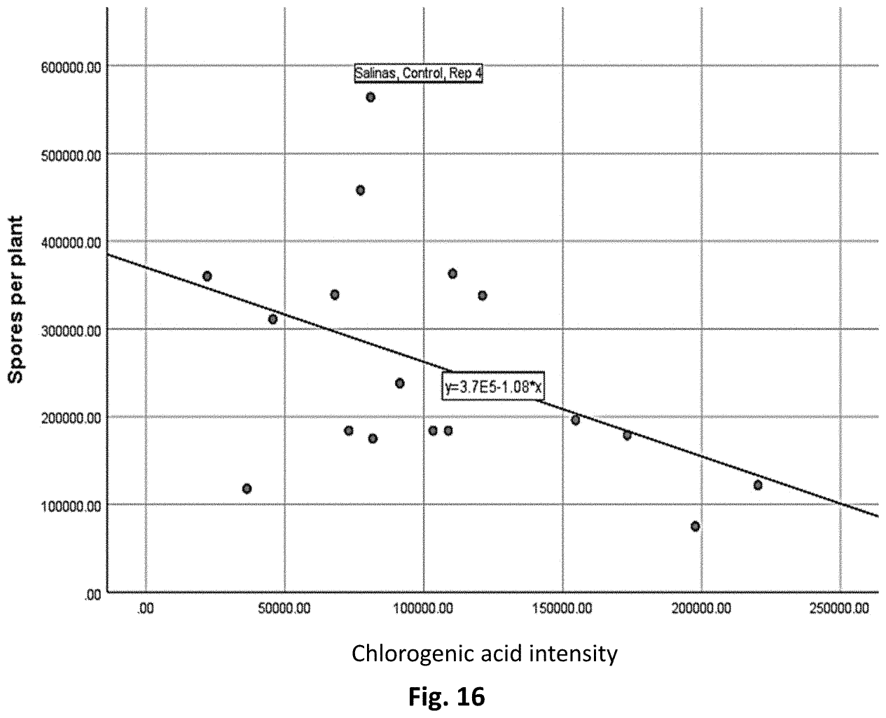

A correlation between the levels of chlorogenic acid and spore count was observed. As chlorogenic acid levels increased, the spore count decreased as seen in FIG. 16. Table 8 displays the correlation values for this data, including correlation between levels of chlorogenic acid with degree of infection (DoI) 8 days post inoculation (DPI) and degree of infection 12 days post inoculation. The correlation between intensity of chlorogenic acid and spores had an R square value of 0.209 and an adjusted R square value of 0.159. The correlation between intensity of chlorogenic acid and DoI 8DPI had an R square value of 0.367 and an adjusted R square value of 0.328. The correlation between intensity of chlorogenic acid and DoI 12DPI had an R square value of 0.336 and an adjusted R square value of 0.294.

TABLE 8
Correlation Between Intensity of Chlorogenic Acid
and Spores, DoI 8 DPI, and DoI 12 DPI

| | | | | | Change Statistics | | | | |
|---|---|---|---|---|---|---|---|---|---|
| | | | Adjusted | Std. Error | R | | | | |
| | | R | R | of the | Square | F | | | Sig. F |
| | R | Square | Square | Estimate | Change | Change | df1 | df2 | Change |
| Spores | −0.457 | 0.209 | 0.159 | 1.17E+05 | 0.209 | 4.225 | 1 | 16 | 0.057 |
| DoI | −0.606 | 0.367 | 0.328 | 15.85750 | 0.367 | 9.293 | 1 | 16 | 0.008 |
| 8DPI | | | | | | | | | |
| DoI | .579a | 0.336 | 0.294 | 13.40961 | 0.336 | 8.086 | 1 | 16 | 0.012 |
| 12DPI | | | | | | | | | |

This example illustrated UV-B treatment increased the levels of multiple compounds in lettuce, including of quercetin 3-O (6-malonyl)-glucoside, kaempferol-3-glucuronide, 1,3 dicaffeolyquinic acid, and chlorogenic acid. Furthermore, increased levels of these compounds correlated with decreased spore count in plants.

### Example 3

### Principle Component Analysis of LC-MS Data

This example assessed the relationship between disease measurements and metabolomic data.

The disease measurements included the following: degree of infection (DoI) at 8 days post inoculation (DPI), DoI at 12 DPI, and spore count. Significant features were determined by an ANOVA test, where filtering for isotopes had occurred and possible artifact peaks had been removed.

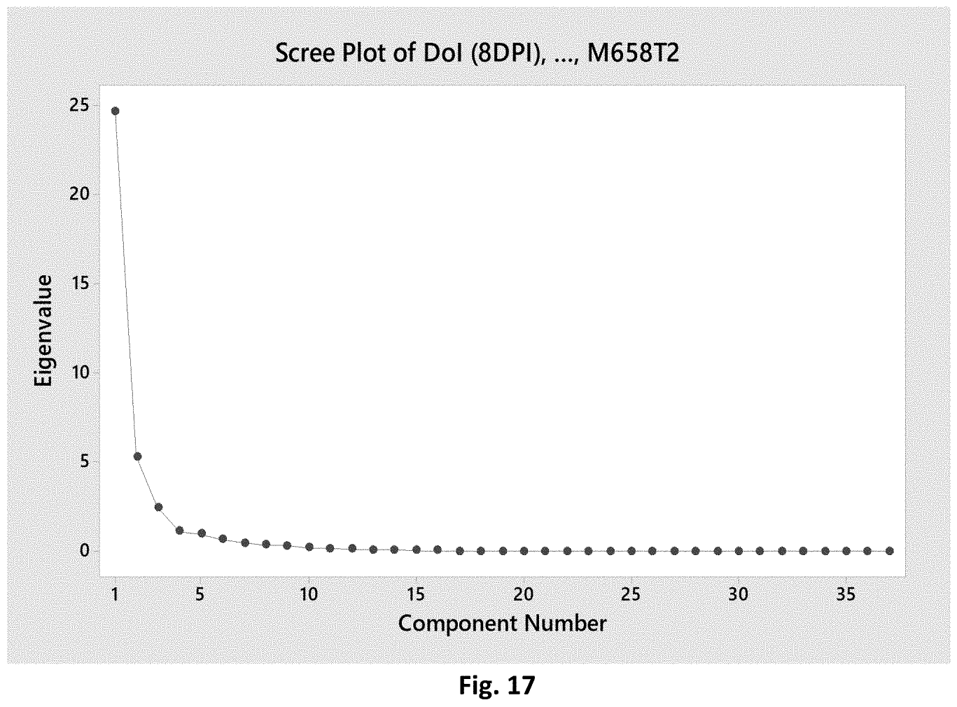

The number of factors to be retained in the principal component analysis (PCA) was determined by the eigenvalues of principle components, which were plotted against the component number as seen in FIG. 17. This determined that the first four components should be retained according to the Kaiser criterion in which eigen values over one are retained. These first four components accounted for 90.7% of the variation. Component one had a very strong influence accounting for 60.3% of variance followed by component 2, which accounted for 20.7% of variance. A reference line could not be calculated; therefore, outliers could not be identified using minitab PCA analysis.

Scores for the first component were most heavily influenced negatively by spore count (−0.127) but were also negatively affected by DoI (8DPI: −0.082, 12DPI: −0.078). Most metabolic features affected the first component positively (eigen vector 0.16-0.19), while a small few (features 2a, 2b, and 4a, and undefined/z658 rt2) had a weaker positive effect on the first component (0.064-0.094). One metabolic feature (feature 20b) had a weak negative effect on the first component (20b).

Scores for the first second component were less grouped. The contribution of DoI values produced the most positive effect (0.37), followed by spore count and an array of metabolic features (0.017-0.288). Some metabolic features had a negative effect on the second component with the strongest contributors being features 21a, 20b and undefined/z658 rt2 (−0.171 to −0.145).

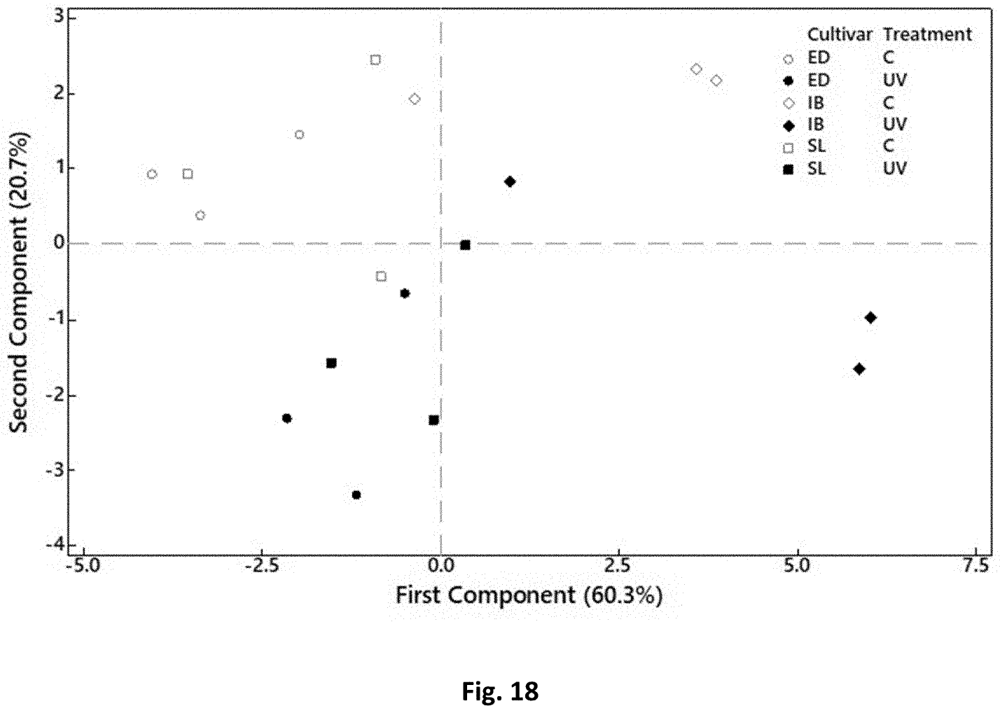

When the different cultivars were plotted against the first two components, a clear UV effect was seen across the first component as depicted in FIG. 18. The second component tended to separate the cultivars. Separation of cultivars was more pronounced in UV-B treated plants compared to control. Control scores were clustered together, except for Iceberg, which was more separated along both the first and second component.

The first component of the PCA was plotted against the second component of the PCA, highlighting groupings of variables and relationships between variables (data not shown). Grouping was obvious with most metabolic features sitting together along the positive side of component one except feature 20b. This group was further divided into 4 sub-groups along the second component. As the features identified were unknown, these subgroups were not currently further characterized but as suggested by the score plot, the separation could be due to cultivar differences. Disease measures were grouped together on the negative side of the first component. Spore count and Dol were also separated in subgroups by the second component. Metabolic feature 20b was separated by other metabolic features by the component but was also separated from the disease measures by the component. The disease measures (Dol 8DPI, Dol 12DPI, spore count) were located in a distinct space from each other metabolic feature group. The loading plot suggested the metabolic feature group (except feature 20b) negatively correlated with disease measures.

Pathways that were influenced by the interactions between UV-B and cultivar were identified using a pathway analysis of the LC-MS data that was performed using the metabolic model ARA and BioCyc 13.0. The most affected pathways were those belonging to the phenylpropanoid pathway, including the flavonoid pathways, kaempferol glycoside biosynthesis (Arabidopsis), quercetin glycoside biosynthesis (Arabidopsis), luteolin glycosides biosynthesis, syringetin biosynthesis, anthocyanin biosynthesis (Arabidopsis), and polyphenol ester pathway, chlorogenic acid as seen in Table 9. Sugar pathways stachyose biosynthesis as well as degradation, and ajugose biosynthesis II (galactinol-independent) were also significantly altered by treatment and cultivar interaction.

TABLE 9
Analysis of Synthesis Pathways

| Pathways | Overlap size | Pathway size | p-value |
|---|---|---|---|
| stachyose biosynthesis | 4 | 4 | 0.002 |
| kaempferol glycoside biosynthesis (Arabidopsis) | 5 | 7 | 0.004 |
| quercetin glycoside biosynthesis (Arabidopsis) | 6 | 10 | 0.005 |
| luteolin glycosides biosynthesis | 3 | 3 | 0.005 |
| syringetin biosynthesis | 3 | 4 | 0.013 |
| chlorogenic acid biosynthesis I | 3 | 4 | 0.013 |
| ajugose biosynthesis II (galactinol-independent) | 3 | 4 | 0.013 |
| chlorogenic acid biosynthesis II | 3 | 4 | 0.013 |
| anthocyanidin modification (Arabidopsis) | 2 | 2 | 0.025 |
| phenylpropanoid biosynthesis | 3 | 5 | 0.027 |
| stachyose degradation | 3 | 5 | 0.027 |
| flavonoid biosynthesis (in equisetum) | 4 | 9 | 0.048 |
| flavanol biosynthesis | 3 | 6 | 0.049 |

Features

Features of the LC-MS fell into three major patterns: (1) General UV increase (all cultivars showed an increase in UV treated), (2) IB+UV increase (Iceberg was higher in control, all cultivars were higher in UV), and (3) General UV decrease (all cultivars showed a decrease in UV- treated). The pattern 2 feature response was most similar to the UV disease response. This was shown through the visual pattern as well as through the strongest significant negative correlations with spore count. Some pattern 1 features had a significant correlation with spore count; however, these were weaker. No pattern 3 features were significantly correlated with spore count.

Pattern 1

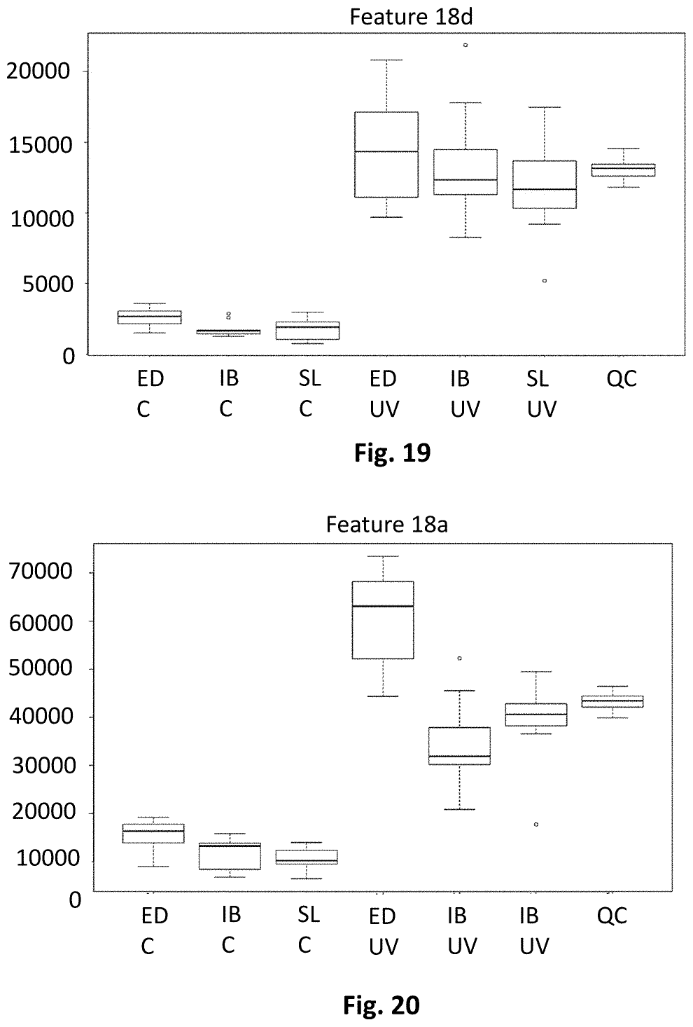

The level of intensity of a feature was increased in UV-B treated plants for each cultivar. Feature 18d was one such example of pattern 1 as seen in FIG. 19. An interesting subset of pattern 1 features had an exaggerated increase in levels in the UV-B treated El Dorado cultivar. One feature which displayed this pattern was feature 18a, shown in FIG. 20.

Putative identities given were the most likely from a list based off m/z value and adducts (metlin/mummichog). These are shown in Table 29. The fold change of the feature in UV-B treated and untreated cultivars of some pattern 1 features are listed for each cultivar in Table 10.

TABLE 10
Pattern 1 Features

| | | | El Dorado | | Iceberg | | Salinas | |
|---|---|---|---|---|---|---|---|---|
| Peak | Mz | | Fold | P | Fold | P | Fold | P |
| ID | med | Rtmed | change | value | change | value | change | value |
| 20a | 353.09 | 5.87 | 4.139* | 0.0004 | 3.970* | 0.0061 | 3.471* | 0.0003 |
| 18d | 447.10 | 5.06 | 5.219* | 0.0000 | 7.642* | 0.0000 | 6.779* | 0.0000 |
| 18a | 461.08 | 5.09 | 3.942* | 0.0000 | 2.944* | 0.0001 | 3.623* | 0.0000 |
| 14a | 463.09 | 4.89 | 3.814* | 0.0000 | 3.176* | 0.0001 | 5.122* | 0.0000 |
| 14b | 464.09 | 4.89 | 4.238* | 0.0000 | | | 4.131* | 0.0000 |
| 14c | 813.14 | 5.00 | 3.132 | 0.0032 | 2.693* | 0.0252 | 2.653* | 0.0132 |
| 18b | 909.18 | 5.07 | 8.668* | 0.0002 | 5.429* | 0.0015 | | |
| 18c | 923.16 | 5.08 | 11.926* | 0.0000 | 5.219* | 0.0017 | 14.559* | 0.0001 |
| 14d | 937.17 | 5.02 | 9.572* | 0.0001 | 7.582* | 0.0031 | 8.649* | 0.0004 |
| 17a | 951.15 | 4.99 | 3.422 | 0.0163 | 4.458* | 0.0054 | 4.207* | 0.0006 |
| 17b | 955.15 | 4.97 | 3.459 | 0.0000 | 4.785* | 0.0022 | 4.100* | 0.0001 |
| 19a | 1099.20 | 5.39 | 3.342 | 0.0000 | | | 4.776* | 0.0000 |
| 19b | 1101.20 | 5.40 | 3.839* | 0.0000 | 2.501* | 0.0012 | 5.042* | 0.0000 |
| 19c | 1396.71 | 5.40 | 3.655* | 0.0000 | 2.548* | 0.0009 | 5.598* | 0.0001 |

*refers to significant features

Several pattern 1 features were also correlated with different disease measures (Dol 8 DPI, DoI 12 DPI and spore count) as seen in Table 11. Two of these features, features 14e and 18c had moderate negative correlations with disease severity. These features correlated more strongly with the rating scale (DoI) than with the spore count. Feature 14d showed a moderate negative correlation with disease measurements and a relatively high fold change in all three cultivars.

TABLE 11
Correlation Between Disease Severity Measures and Compound Level of
Features From Pattern 1

| | | Feature | | | | | | | |
|---|---|---|---|---|---|---|---|---|---|
| Peak ID | | 20a | 18d | 18a | 14c | 18c | 14d | 17a | 17b |
| m/z: | | 353.09 | 447.10 | 461.08 | 813.14 | 923.16 | 937.17 | 951.15 | 955.15 |
| Retention time: | | 5.87 | 5.06 | 5.09 | 5.00 | 5.08 | 5.02 | 4.99 | 4.97 |
| 8DPI DoI | Pearson | — | — | — | — | — | — | — | — |
| | Correlation | 0.433 | 0.489 | 0.631 | 0.484 | 0.664 | 0.679 | 0.536 | 0.644 |
| | Sig. (2-tailed) | 0.073 | 0.039* | 0.005* | 0.042* | 0.003* | 0.002* | 0.022* | 0.004* |
| 12DPI DoI | Pearson | — | — | — | — | — | — | — | — |
| | Correlation | 0.316 | 0.438 | 0.627 | 0.377 | 0.665 | 0.629 | 0.468 | 0.627 |
| | Sig. (2-tailed) | 0.201 | 0.069 | 0.005* | 0.123 | 0.003* | 0.005* | 0.050 | 0.005* |
| Spore | Pearson | — | — | — | — | — | — | — | — |
| count | Correlation | 0.121 | 0.333 | 0.524 | 0.235 | 0.564 | 0.506 | 0.313 | 0.468 |
| | Sig. (2-tailed) | 0.634 | 0.177 | 0.025* | 0.348 | 0.015* | 0.032* | 0.206 | 0.050* |

*indicates a significant correlation

Pattern 2

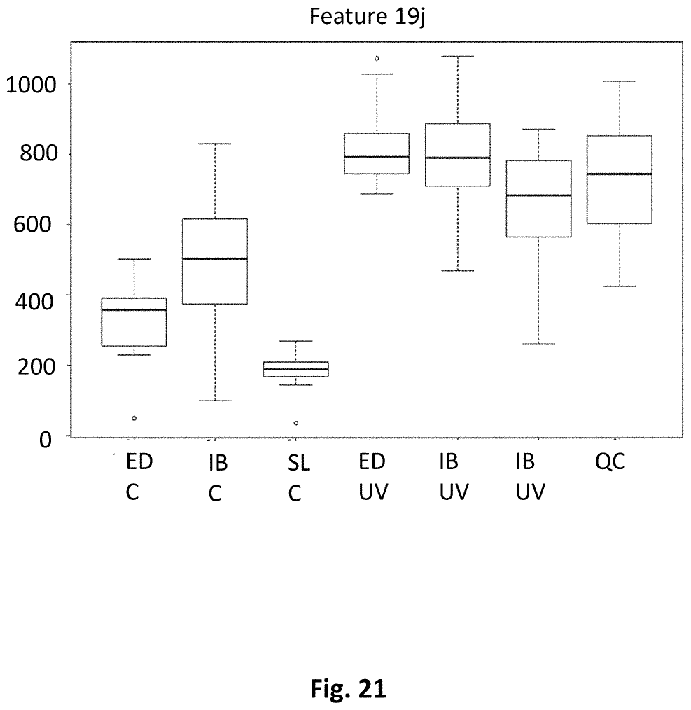

Pattern 2 demonstrated interesting features as it mimicked the disease reduction pattern seen in this set of experiments. One example of a pattern two feature was feature 19j as seen in FIG. 21. In this feature, under control conditions, the feature was higher in Iceberg lettuce. Additionally, all cultivars showed an increase in feature level in UV-B treated cultivars when compared to untreated cultivars. Xcms and other databases gave multiple (or no) putative identities for most pattern 2 features.

Pattern 2 features tended to correlate more strongly with spore count (negative correlation) than pattern 1 but had slightly weaker correlations with rating scales (DoI), as listed in Table 12. The negative correlations with spore count appeared to be strongest with the features 19j and 19h, which had Pearson correlations of −0.722 and −0.705 respectively. Many other features in pattern 2 had strong negative correlations (Pearson's Coefficient −0.680 to −0.690).

TABLE 12
Correlation Between Disease Severity Measures and
Compound Level of Pattern 2 Features

| | | Feature | | | | | | |
|---|---|---|---|---|---|---|---|---|
| Peak ID | | | 21a | 19d | 19e | | 19f | 19k |
| m/z | | 473.07 | 489.11 | 505.10 | 549.09 | 563.10 | 611.02 | 644.01 |
| Retention time | | 5.00 | 6.17 | 5.39 | 5.39 | 6.29 | 5.39 | 5.39 |
| 8DPI | Pearson | −0.487 | −0.464 | −0.524 | −0.550 | −0.584 | −0.519 | −0.355 |
| DoI | Correlation | | | | | | | |
| | Sig. (2- | 0.041* | 0.052 | 0.025* | 0.018* | 0.011* | 0.027* | 0.148 |
| | tailed) | | | | | | | |
| 12DPI | Pearson | −0.438 | −0.431 | −0.514 | −0.533 | −0.579 | −0.522 | −0.347 |
| DoI | Correlation | | | | | | | |
| | Sig. (2- | 0.069 | 0.074 | 0.029* | 0.023* | 0.012* | 0.026* | 0.159 |
| | tailed) | | | | | | | |
| Spore | Pearson | −0.565 | −0.320 | −0.679 | −0.682 | −0.684 | −0.690 | −0.586 |
| count | Correlation | | | | | | | |
| | Sig. (2- | 0.015* | 0.196 | 0.002* | 0.002* | 0.002* | 0.002* | 0.011* |
| | tailed) | | | | | | | |

| | | Feature | | | | | | | |
|---|---|---|---|---|---|---|---|---|---|
| Peak ID | | 19a | 19b | 19g | 19h | 19l | 19i | 19c | 19j |
| m/z | | 1099.19 | 1101.20 | 1122.16 | 1143.11 | 1148.11 | 1153.10 | 1396.71 | 1423.66 |
| Retention time | | 5.39 | 5.39 | 5.39 | 5.39 | 5.39 | 5.39 | 5.39 | 5.39 |
| 8DPI | Pearson | −0.544 | −0.547 | −0.481 | −0.502 | −0.425 | −0.484 | −0.546 | −0.576 |
| DoI | Correlation | | | | | | | | |
| | Sig. (2- | 0.020* | 0.019* | 0.043* | 0.034* | 0.079 | 0.042* | 0.019* | 0.012* |
| | tailed) | | | | | | | | |
| 12DPI | Pearson | −0.525 | −0.525 | −0.457 | −0.504 | −0.437 | −0.474 | −0.524 | −0.537 |
| DoI | Correlation | | | | | | | | |
| | Sig. (2- | 0.025* | 0.025* | 0.057 | 0.033* | 0.069 | 0.047* | 0.026* | 0.022* |
| | tailed) | | | | | | | | |
| Spore | Pearson | −0.679 | −0.669 | −0.663 | −0.705 | −0.681 | −0.677 | −0.667 | −0.722 |
| count | Correlation | | | | | | | | |
| | Sig. (2- | 0.002* | 0.002* | 0.003* | 0.001* | 0.002* | 0.002* | 0.003* | 0.001* |

*indicates significant

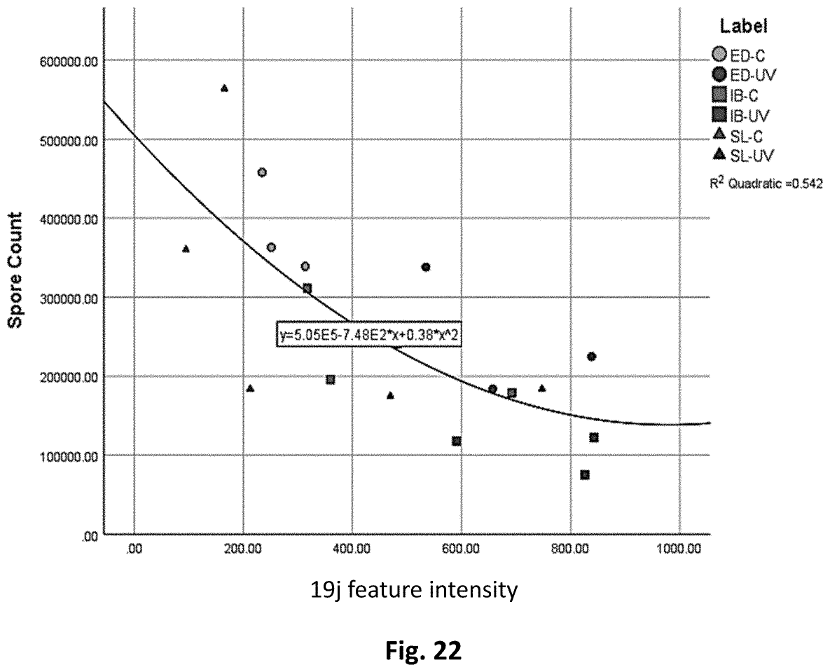

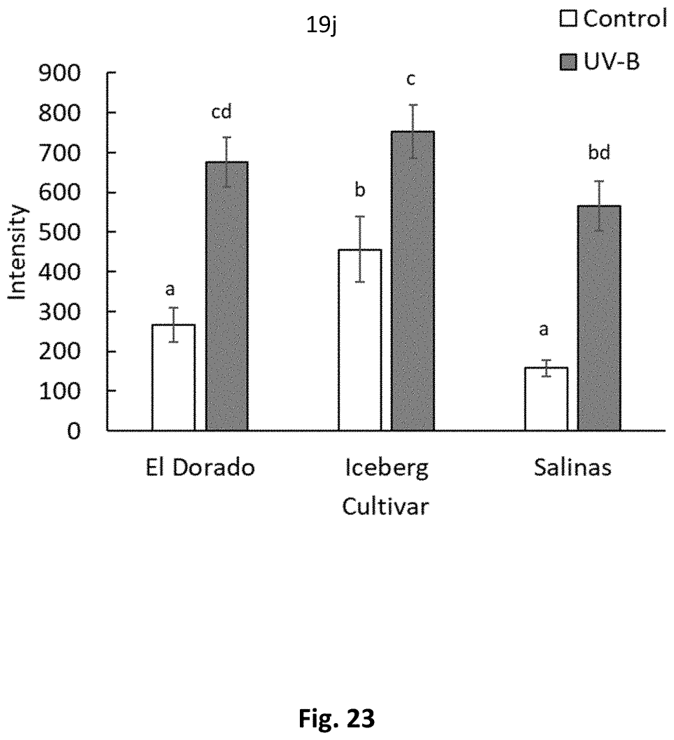

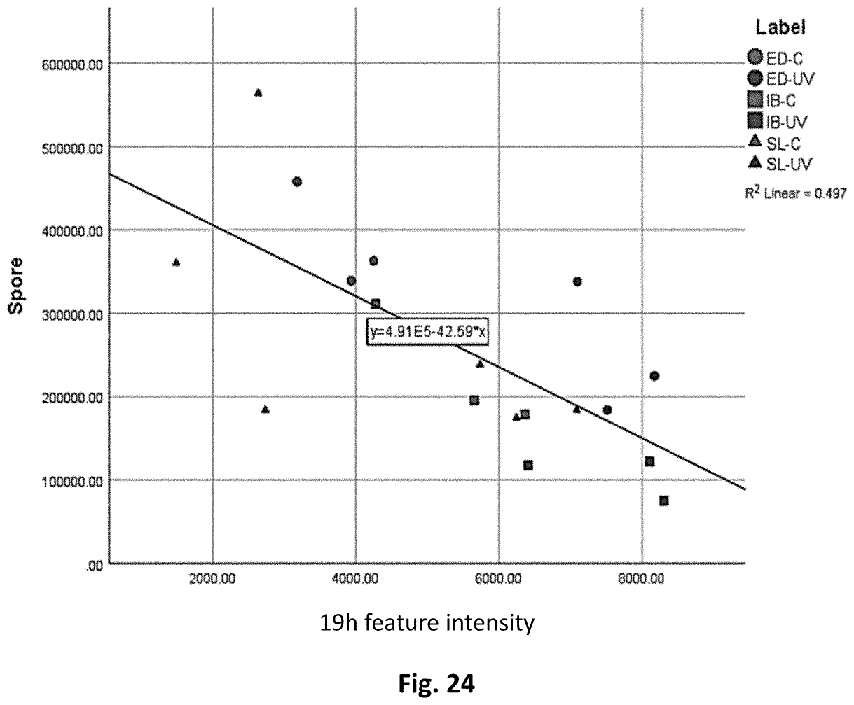

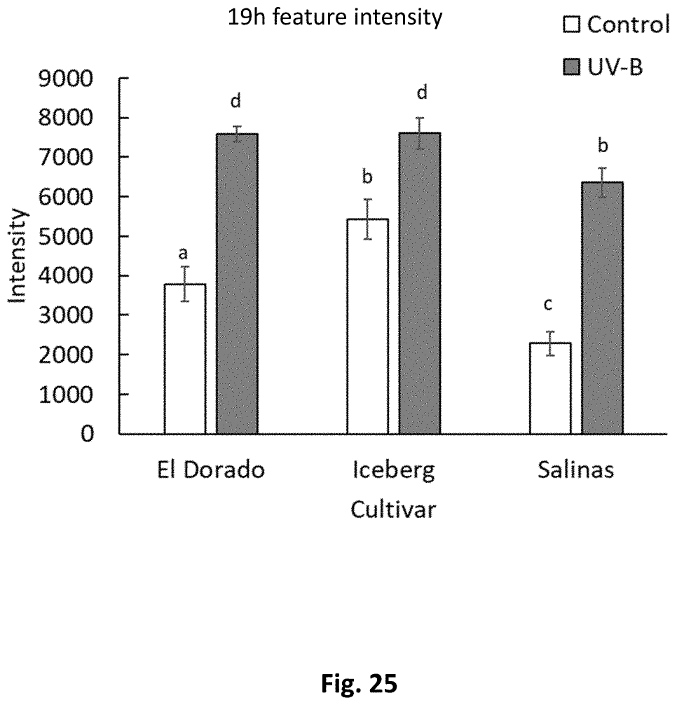

The features, which showed the strongest negative correlations with disease factors, 19j and 19h were further analyzed. When 19j intensity was plotted against spore count, M1424T5 intensity negatively correlated with spore count as seen in FIG. 22. Furthermore, 19j intensity was increased in UV-B treated cultivars compared to untreated cultivars for the El Dorado, Iceberg and Salinas strains as in FIG. 23. When 19h intensity was plotted against spore count, 19h intensity negatively correlated with spore count as seen in FIG. 24. 19h intensity was increased in UV-B treated cultivars compared to untreated cultivars for the El Dorado, Iceberg and Salinas strains as seen in FIG. 25.

Pattern 3

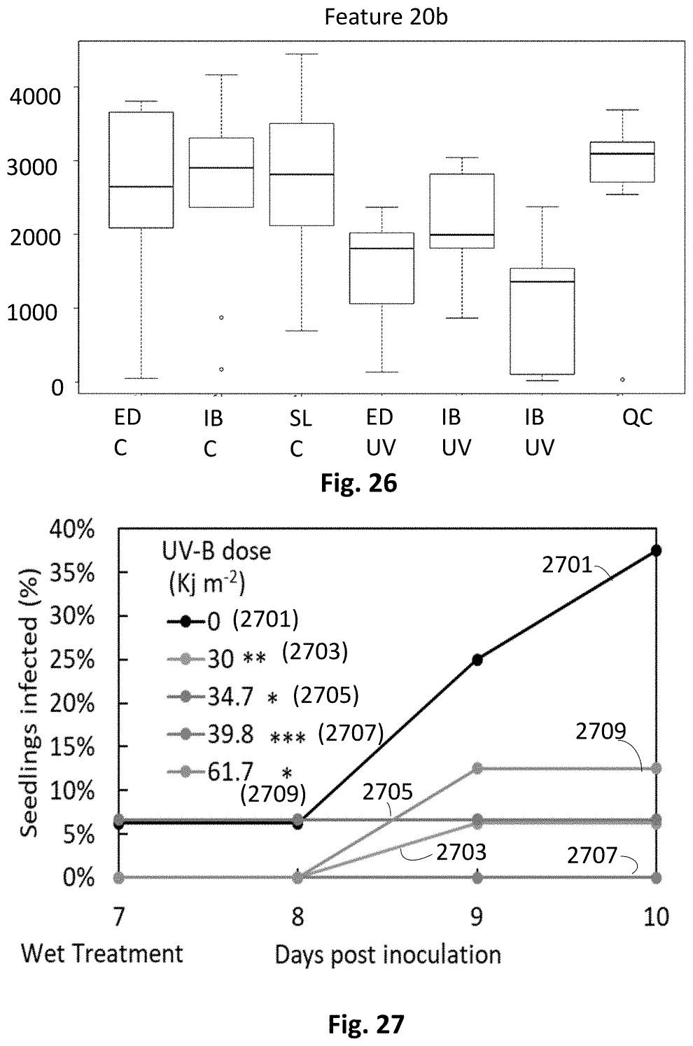

Pattern 3 features generally decreased in the UV-B treated versions of cultivars. One example of a pattern 3 feature, feature 20b, is shown in FIG. 26. Only the Salinas of feature M295T6 displayed a significant decrease in UV compared to control plants, with a magnitude of >2.5 fold out of all features found. No features identified as pattern 3 were correlated with any disease measures.

Other Features

The features discussed in this example were not the only features of interest identified. Table 13 depicts a nonexclusive list of features contemplated, among others, for use in the present disclosure. This list includes features found in pattern 1 and features found in pattern 2.

TABLE 13
Other Features

| Name | Pattern | mzMed | RT | Peak Id |
|---|---|---|---|---|
| M461T5 | 1 | 461.08 | 5.09 | 18a |
| M923T5 | 1 | 923.16 | 5.08 | 18b |
| M505T5 | 2 | 505.0993 | 5.390517 | 19d |
| M549T5 | 2 | 549.0914 | 5.387283 | 19e |
| M1099T5 | 2 | 1099.195 | 5.390425 | 19a |
| M611T5 | 2 | 611.0188 | 5.394 | 19f |
| M1122T5 | 2 | 1122.161 | 5.390483 | 19g |
| M1143T5 | 2 | 1143.112 | 5.390533 | 19h |
| M1153T5 | 2 | 1153.103 | 5.387117 | 19i |
| M563T6 | 2 | 563.1032 | 6.293567 | |
| M937T5 | 1 | 937.17 | 5.02 | 14d |
| M1101T5 | 2 | 1101.198 | 5.387283 | 19b |
| M1397T5 | 2 | 1396.706 | 5.387233 | 19c |
| M1424T5 | 2 | 1423.661 | 5.3905 | 19j |

As seen in this example, LC-MS analysis identified many new features of interest involved in the plant UV-B response system. These features were linked to many synthesis pathways, including flavonoid synthesis pathways.

### Example 4

### Disease Protection Against Bremia lactucae in Lettuce Seedlings

This example assessed the ability of different doses of UV-B radiation administered to seeds to protect lettuce seedlings against disease.

Methods

Circles of capillary matting were placed in 20 60 mm diameter petri dishes. 15 dishes were saturated with approximately 20 mL of PEG solution and 5 petri dishes remained dry. 50 mg of lettuce seeds were placed on filter paper in the petri dishes and the weight of the petri dishes, PEG solution, filter paper, matting and seeds were recorded.

1 wet dish and one dry dish was placed in each treatment area, while the remaining dishes were treated in the control area. The treatment areas contained an irradiance of 0.3 kJ m⁻² h⁻¹(Area 1), 0.7 kJ m⁻² h⁻¹ (Area 2), 1.3 kJ m⁻² h⁻¹(Area 3), 1.7 kJ m⁻² h⁻¹ (Area 4), 2.9 kJ m² h⁻¹ (Area 5/Ultra high), or 0 kJ m⁻² h⁻¹ (control). At 3 hours post treatment, a wet dish was moved from the control area to each of Areas 1-4 and treatment was resumed. At 6 hours after treatment initiation, treatment was paused and distilled water was added so that all dishes reached their original weight. A wet dish was removed from the control area to each of areas 1-5 and treatment was resumed. At 23 hours post treatment, treatment was paused and distilled water was added to each dish until it reached its original weight. Treatment was resumed until 27 hours post treatment initiation time. After treatment, dry seeds were placed in a refrigerator and wet seeds were placed in a humidity chamber at 24° C., 50% relative humidity for 24 hours to dry. Once dried, seeds were stored in a refrigerator.

20 seeds were placed on moistened filter paper in a plastic plant growth box. The box was sealed and placed in a 15° C. controlled temperature room with a photoperiod of 14 hours. After 3 days, the seedlings were transplanted onto black tissue paper in Magenta GA7 boxes. 7 days post sowing, seedlings were inoculated with 1 mL per box of 10⁵ condia mL⁻¹ Bremia lactucae using an atomizer. Seedlings were placed in the dark for 24 hours, then returned to a 15° C. controlled temperature room with a photoperiod of 14 hours. Measurements of disease incidence, severity and infectability were taken at 7-10 days post-inoculation (DPI).

Results

Disease incidence over time was significantly reduced (individual survival analysis, P<0.05) by wet UV-B seed treatment doses 30.8, 34.7, 39.8, and 61.7 kJ m⁻² as seen in FIG. 27 and Table 14. Incidence was not significantly altered at any single time points (Fisher's exact test). A UV-B dose of 79.3 kJ m⁻² significantly increased disease over the entire disease period (survival analysis, P=0.006).

TABLE 14
Percent of Plants Showing Infection by Bremia

| | Osmoprime | Dose | % of plants |
|---|---|---|---|
| DPI | status | (kJ m⁻²) | infected |
| 7 | Primed | 0 | 6% |
| 7 | Primed | 15.9 | 6% |
| 7 | Primed | 30.8 | 0% |
| 7 | Primed | 34.7 | 7% |
| 7 | Primed | 34.8 | 0% |
| 7 | Primed | 39.8 | 0% |
| 7 | Primed | 44.8 | 0% |
| 7 | Primed | 61.7 | 0% |
| 7 | Primed | 79.3 | 19% |
| 8 | Primed | 0 | 6% |
| 8 | Primed | 15.9 | 6% |
| 8 | Primed | 30.8 | 0% |
| 8 | Primed | 34.7 | 7% |
| 8 | Primed | 34.8 | 0% |
| 8 | Primed | 39.8 | 0% |
| 8 | Primed | 44.8 | 6% |
| 8 | Primed | 61.7 | 0% |
| 8 | Primed | 79.3 | 38% |
| 9 | Primed | 0 | 25% |
| 9 | Primed | 15.9 | 13% |
| 9 | Primed | 30.8 | 6% |
| 9 | Primed | 34.7 | 7% |
| 9 | Primed | 34.8 | 13% |
| 9 | Primed | 39.8 | 0% |
| 9 | Primed | 44.8 | 19% |
| 9 | Primed | 61.7 | 13% |
| 9 | Primed | 79.3 | 56% |
| 10 | Primed | 0 | 38% |
| 10 | Primed | 15.9 | 25% |
| 10 | Primed | 30.8 | 6% |
| 10 | Primed | 34.7 | 7% |
| 10 | Primed | 34.8 | 19% |
| 10 | Primed | 39.8 | 0% |
| 10 | Primed | 44.8 | 25% |
| 10 | Primed | 61.7 | 13% |
| 10 | Primed | 79.3 | 56% |
| 7 | Unprimed | 0 | 0% |
| 7 | Unprimed | 34.7 | 0% |
| 7 | Unprimed | 44.8 | 0% |
| 8 | Unprimed | 0 | 0% |
| 8 | Unprimed | 34.7 | 13% |
| 8 | Unprimed | 44.8 | 6% |
| 9 | Unprimed | 0 | 0% |
| 9 | Unprimed | 34.7 | 19% |
| 9 | Unprimed | 44.8 | 6% |
| 10 | Unprimed | 0 | 7% |
| 10 | Unprimed | 34.7 | 38% |
| 10 | Unprimed | 44.8 | 6% |

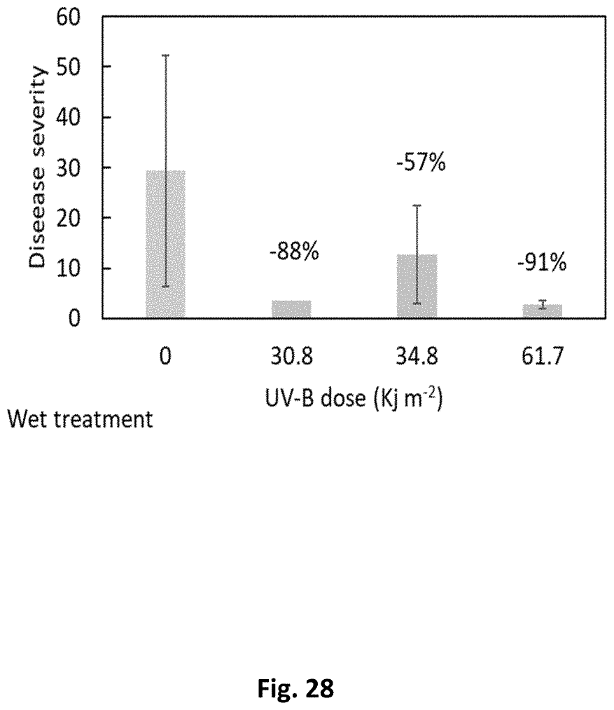

Disease severity was measured by taking a visual estimate of the percentage of leaf tissue that displayed downy mildew symptoms. Measurements were taken 7 to 10 days DPI and ratings of infected plants were used to create a disease progression curve. The area under the disease progression curve (AUDPC) was used to represent disease severity as seen in FIG. 28 and Table 15. Several doses (30.8, 34.8, and 61.7 kJ m⁻²) reduced disease severity compared to control.

TABLE 15
Disease Severity in Lettuce
Seedlings Infected with Bremia

| Dose | Osmoprime | mean | Standard |
|---|---|---|---|
| (kJ/m⁻²) | status | AUDPC | Error |
| 0 | Primed | 29.375 | 22.94684 |
| 15.9 | Primed | 165 | 115 |
| 30.8 | Primed | 3.5 | #N/A |
| 34.7 | Primed | 184 | #N/A |
| 34.8 | Primed | 12.75 | 9.75 |
| 44.8 | Primed | 46.875 | 3.442232 |
| 61.7 | Primed | 2.75 | 0.75 |
| 79.3 | Primed | 76.54444 | 14.5984 |
| 34.7 | Unprimed | 52.91667 | 24.96178 |
| 44.8 | Unprimed | 34.375 | #N/A |

Seedlings which displayed downy mildew symptoms were washed in 250 μL of distilled water and the resulting spore suspension was counted using a hemocytometer. The values for spore counts were divided by plant leaf area. Several doses (30.8, 34.8 and 61.7 kJ m⁻²) reduced spore count per leaf area (mm²) compared to control, as seen in Table 16.

TABLE 16
The Mean Number of Bremia Spores
per mm² of Lettuce Cultivar

| | | Mean | |
|---|---|---|---|
| dose | | Spores/ | Standard |
| (kJ/m²) | prime | mm² | Error |
| 0 | Primed | 672.4186 | 303.3356 |
| 15.9 | Primed | 1853.455 | 755.8139 |
| 30.8 | Primed | 312.6199 | 90.41087 |
| 34.7 | Primed | 618.1387 | #N/A |
| 34.8 | Primed | 854.5224 | 346.0345 |
| 44.8 | Primed | 1189.364 | 475.6395 |
| 61.7 | Primed | 295.1873 | #N/A |
| 79.3 | Primed | 711.0528 | 175.9982 |
| 0 | Unprimed | 3317.605 | #N/A |
| 34.7 | Unprimed | 1324.479 | 563.9168 |
| 44.8 | Unprimed | 126.7491 | #N/A |

This example shows that various doses of UV-B radiation administered to seeds protects lettuce seedlings against disease.

### Example 5

### Disease Protection Against Bremia lactucae in Lettuce Seedlings

This example assessed the ability of another range of doses of UV-B radiation administered to seeds to protect lettuce seedlings against disease.

Methods

Circles of capillary matting were placed in 20 60 mm diameter petri dishes. 15 dishes were saturated with approximately 20 mL of PEG solution and 5 petri dishes remained dry. 50 mg of lettuce seeds were placed on filter paper in the petri dishes and the weight of the petri dishes, PEG solution, filter paper, matting and seeds was recorded.

1 wet dish and one dry dish was placed in each treatment area, while the remaining dishes were treated in the control area. The treatment areas contained an irradiance of 2.6 kJ m⁻² h⁻¹ (Area 1), 3.6 kJ m⁻² h¹(Area 2), 4.1 kJ m⁻² h¹(Area 3), 4.8 kJ m⁻² (Area 4), 10.0 kJ m⁻² (Ultra high), or 0 kJ m⁻² (control). At 3 hours post treatment, a wet dish was moved from the control area to each of Areas 1-4 and treatment was resumed. At 6 hours after treatment initiation, treatment was paused and distilled water was added so that all dishes reached their original weight. A wet dish was removed from the control area to each of areas 1-5 and treatment is resumed. At 23 hours post treatment, treatment was paused and distilled water was added to each dish until it reached its original weight. Treatment was resumed until 27 hours post treatment initiation time. After treatment, dry seeds were placed in a refrigerator and wet seeds were placed in a humidity chamber at 24° C., 50% relative humidity for 24 hours to dry. Once dried, seeds were stored in a refrigerator.

Results

Results of Trial 1

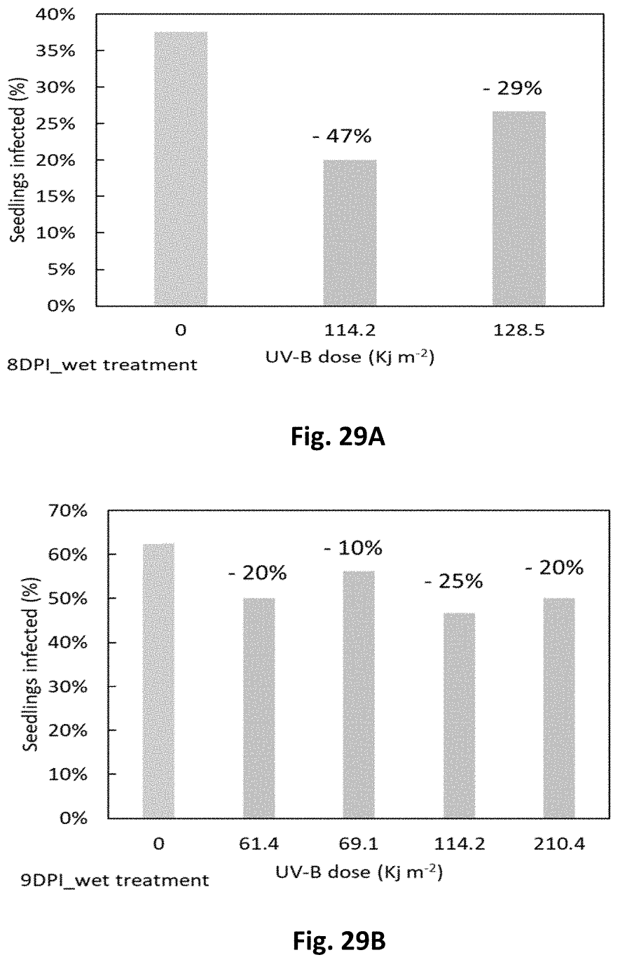

UV-B doses of 114.2 and 128.5 kJ m⁻² reduced disease incidence at 8 DPI as seen in FIG. 29A and Table 17. Likewise, multiple osmoprimed treatments resulted in lower disease incidence than control at 9 DPI, as seen in FIG. 29B and Table 17.

TABLE 17
Disease Incidence at 7 to 9 DPI

| | Dose | Osmoprime | % of plants |
|---|---|---|---|
| DPI | (kJ m⁻²) | status | infected |
| 7 | 0 | Primed | 6% |
| 7 | 53.7 | Primed | 50% |
| 7 | 61.4 | Primed | 31% |
| 7 | 69.1 | Primed | 25% |
| 7 | 85.4 | Primed | 31% |
| 7 | 98.5 | Primed | 67% |
| 7 | 109.9 | Primed | 31% |
| 7 | 114.2 | Primed | 13% |
| 7 | 128.5 | Primed | 20% |
| 7 | 210.4 | Primed | 44% |
| 7 | 270.5 | Primed | 44% |
| 7 | 0 | Unprimed | 13% |
| 7 | 69.1 | Unprimed | 13% |
| 7 | 98.5 | Unprimed | 81% |
| 7 | 109.9 | Unprimed | 19% |
| 7 | 128.5 | Unprimed | 79% |
| 8 | 0 | Primed | 38% |
| 8 | 53.7 | Primed | 56% |
| 8 | 61.4 | Primed | 38% |
| 8 | 69.1 | Primed | 56% |
| 8 | 85.4 | Primed | 69% |
| 8 | 98.5 | Primed | 67% |
| 8 | 109.9 | Primed | 50% |
| 8 | 114.2 | Primed | 20% |
| 8 | 128.5 | Primed | 27% |
| 8 | 210.4 | Primed | 56% |
| 8 | 270.5 | Primed | 69% |
| 8 | 0 | Unprimed | 44% |
| 8 | 69.1 | Unprimed | 25% |
| 8 | 98.5 | Unprimed | 81% |
| 8 | 109.9 | Unprimed | 31% |
| 8 | 128.5 | Unprimed | 79% |
| 9 | 0 | Primed | 63% |
| 9 | 53.7 | Primed | 81% |
| 9 | 61.4 | Primed | 50% |
| 9 | 69.1 | Primed | 56% |
| 9 | 85.4 | Primed | 75% |
| 9 | 98.5 | Primed | 67% |
| 9 | 109.9 | Primed | 63% |
| 9 | 114.2 | Primed | 47% |
| 9 | 128.5 | Primed | 67% |
| 9 | 210.4 | Primed | 50% |
| 9 | 270.5 | Primed | 81% |
| 9 | 0 | Unprimed | 50% |
| 9 | 69.1 | Unprimed | 31% |
| 9 | 98.5 | Unprimed | 88% |
| 9 | 109.9 | Unprimed | 69% |
| 9 | 128.5 | Unprimed | 93% |

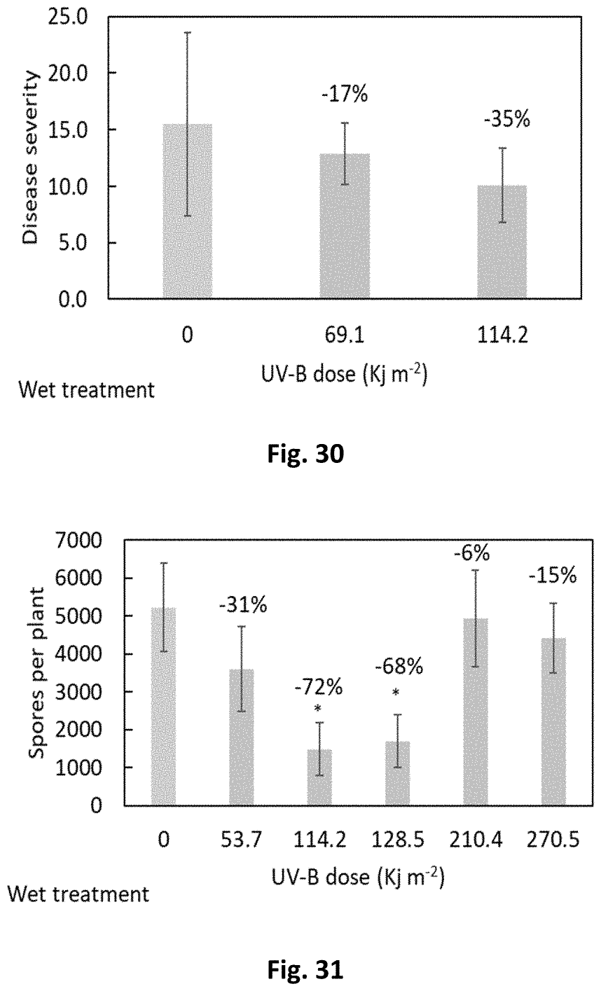

A disease progression curve was created to measure disease severity using similar methods as described in previous examples. UV-B doses 69.1 kJ m⁻² and 114.2 kJ m⁻² decreased overall disease severity as seen in FIG. 30 and Table 18.

TABLE 18
Disease Severity in Great Lakes Lettuce Seedlings

| Dose | Osmoprime | mean | Standard |
|---|---|---|---|
| (kJ m⁻²) | status | AUDPC | Error |
| 0 | Primed | 15.5 | 8.1 |
| 53.7 | Primed | 47.7 | 11.2 |
| 61.4 | Primed | 39.6 | 19.5 |
| 69.1 | Primed | 12.9 | 2.8 |
| 85.4 | Primed | 55.2 | 11.1 |
| 98.5 | Primed | 69.9 | 11.8 |
| 109.9 | Primed | 58.0 | 19.2 |
| 114.2 | Primed | 10.1 | 3.3 |
| 128.5 | Primed | 19.2 | 8.0 |
| 210.4 | Primed | 20.8 | 8.2 |
| 270.5 | Primed | 33.2 | 8.2 |
| 0 | Unprimed | 23.3 | 10.9 |
| 69.1 | Unprimed | 29.1 | 8.5 |
| 98.5 | Unprimed | 96.0 | 12.4 |
| 109.9 | Unprimed | 36.0 | 17.4 |
| 128.5 | Unprimed | 55.9 | 13.7 |

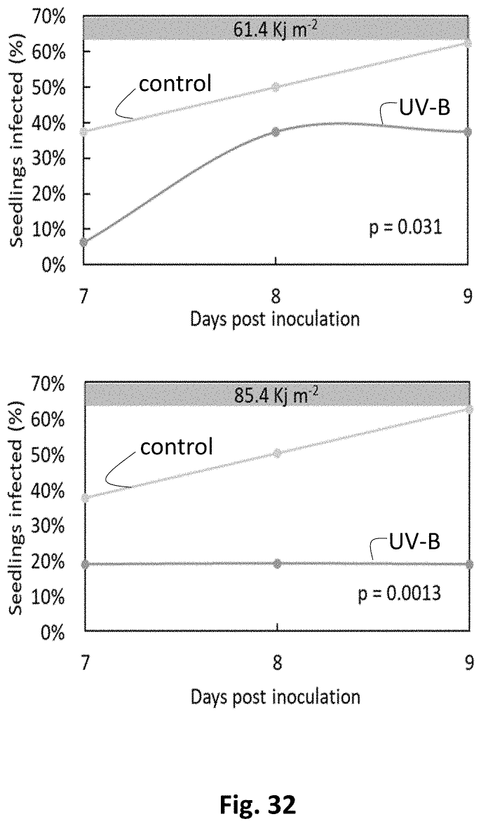

Infectibility was calculated as in previous examples. Infectability was heavily decreased by osmoprimed seed treatment with five UV-B doses as seen in FIG. 31 and Table 19. In FIG. 31, error bars indicate 1 standard error and asterisks indicate significant difference in spore count compared to control, where significance is determined by the student's T-test with a p-value of<0.05.

TABLE 19
Mean Number of Spores Per Plant

| Dose | Osmoprime | mean Spores | Standard |
|---|---|---|---|
| (kJ m⁻²) | status | seedling⁻¹ | Error |
| 0 | Primed | 5.2E+03 | 1.2E+03 |
| 53.7 | Primed | 3.6E+03 | 1.1E+03 |
| 61.4 | Primed | 1.1E+04 | 3.4E+03 |
| 69.1 | Primed | 6.3E+03 | 1.4E+03 |
| 85.4 | Primed | 9.8E+03 | 2.6E+03 |
| 98.5 | Primed | 8.7E+03 | 2.6E+03 |
| 109.9 | Primed | 8.5E+03 | 2.7E+03 |
| 114.2 | Primed | 1.5E+03 | 7.0E+02 |
| 128.5 | Primed | 1.7E+03 | 6.9E+02 |
| 210.4 | Primed | 4.9E+03 | 1.3E+03 |
| 270.5 | Primed | 4.4E+03 | 9.2E+02 |
| 0 | Unprimed | 5.8E+03 | 2.8E+03 |
| 69.1 | Unprimed | 5.2E+03 | 2.5E+03 |
| 98.5 | Unprimed | 1.2E+04 | 3.9E+03 |
| 109.9 | Unprimed | 7.9E+03 | 4.5E+03 |
| 128.5 | Unprimed | 1.3E+04 | 6.8E+03 |

Results of Trial 2

Disease incidence is the percentage of plants displaying downy mildew disease symptoms. Osmoprimed seed treatments with a UV-B dose of 61.4 0 kJ m⁻² significantly decreased the infection curve from 7-9 days post inoculation (DPI) compared to a dose of 0 kJ M⁻² as seen in FIG. 32 (top panel) and Table 20. Additionally, a UV-B dose of 85.4 kJ m⁻² significantly decreased the infection curve from 7-9 DPI compared to a dose of 0 kJ m⁻² as seen in FIG. 32 (bottom panel).

TABLE 20
Percent of Plants Infected with Bremia

| | Dose | Osmoprime | % of plants |
|---|---|---|---|
| DPI | (kJ m⁻²) | status | infected |
| 7 | 0 | Primed | 38% |
| 7 | 53.7 | Primed | 31% |
| 7 | 61.4 | Primed | 6% |
| 7 | 69.1 | Primed | 50% |
| 7 | 76.6 | Primed | 56% |
| 7 | 85.4 | Primed | 19% |
| 7 | 87.6 | Primed | 19% |
| 7 | 97.7 | Primed | 63% |
| 7 | 98.5 | Primed | 19% |
| 7 | 99.9 | Primed | 19% |
| 7 | 109.9 | Primed | 63% |
| 7 | 114.2 | Primed | 56% |
| 7 | 128.5 | Primed | 53% |
| 7 | 210.4 | Primed | 69% |
| 7 | 270.5 | Primed | 50% |
| 7 | 0 | Unprimed | 50% |
| 7 | 69.1 | Unprimed | 56% |
| 7 | 98.5 | Unprimed | 63% |
| 7 | 109.9 | Unprimed | 38% |
| 7 | 128.5 | Unprimed | 38% |
| 8 | 0 | Primed | 50% |
| 8 | 53.7 | Primed | 44% |
| 8 | 61.4 | Primed | 38% |
| 8 | 69.1 | Primed | 69% |
| 8 | 76.6 | Primed | 56% |
| 8 | 85.4 | Primed | 19% |
| 8 | 87.6 | Primed | 31% |
| 8 | 97.7 | Primed | 63% |
| 8 | 98.5 | Primed | 44% |
| 8 | 99.9 | Primed | 25% |
| 8 | 109.9 | Primed | 81% |
| 8 | 114.2 | Primed | 75% |
| 8 | 128.5 | Primed | 53% |
| 8 | 210.4 | Primed | 81% |
| 8 | 270.5 | Primed | 69% |
| 8 | 0 | Unprimed | 69% |
| 8 | 69.1 | Unprimed | 69% |
| 8 | 98.5 | Unprimed | 81% |
| 8 | 109.9 | Unprimed | 75% |
| 8 | 128.5 | Unprimed | 56% |
| 9 | 0 | Primed | 63% |
| 9 | 53.7 | Primed | 56% |
| 9 | 61.4 | Primed | 38% |
| 9 | 69.1 | Primed | 100% |
| 9 | 76.6 | Primed | 63% |
| 9 | 85.4 | Primed | 19% |
| 9 | 87.6 | Primed | 63% |
| 9 | 97.7 | Primed | 81% |
| 9 | 98.5 | Primed | 50% |
| 9 | 99.9 | Primed | 44% |
| 9 | 109.9 | Primed | 88% |
| 9 | 114.2 | Primed | 88% |
| 9 | 128.5 | Primed | 87% |
| 9 | 210.4 | Primed | 100% |
| 9 | 270.5 | Primed | 88% |
| 9 | 0 | Unprimed | 69% |
| 9 | 69.1 | Unprimed | 81% |
| 9 | 98.5 | Unprimed | 94% |
| 9 | 109.9 | Unprimed | 94% |
| 9 | 128.5 | Unprimed | 56% |

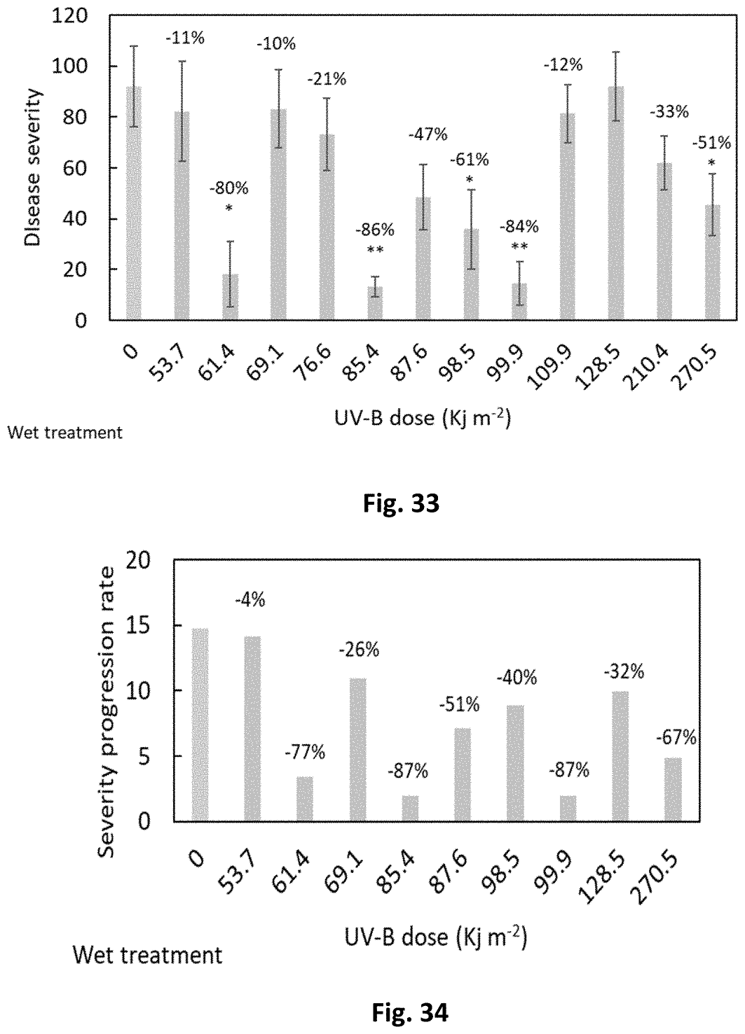

Disease severity was measured as in previous examples. Most doses of UV-B radiation reduced disease severity as seen in FIG. 33 and Table 21. Several UV-B seed treatments heavily reduced the disease progression rate compared to control as depicted in FIG. 34.

TABLE 21
Disease Severity of UV-B Treated Plants

| Dose | Osmoprime | mean | Standard |
|---|---|---|---|
| (kJ m⁻²) | status | AUDPC | Error |
| 0 | Primed | 92.03125 | 15.80952 |
| 53.7 | Primed | 82.14285 | 19.57123 |
| 61.4 | Primed | 18.125 | 12.88875 |
| 69.1 | Primed | 83.18182 | 15.33283 |
| 76.6 | Primed | 73.15972 | 14.13143 |
| 85.4 | Primed | 13.125 | 4.0625 |
| 87.6 | Primed | 48.4375 | 12.99113 |
| 97.7 | Primed | 96.5625 | 13.14788 |
| 98.5 | Primed | 35.75893 | 15.58176 |
| 99.9 | Primed | 14.53125 | 8.489903 |
| 109.9 | Primed | 81.25 | 11.50791 |
| 114.2 | Primed | 108.3854 | 13.59883 |
| 128.5 | Primed | 91.875 | 13.56614 |
| 210.4 | Primed | 61.875 | 10.55501 |
| 270.5 | Primed | 45.34091 | 12.16172 |
| 0 | Unprimed | 80.22728 | 20.12224 |
| 69.1 | Unprimed | 46.96023 | 13.40437 |
| 98.5 | Unprimed | 63.67789 | 13.50304 |
| 109.9 | Unprimed | 77.8125 | 12.12884 |
| 128.5 | Unprimed | 52.04861 | 16.1202 |

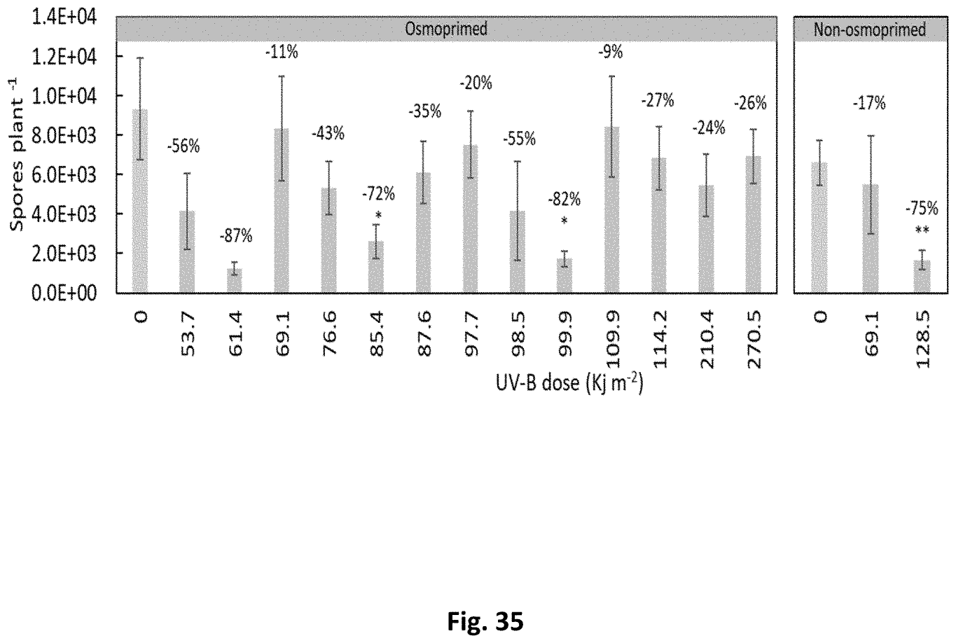

Infectibility was calculated by spore count as in previous examples. Many osmoprimed seed treatments reduced infectibility as seen in FIG. 35 and Table 22. Several of the reductions in infectibility were significant (indicated with asterisk). Two non-osmoprimed treatments also decreased infectability.

TABLE 22
Spore Counts in UV Treated and Untreated Seedlings

| | | Mean | |
|---|---|---|---|
| Dose | Osmoprime | Spores | Standard |
| (kJ m⁻²) | status | plant⁻¹ | Error |
| 0 | Primed | 9.3E+03 | 2.E+03 |
| 53.7 | Primed | 4.1E+03 | 1.9E+03 |
| 61.4 | Primed | 1.3E+03 | 3.2E+02 |
| 69.1 | Primed | 8.3E+03 | 2.7E+03 |
| 76.6 | Primed | 5.3E+03 | 1.3E+03 |
| 85.4 | Primed | 2.6E+03 | 8.4E+02 |
| 87.6 | Primed | 6.1E+03 | 1.6E+03 |
| 97.7 | Primed | 7.5E+03 | 1.7E+03 |
| 98.5 | Primed | 4.2E+03 | 2.5E+03 |
| 99.9 | Primed | 1.7E+03 | 3.9E+02 |
| 109.9 | Primed | 8.4E+03 | 2.6E+03 |
| 114.2 | Primed | 6.8E+03 | 1.6E+03 |
| 128.5 | Primed | 1.1E+04 | 1.5E+03 |
| 210.4 | Primed | 5.5E+03 | 1.6E+03 |
| 270.5 | Primed | 6.9E+03 | 1.4E+03 |
| 0 | Unprimed | 6.6E+03 | 1.1E+03 |
| 69.1 | Unprimed | 5.5E+03 | 2.5E+03 |
| 98.5 | Unprimed | 6.9E+03 | 1.6E+03 |
| 109.9 | Unprimed | 9.9E+03 | 3511.888 |
| 128.5 | Unprimed | 1.7E+03 | 475.0731 |

Results of Trial 3

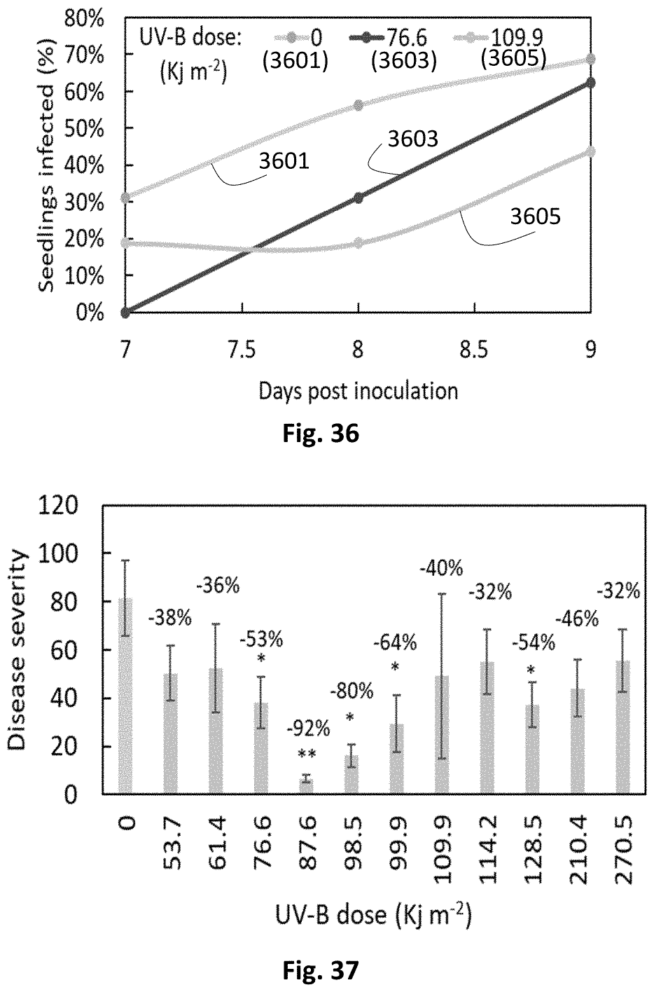

At 7 days post inoculation (DPI) (first signs of symptoms) most treatments resulted in reduced incidence. As depicted in FIG. 36 and Table 23, both the treatments with a dose of 76.7 kJ m⁻² and a dose of 109.9 kJ m⁻² significantly reduced probability of infection of the entire disease period.

TABLE 23
Disease Incidence at 7, 8 and 9 DPI

| | | | % of |
|---|---|---|---|
| | Dose | Osmoprime | plants |
| DPI | (kJ m⁻²) | status | infected |
| 7 | 0 | Primed | 31% |
| 7 | 53.7 | Primed | 13% |
| 7 | 61.4 | Primed | 19% |
| 7 | 69.1 | Primed | 25% |
| 7 | 76.6 | Primed | 0% |
| 7 | 85.4 | Primed | 94% |
| 7 | 87.6 | Primed | 6% |
| 7 | 97.7 | Primed | 56% |
| 7 | 98.5 | Primed | 13% |
| 7 | 99.9 | Primed | 6% |
| 7 | 109.9 | Primed | 19% |
| 7 | 114.2 | Primed | 31% |
| 7 | 128.5 | Primed | 19% |
| 7 | 210.4 | Primed | 13% |
| 7 | 270.5 | Primed | 40% |
| 7 | 0 | Unprimed | 75% |
| 7 | 69.1 | Unprimed | 47% |
| 7 | 98.5 | Unprimed | 25% |
| 7 | 109.9 | Unprimed | 31% |
| 7 | 128.5 | Unprimed | 56% |
| 8 | 0 | Primed | 56% |
| 8 | 53.7 | Primed | 63% |
| 8 | 61.4 | Primed | 50% |
| 8 | 69.1 | Primed | 44% |
| 8 | 76.6 | Primed | 31% |
| 8 | 85.4 | Primed | 100% |
| 8 | 87.6 | Primed | 19% |
| 8 | 97.7 | Primed | 100% |
| 8 | 98.5 | Primed | 38% |
| 8 | 99.9 | Primed | 50% |
| 8 | 109.9 | Primed | 19% |
| 8 | 114.2 | Primed | 63% |
| 8 | 128.5 | Primed | 75% |
| 8 | 210.4 | Primed | 69% |
| 8 | 270.5 | Primed | 60% |
| 8 | 0 | Unprimed | 88% |
| 8 | 69.1 | Unprimed | 80% |
| 8 | 98.5 | Unprimed | 50% |
| 8 | 109.9 | Unprimed | 69% |
| 8 | 128.5 | Unprimed | 69% |
| 9 | 0 | Primed | 69% |
| 9 | 53.7 | Primed | 63% |
| 9 | 61.4 | Primed | 63% |
| 9 | 69.1 | Primed | 75% |
| 9 | 76.6 | Primed | 63% |
| 9 | 85.4 | Primed | 100% |
| 9 | 87.6 | Primed | 38% |
| 9 | 97.7 | Primed | 100% |
| 9 | 98.5 | Primed | 63% |
| 9 | 99.9 | Primed | 69% |
| 9 | 109.9 | Primed | 44% |
| 9 | 114.2 | Primed | 81% |
| 9 | 128.5 | Primed | 81% |
| 9 | 210.4 | Primed | 75% |
| 9 | 270.5 | Primed | 80% |
| 9 | 0 | Unprimed | 88% |
| 9 | 69.1 | Unprimed | 93% |
| 9 | 98.5 | Unprimed | 63% |
| 9 | 109.9 | Unprimed | 81% |
| 9 | 128.5 | Unprimed | 88% |

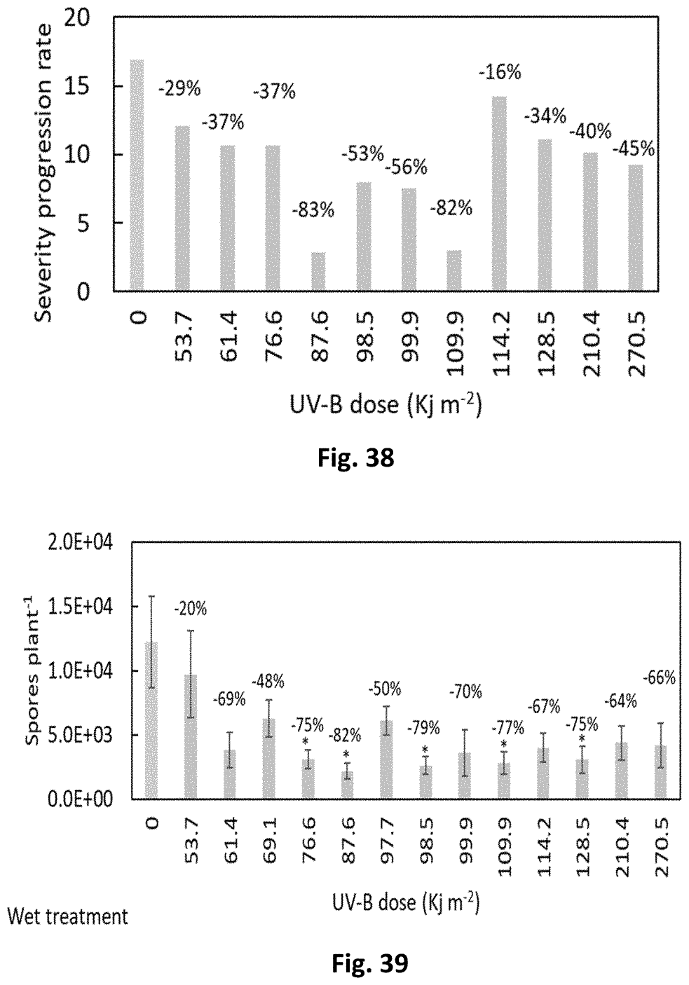

Disease severity was measured as previously described. All osmoprimed UV-B seed treatments showed a reduction in overall disease severity as seen in FIG. 37 and Table 24. Osmoprimed UV-B seed treatments with a dose of 76.6, 87.6, 98.5, 99.9 and 128.5 kJ m⁻² showed significantly reduced overall disease severity compared to control (0 kJ m⁻²), as indicated with an asterisk. Furthermore, as seen in FIG. 38, many treatments reduced disease progression.

TABLE 24
Disease Severity in
Treated and Untreated Lettuce

| Dose | Osmoprime | mean | Standard |
|---|---|---|---|
| (kJ m⁻²) | status | AUDPC | Error |
| 0 | Primed | 81.3 | 15.7 |
| 53.7 | Primed | 50.3 | 11.4 |
| 61.4 | Primed | 52.3 | 18.3 |
| 69.1 | Primed | 108.4 | 17.1 |
| 76.6 | Primed | 38.0 | 10.7 |
| 85.4 | Primed | 124.3 | 13.8 |
| 87.6 | Primed | 6.7 | 1.7 |
| 97.7 | Primed | 85.9 | 12.8 |
| 98.5 | Primed | 16.0 | 4.9 |
| 99.9 | Primed | 29.4 | 11.8 |
| 109.9 | Primed | 49.2 | 34.2 |
| 114.2 | Primed | 55.0 | 13.5 |
| 128.5 | Primed | 37.3 | 9.5 |
| 210.4 | Primed | 44.1 | 12.0 |
| 270.5 | Primed | 55.4 | 12.9 |
| 0 | Unprimed | 29.9 | 5.6 |
| 69.1 | Unprimed | 91.9 | 15.1 |
| 98.5 | Unprimed | 51.0 | 18.3 |
| 109.9 | Unprimed | 26.6 | 6.9 |
| 128.5 | Unprimed | 84.9 | 13.0 |

Spore counts were calculated as in previous examples. Several osmoprimed seed treatments reduced infectability as seen in FIG. 39 and Table 25. Doses of 76.7,87.6, 98.5 109.9 and 128.5 kJ m⁻² significantly reduced infectibility, indicated with an asterisk. Furthermore, two non-osmoprimed treatments also decreased infectability.

TABLE 25
Spores per Plant

| | | Mean | |
|---|---|---|---|
| Dose | Osmoprime | Spores | Standard |
| (kJ m⁻²) | status | plant⁻¹ | Error |
| 0 | Primed | 1E+04 | 4E+03 |
| 53.7 | Primed | 1E+04 | 3E+03 |
| 61.4 | Primed | 4E+03 | 1E+03 |
| 69.1 | Primed | 6E+03 | 1E+03 |
| 76.6 | Primed | 3E+03 | 7E+02 |
| 85.4 | Primed | 2E+04 | 7E+03 |
| 87.6 | Primed | 2E+03 | 6E+02 |
| 97.7 | Primed | 6E+03 | 1E+03 |
| 98.5 | Primed | 3E+03 | 7E+02 |
| 99.9 | Primed | 4E+03 | 2E+03 |
| 109.9 | Primed | 3E+03 | 9E+02 |
| 114.2 | Primed | 4E+03 | 1E+03 |
| 128.5 | Primed | 3E+03 | 1E+03 |
| 210.4 | Primed | 4E+03 | 1E+03 |
| 270.5 | Primed | 4E+03 | 2E+03 |
| 0 | Unprimed | 5E+03 | 1E+03 |
| 69.1 | Unprimed | 8E+03 | 2E+03 |
| 98.5 | Unprimed | 4E+03 | 2E+03 |
| 109.9 | Unprimed | 3E+03 | 7E+02 |
| 128.5 | Unprimed | 1E+04 | 2E+03 |

As seen in this example, UV-B treatment of lettuce seeds resulted in disease resistance in lettuce seedlings derived from UV-B treated seeds when compared to seedlings derived from untreated seeds. Various doses of UV-B radiation were used in this experiment, and various doses were found to improve disease resistance in treated plants when compared to untreated plants.

### Example 6

### Treating Seedlings with UV-B Light to Improve Disease Resistance

This example assessed the effect of UV-B treatment of seedlings on disease resistance.

Methods

Experimental Treatments

Lettuce (Lactuca sativa) seeds were sown 0.5 cm deep into black plastic trays, with a cell size of 3 cm⁻², containing ‘Daltons Seedling Raising Mix’. The tray was spread with a single layer of grade 3 medium vermiculite (Auspari pty LTD, NSW). Sown trays were misted with water then placed in darkness at 14° C. for 48 hours for vernalization. Following vernalization, plants were grown for 14 days in a controlled temperature room (CTR). The CTR had growth conditions of 17° C., 215 μmol m⁻² s_{—1} with a photo-period of 10 hours supplied by FL58W/965 super daylight deluxe fluorescent tubes (Slyvania Premium Extra, China). Capillary matting beneath the trays was watered daily. In majority of experiments, cultivar Casino (Terranova Seed, NZ) was used. Treatments were either control (PAR only) or UV-B (PAR +300 nm UV-B). PAR light consisted of red and blue LEDs. UV-B doses for the dose response experiment are found in Table 26. Light quality and quantity were confirmed with a radiometer (Optronic Laboratories OL756) or spectroradiometer (Spectrilight ILT950) prior to each treatment.

Commercial Treatments

Lettuce (Lactuca sativa) were sown as for experimental treatments. Growth chamber experiments (semi-commercial) used cultivars; El Dorado, Iceberg and Salinas, and were raised as for experimental treatments. Glass-house (commercial) lettuce plants (cultivar Casino) were grown on a flood and drain table for five days then moved to matting with drip irrigation under standard glasshouse conditions in Palmerston North, New Zealand. A cooling fan maintained temperature under 20° C.

Two-week-old plants were treated with a moving LED array (52.8 mm/s). Semi Commercial (SC) plants were treated with UV-B for three days with a 10 hour photo period in a growth chamber with a temperature of 17° C. Background lighting (PAR) was supplied by overhead stationary red and blue LEDs (100 μmol m⁻² s⁻¹). SC control plants received PAR from overhead stationary red and blue LEDs (100 μmol m⁻² s⁻¹) only. Light quality and quantity was confirmed to meet the specifications of each recipe using a radiometer (Optronic Laboratories OL756) or spectroradiometer (Spectrilight ILT950) prior to each treatment.

Plants were misted with 100,000 spores mL⁻¹ of B. lactucae (sextext code IBEB-C 36-01-00 or EU-B 16-63-40-00) using a pressure sprayer until plants were saturated. Inoculated plants were kept in a misting tent at a temperature of 17° C. and misted twice daily with water to encourage a high humidity. Disease was visually assessed using the disease scale found in Table 27 or a sporulation scale found in Table 28 daily from 6 days post inoculation (DPI) till 12 DPI. Rating scales were created based on observations of growth patterns of B. lactucae on lettuce cultivar Casino seedlings (2-4 weeks old) between 6 and 12 DPI. Spore counts were taken at 12 DPI using methods similar to those of previous examples.

TABLE 26
UV-B Treatments Used in Dose Screening

| Experiment | UV-B | PAR | Length | |
|---|---|---|---|---|
| set | (μmol m⁻² s⁻¹) | (μmol m⁻² s⁻¹) | (hours) | Reps |
| A | 0.1 | 90 | 72 | 4 |
| B | 0.3 | 215 | 72 | 4 |
| C | 0.1 | 215 | 72 | 4 |
| D | 0.5 | 215 | 72 | 3 |

TABLE 27
Disease Rating Scale

| Rating | Description |
|---|---|
| 0 | No visible disease |
| 1 | Cotyledons infected: yellowing or sporangia |
| 1 | Sporangia on a singular leaf |
| 3 | Sporangia on multiple leaves |
| 4 | Heavy infection of sporangia on more than one leaf Yellowing. |
| 5 | Majority of plant covered, brown lesions and |
| | yellowing evident, very severe infection/dead. |

TABLE 28
Sporulation Table

| Rating | Description |
|---|---|
| 0 | No signs of spores |
| 1 | Cotyledon infected |
| 2 | Singular patch of spores 1-10% covered on 1 leaf only |
| 3 | Spores 10-25% covered on 1 leaf only |
| 4 | Spores 25-75% covered on 1 leaf only |
| 5 | Spores on multiple leaves <25% covered |
| 6 | Spores on multiple leaves and 25-75% covered on 1 leaf |
| 7 | Spores on multiple leaves and 50-75% covered on 2 leaf |
| 8 | Spores on multiple leaves and 50-75% covered on 3 leaf |
| 9 | Spores on multiple leaves and 75-100% covered on >3 leaf |

Results

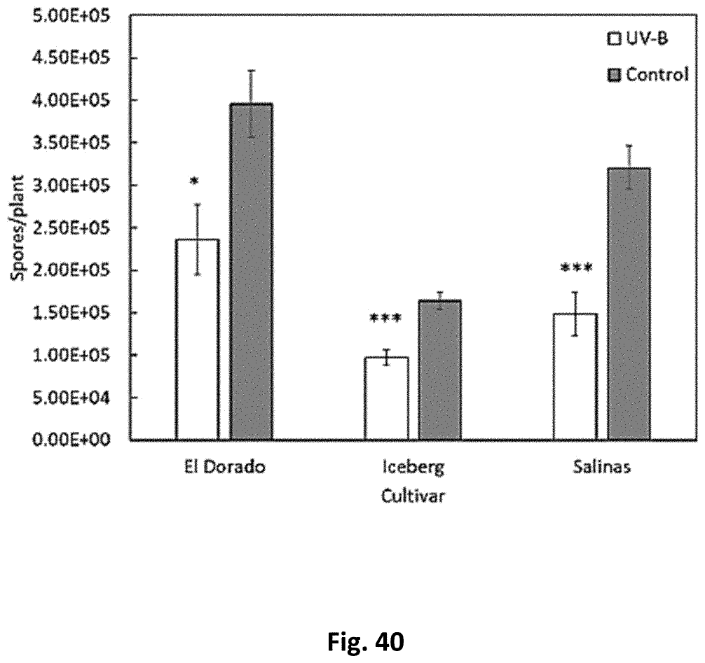

Spore count was significantly reduced in UV-B pretreated plants of all cultivars as seen in FIG. 40. Salinas had the largest decrease in spore count (54%) followed by Iceberg (41%) and El Dorado (40%). This showed that commercial UV-B pretreatment can reduce disease susceptibility as sporulation severity and spore count. As the main goal of a commercial treatment is increased yield and uniformity, this experiment showed that the commercial UV-B treatment can also decrease disease susceptibility increasing the value of the treatment.

Secondary Downy Mildew Infections have Reduced Severity when Spread Between UV-B Pretreated Plants

To determine whether UV-B pre-treatment reduces secondary infection, UV-B pretreated, or control plants were used as a source of inoculum (A) to infect a new set of UV-B pretreated or control plants (B). Treatments are described in the format of A-B. For example, C-UV indicates the inoculum came from UV-B pretreated plants (A), and infected control (C) plants (B). The disease symptoms of the secondary plant (B) were assessed.

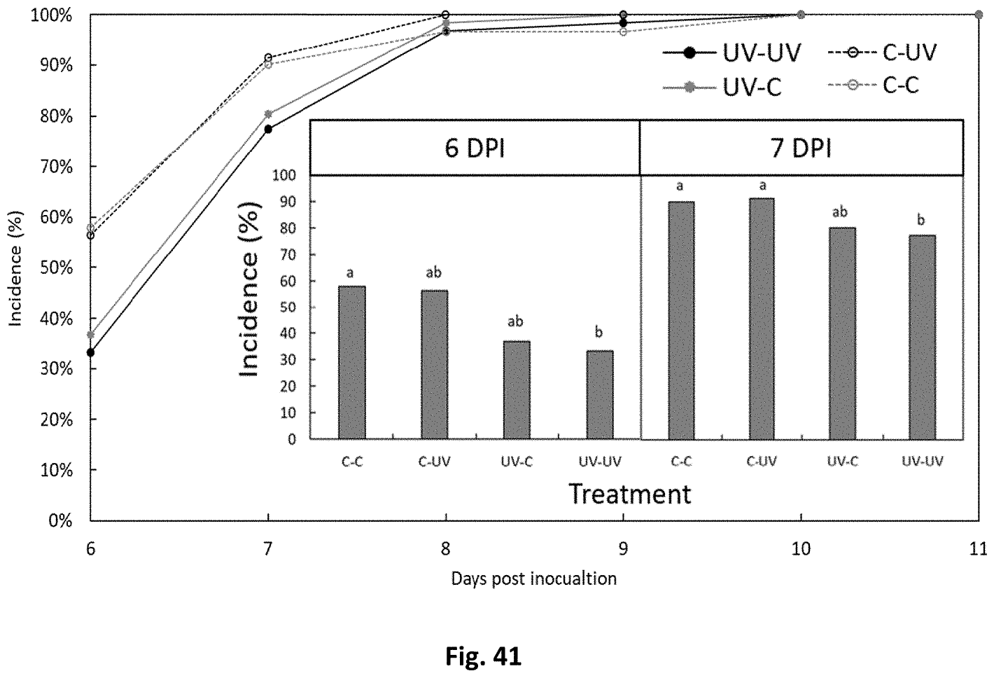

Disease incidence rate was rapid in this experimental set, displayed in FIG. 41. In brief, these data demonstrate that when UV treated plants were inoculated with disease, and then those plants were used to attempt to cross-infect a new set of UV treated plants, the disease rate significantly dropped. As all treatments were almost saturated with disease incidence by 8 DPI, from this time point onwards there were no differences in incidence. The most effective treatment combination UV-UV resulted in plants with a significantly lower incidence than C-C at both 6 and 7 DPI (Fisher's Exact test, two-tailed, p=0.04, 0.046 respectively). At 7 DPI, UV-UV plants had a significantly lower disease incidence than C-UV plants also (Fisher's Exact test, two-tailed, p=0.031). Downy mildew disease incidence was delayed in UV-UV lettuce plants.

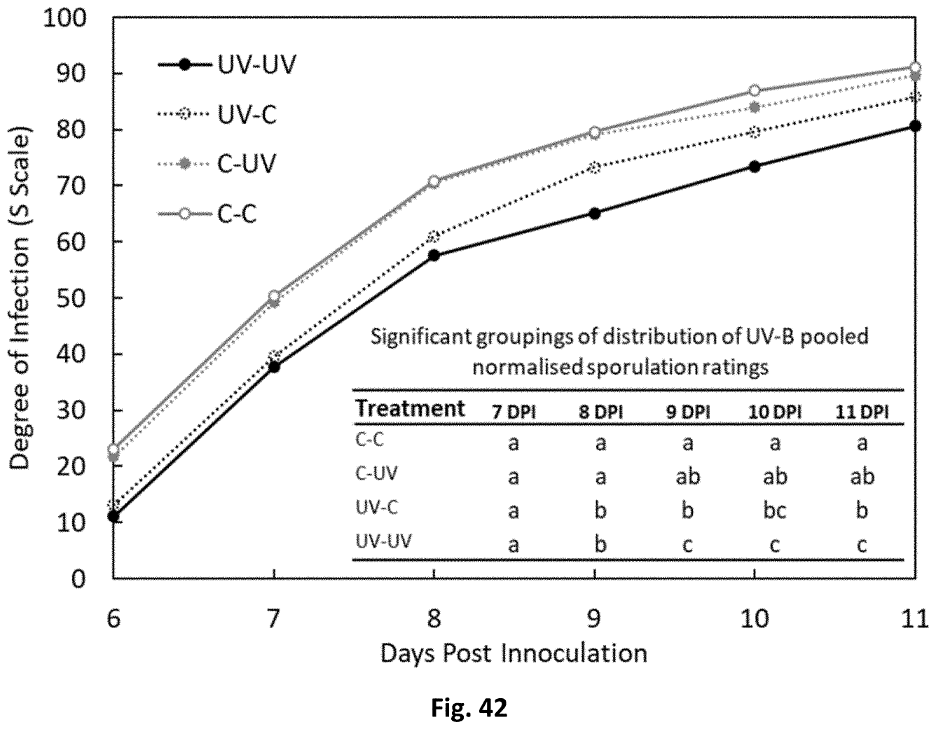

The degree of infection (DoI) (based on sporulation scale) of UV-UV plants was lower than C-C plants throughout the disease period as seen in FIG. 42. A Kruskall Wallis test with Bonferroni correction showed the distribution of normalized ratings were significantly lower in UV-UV and UV-C plants than C-C plants from 8 DPI onwards. At two time points (9 and 11 DPI), UV-UV plants had a significantly lower sporulation rating distribution than UV-C plants. Both UV-UV and UV-C received inoculum from a UV-B pretreated plant. Therefore, the level of inoculum produced by an infected UV-B pretreated plant was sufficiently reduced for a resulting secondary infection to have reduced sporulation severity as well. The disease reduction effect was enhanced when the secondary plant is also UV-B pretreated. Overall, plants infected with inoculum from a UV-B pretreated plant had reduced sporulation severity

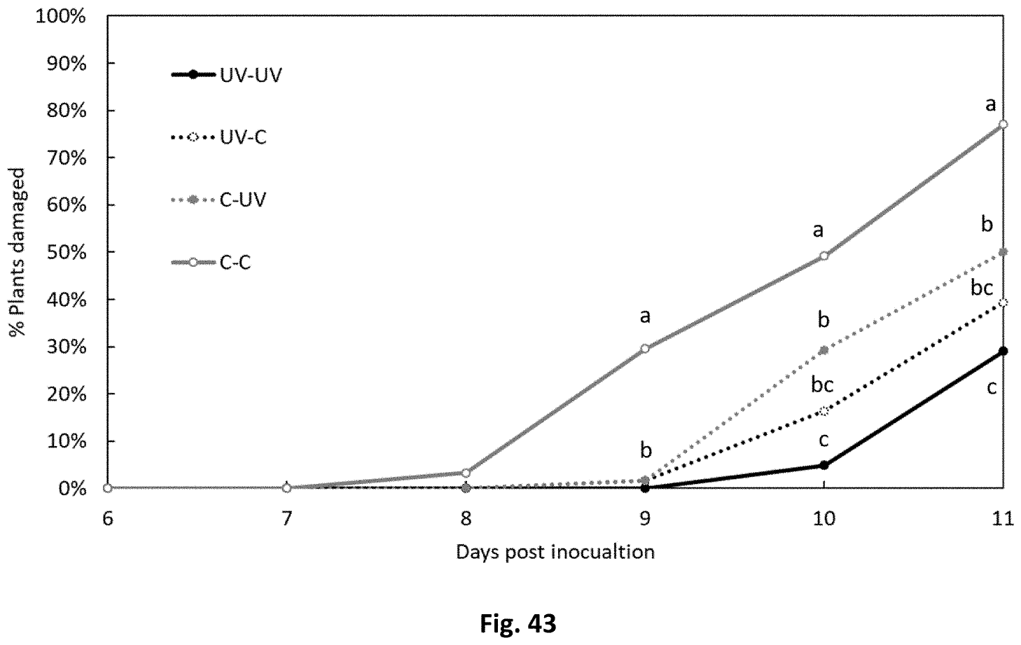

Downy mildew disease damage was reduced in lettuce plants in which either the primary or secondary plant was UV-B pretreated. Pooled counts of lettuce displaying disease damage over the treatment time are displayed in FIG. 43. Ratings of 4 or 5 on the disease scale indicated a plant displayed damage symptomatic of downy mildew disease. All treatments containing at least one set of UV-B treated plants (C-UV, UV-C, and UV-UV) had significantly fewer disease damaged plants than C-C on 9, 10 and 11 DPI. UV-UV treatment had significantly fewer damaged plants than C-UV at 10 and 11 DPI also. UV-B pretreatment of either the secondary or primary plant alone was enough to reduce the number of plants displaying disease damage. When both sets of plants were treated, the effect was amplified, with an even greater reduction in damaged plants.

Control plants which received inoculum from a UV-B pretreated source (UV-C) had a greater tolerance than C-C plants. Results indicated that receiving a reduced inoculum alone (UV-C) results in increased tolerance.

Treatments with at Least One Phase of UV-B Had a Reduced Spore Count

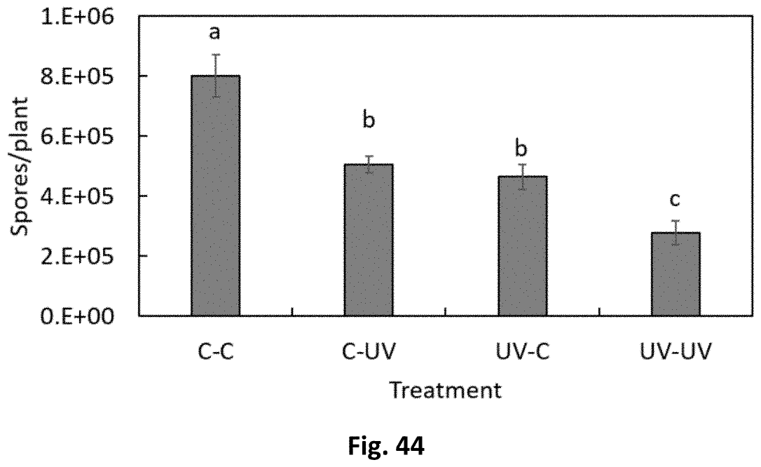

The spore count of disease reproductivity was plotted in FIG. 44. All treatments where the primary, secondary or both plants received a UV-B pretreatment had a significantly lower spore count than control plants (C-C). Intermediate treatments reduced spore count by 35% (C-UV, ANOVA LSD; p<0.0005) and 42% (UV-C, ANOVA LSD; p<0.0005). When both primary and secondary plants received a UV-B pretreatment (UV-UV), disease was further reduced (67%, ANOVA LSD; p<0.0005).

Significantly fewer spores were harvested from UV-UV plants than any other treatment. Plants of the intermediate treatments (C-UV and UV-C) had a significantly higher spore count than plants of the UV-UV treatment but significantly lower spore count than plants of the C-C treatment. Spore count data clearly showed a progressive effect, where one set of UV-B plants (primary or secondary) caused an intermediate decrease; however, when both sets of plants were UV treated (UV-UV) an amplified decrease occurred. The amplified effect was caused by the combination of a decreased inoculum from a UV-B pretreated plant source and the additional UV-B protective response in the secondary plant.

### Example 7

### UV-B Induced Increases to Lettuce Flavonoids Involved in the UV-B Induced Disease Defense

In this example, the correlation between the overall level of leaf-based flavonoids and the spore count in infected lettuce was calculated. Flavonoid level was measured using a portable sensor.

Methods

Lettuce plants were treated using similar methods described in Example 6. Lettuce plants were then treated with PAR+UV-B light (280 nm) or PAR only (control) for three days followed by inoculation of 100,000 spores/mL of B. lactucae. Plants were measured for flavonoid levels using a portable sensor (Dualex; Force A, Orsay; France at 0, 24, 48, 72 hours after treatment start and 1, 7, and 12 (360 hours) days post inoculation (DPI). Plants were then washed and the resulting spore suspension counted using a hemocytometer (BRAND® counting chamber BLAUBRAND® Neubauer improved, Sigma Aldrich).

Results

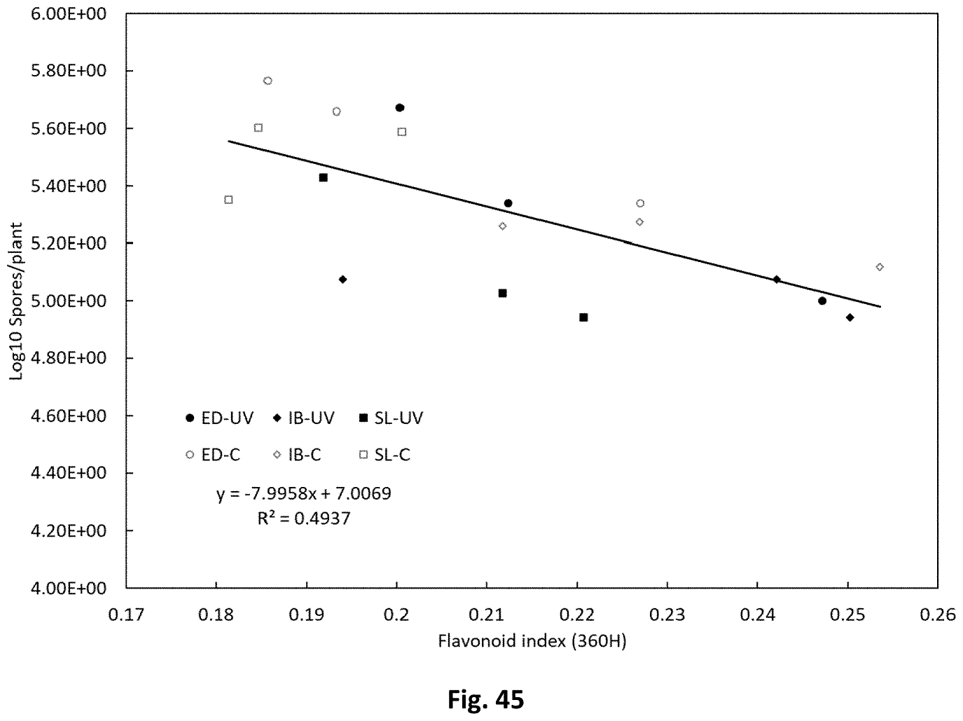

There was evidence of a correlation between leaf-based flavonoids and reduction in disease spore count following post-treatment Bremia inoculation as displayed in FIG. 45. Within the 280 nm semi-commercial experiment, flavonoid level at 360 hours (12 DPI) correlated negatively (r=−0.666, p=0.003) with spore count. Significant correlations between disease severity and flavonoid level were not present at any other time point. As 360 hours was the last recorded time point, high flavonoids at late stage disease influenced spore count following a 280 nm treatment. This flavonoid probe indicated that UV-B increased flavonoids and decreased disease, which at late stage disease forms a negative correlation.

As seen in this example, there was a correlation between the level of leaf-based flavonoids and a reduction in disease spore count.

### Example 8

### Role of Phenolics in the UV-B Induced Disease Defense

This example assessed the role of phenolic compounds in UV-B mediated disease resistance.

Methods

Lettuce (Lactuca sativa) plants were sown into black plastic trays with a cell size of 3 cm⁻² containing ‘Daltons Seedling Raising Mix’ in a randomized pattern. Two experiments with LC-MS analysis were run. The first set (LC-MS 1) used lettuce cultivars El Dorado, Iceberg, and Salinas. The second set (LC-MS 2) used cultivars La Brilliante, Emperor, Grand Rapids, Calicel, Greenway (Yates, NZ), Falcon, Pedrola (Terranova seeds, NZ), Desert Storm. These cultivars expressed a range of responsiveness to UV-B treatment as indicated by flavonoid level and susceptibility to downy mildew disease.

LC-MS-2 cultivars were chosen from a screen for disease susceptibility (as spore count) as well as UV-B induced flavonoid levels. Of these, four cultivars (Great Lakes, Glendana, Vegas, and Pedrola) were completely resistant to B. lactucae (sextext code IBEB-C 36-01-00 or EU-B 16-63-40-00). Pedrola was chosen to represent complete resistance to B. lactucae in the extended LC-MS 2 analysis. In the first LC-MS set (LC-MS1), cultivar Iceberg had low susceptibility, Salinas had moderate susceptibility, and El Dorado had high susceptibility. The disease screen included an even less susceptible (La Brilliante) and more susceptible (Emperor) cultivar than Iceberg and El Dorado, respectively. These cultivars were included as new extreme examples of high or low susceptibility in LC-MS2. The remaining cultivars had intermediate levels of disease susceptibility.

In terms of metabolites, flavonoid response to UV-B was used to indicate likely LC-MS metabolite UV-B response range. Most cultivars experienced a similar increase between 43% and 47% increase, with Falcon and Calicel experiencing lower increases (28% and 30% respectively). Emperor had the highest increase in flavonoids (50%). In order to achieve a range of both metabolite response to UV-B and disease susceptibility as well as ease of growth e.g. germination uniformity, Desert Storm, Falcon, Greenway, and Calicel were included in the cultivar set.

Following sowing, a single layer of grade 3 medium vermiculite (Auspari pty LTD, NSW) was spread over the tray. Sown trays were misted with water then placed in darkness at 14° C. for 48 hours for vernalization. Following vernalization, plants were moved to a controlled temperature room (CTR) and grown for 14 days. The CTR had a temperature of 17° C., and a 10 hour photoperiod supplied by 215 μmol in⁻² s⁻¹ white light from FL58W/965 super daylight deluxe fluorescent tubes (Slyvania Premium Extra, China). Water was applied daily to capillary matting underneath the trays. Separate plants were randomly designated for dualex measurements, LC-MS, and disease assessment.

Light treatments were applied through the use of a stationary LED array. Two-week-old CTR grown plants were treated with 215 μmol m⁻² s⁻¹ of PAR light through red and blue LEDs plus either 0.5 μmol m⁻² s⁻¹ UV-B light or no UV-B light (control) for a photoperiod of 10 hours for three days. Following light treatments, plants were allowed 14 hours recovery time in darkness prior to infection with disease. Treatments were conducted in a 17° C. CTR with the LED array acting as a sole light source. Three repeats were completed for LC-MS set 1, only one repeat, spread over two treatments, was completed for LC-MS 2.

A subset of plants from each cultivar from each treatment were designated for Dualex measures. Dualex measures were taken at 0 hours (just prior to treatment start), then every 24 hours until inoculation (0, 24, 48, 72 Hours). Following inoculation, dualex measurements were taken at 1, 7, and 12 days post inoculation (DPI). Dualex measurements were taken in LC-MS 1 experiments only (n=14-15 per treatment per cultivar).

At 72 hours, between treatment end and inoculation, sample plants were frozen in packets of three in liquid nitrogen and stored at −80° C. LC-MS 1 contained nine samples (three plants per sample) per cultivar per treatment. LC-MS 2 contained three samples (three plants per samples) per cultivar per treatment. A modified version of Wargent et al. (2015) was used to perform liquid chromatography-mass spectrometry (LC-MS). Foliar material was homogenized in liquid N2 and weighed to an equal mass of 150 mg for each sample. Each of the powdered leaf samples was extracted overnight at 1° C. with 1.5 mL of methanol/MQ/formic acid (80/20/1 v/v/v). Samples were diluted with methanol before analysis by LC-MS. LC-MS grade methanol was from Merek (Newmarket, Auckland, New Zealand). Ultrapure water was obtained from a Milli-Q Synthesis system (Millipore, Billerica, Mass., USA).

The LC-MS equipment used was the same system as Wargent et al. (2015). The LC-HRMS system was composed of a Dionex Ultimate® 3000 Rapid Separation LC and a micrOTOF QII mass spectrometer (Bruker Daltonics, Bremen, Germany) fitted with an electrospray ion source. The LC contained an SRD-3400 solvent rack/degasser, an HPR-3400RS binary pump, a WPS-3000RS thermostated autosampler and a TCC-3000RS thermostated column compartment. The column used was C68 (Luna Omega C18 100×2.1 mm id, 1.6 um; Agilent, Melbourne, Australia) and was maintained at 40° C. The flow rate was 0.400 mL min⁻¹. Solvents were A=0.2% formic acid and B=100% acetonitrile which set up a gradient over 20 minutes. The gradient was set up as 90% A, 10% B, 0-0.5 minutes; linear gradient to 60% A, 40% B, 0.5-9 minutes; linear gradient to 5% A, 95% B, 9-14 minutes; maintained at 5% A, 95% B. 14-18 minutes; linear gradient to 90% A, 10% B, 18-18.2 minutes; then returns to original conditions for next sample injection at 20 minutes. The injection volume was 1 mL. Mass spectrum (micrOTOF QII) parameters were as Wargent et al. (2015). Analysis of raw output was completed by XCMS online (Gowda et al., 2014) to determine molecular features labelled with accurate mass and retention time. XCMS also grouped features into peak groups which likely represent a singular metabolite.

Feature groups and representative mass was confirmed by spectral data using MZMINE (Pluskal et al., 2010). Intensities of feature within a peak group were summed to determined feature area intensity. Feature area intensity was submitted to statistical tests, such as PCAs, ANOVA and t-tests to determine differences between cultivars and treatments. Identification (formula and compound name) of features was determined using MSDIAL and MSFINDER(Lai et al., 2017; Tsugawa et al., 2016). Proposed identification by MSFINDER was given a score of confidence and confirmed by comparison of QC MS/MS spectral data (MZMINE) to published spectrum and published literature.

A subset of plants in LC-MS experiments (LC-MS1 n=20-24, LC-MS 2 n=9-15) assessed for downy mildew disease severity. Lettuce plants were misted with 100,000 spores mL⁻ of B. lactucae (sextext code IBEB-C 36-01-00 or EU-B 16-63-40-00) using a pressure sprayer until plants were saturated. Inoculated plants were kept in a misting tent at a temperature of 17° C. and misted twice daily with water to encourage a high humidity. Disease was visually assessed using a damage scale (Table 27) or a sporulation scale (Table 28) daily from six days post inoculation (DPI) until 12 DPI on the sets of plants designated for disease assessment for each cultivar and treatment. Rating scales were based on observed disease development of downy mildew disease using two to four-week-old lettuce Casino seedlings infected with B. lactucae (sextext code IBEB-C 36-01-00 or EU-B) between 6 to 12 DPI.

Spore counts were taken 12 DPI. Spore counts were calculated as described in previous examples.

The compounds 5-Caffeoylquinic acid (Chlorogenic acid) (CA), 3,5-dicaffeoylquinic acid (DCQA) and Quercetin 3-O-(6″-malonyl-glucoside) (Q) were chosen. Standards of CA (ht-tps://www.sigmaaldrich.com/catalog/product/aldrich/3878?lang=en&region=NZ) and Q (https://www.sigmaaldrich.com/catalog/product/sigma/16733?lang=en&region=US) were ordered from Sigma Alderich, and DCQA from Carbosynth (https://www.carbosynth.com/carbosynth/website.nsf/(w-productdisplay)/1DB1FA22CAF00B3C48257ECB00243A6B). Published studies on polyphenol content were used to determine a control content of iceberg/crisphead type lettuce plant as 3.78 mg/100 g FW CA (Yamaguchi et al., 2003), 0.28 mg/100 g FW DCQA (Ribas-Agusti et al., 2011) and 1.85 mg/100 g FW Q (DuPont et al., 2000). Concentrations were adjusted for leaf weight, and infiltration volume of plants at 16 days old of each of the three cultivars and dilutions of the standards made to achieve a 1.5, 2.5 and 4 times increase in El Dorado, Iceberg and Salinas plants. These fold changes were based on UV-B induced increases to levels of CA, DCQA and Q of 1.2 to 2.6 fold 4.4.3.

Syringe infiltration was adapted in this case for infiltration of phenolic compound, using a similar leaf infiltration method to Kim and Mackey (2008). Plants (16 days post sowing) were placed in a humid environment for 30 minutes to encourage stomatal opening. The oldest leaf (leaf 1) of each plant was marked for infiltration with vivid at the base of the leaf. Infiltrations were carried out by injections of either water (mock) or the compound solution using a 1 mL needless syringe into the back of the leaf at two points (one on each side of the rib). Plants were infiltrated till the entire leaf had changed color indicating entry of the liquid (approx. 0.8+/−0.1 mL). Plants were allowed to rest 17 hours (5 hours light, 12 hours dark) before inoculation. The first two repeats tested compounds CA and DCQA only. Repeat 3 tested Q only and repeat 4 tested all three compounds (CA, DCQA and Q). Trays of plants were blocked by cultivar and compound, with the compound concentrations arranged in a Latin square within each block.

Results

There was a Negative Correlation Between Spore Count and Flavonoid Accumulation in UV-B Treated Plants

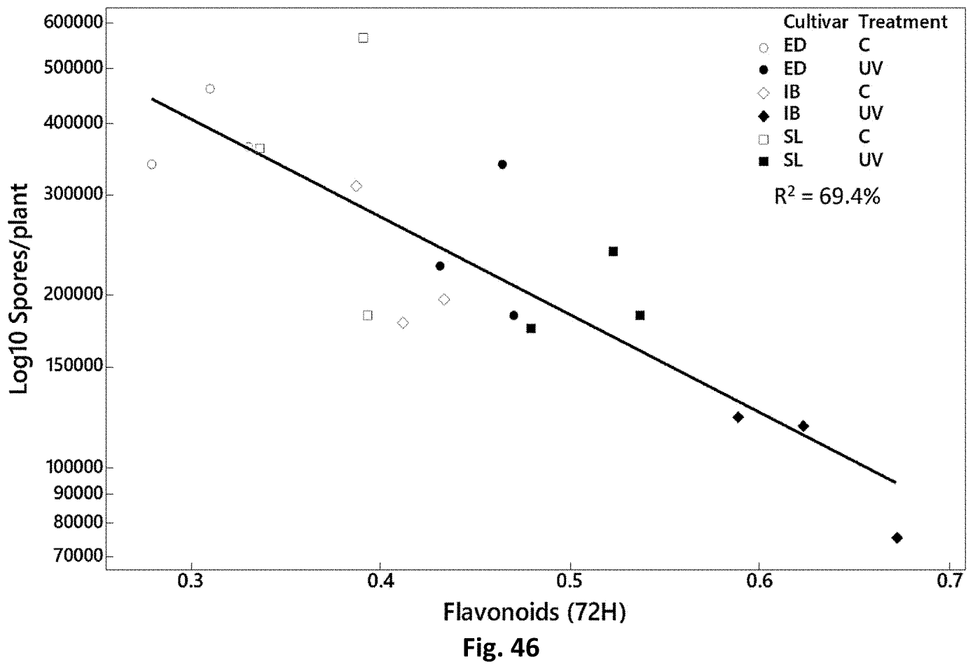

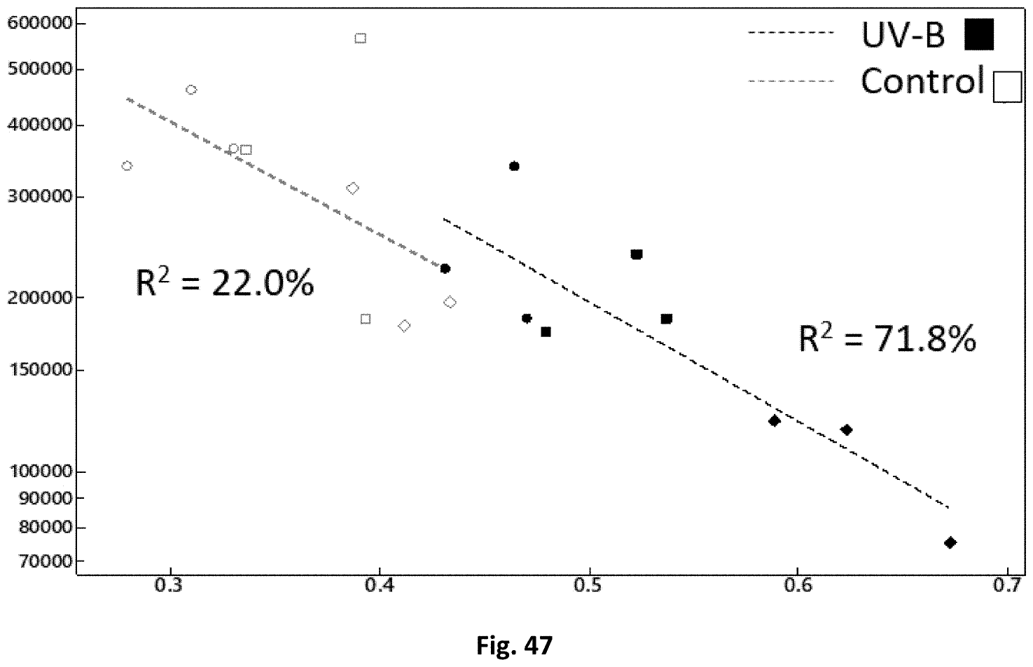

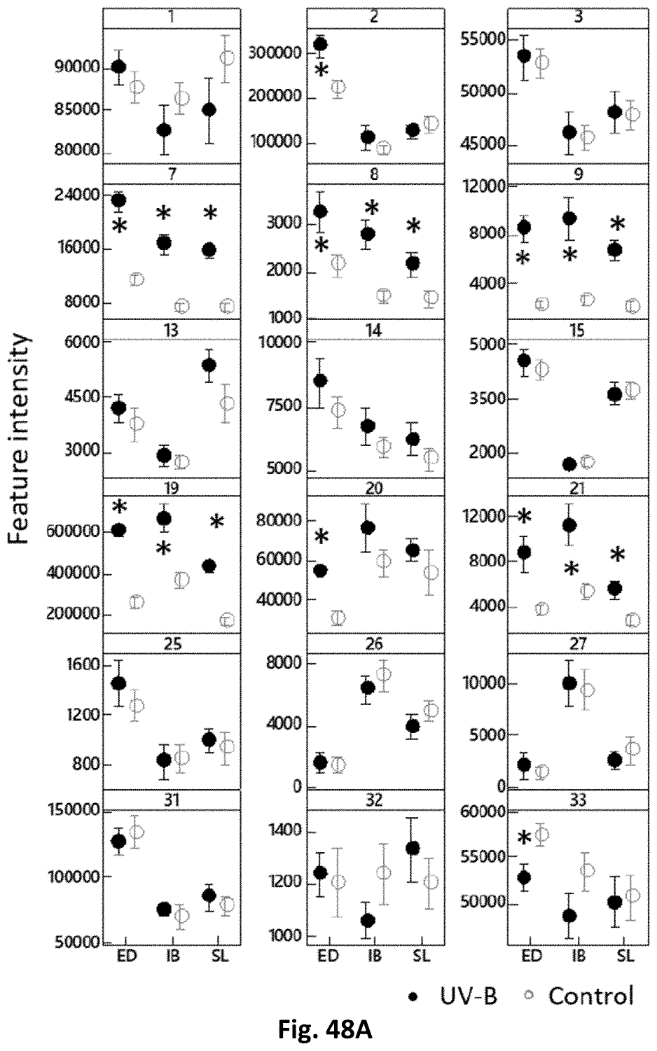

A principal component analysis (PCA) of flavonoids, chlorophyll and NBI at 72 hours and disease measuring degree of infection (DoI) at 8 and 12 days post inoculation (DPI) and spore count) was performed. FIG. 46 shows a regression analysis between the spore count and flavonoid level of infected lettuce. This regression analysis showed flavonoid level at 72 hours correlated negatively with both early (r=−0.688, p=0.002) and late (r=−0,659, p=0.003) stage sporulation ratings (DoI) as well as logiospore count (R=−0.812, p<0.0005). UV-B responsive flavonoids heavily drove this regression between logio spore count and flavonoid level. A regression analysis on control plants alone as depicted in FIG. 47 showed no significant regression (R=−0.491, p=0.180); however, on UV-B plants alone, also depicted in FIG. 47, the regression was strengthened (R=−0.844, p=0.004). The higher level of flavonoids in UV-B treated plants was attributed to UV-B responsive flavonoids.

As flavonoid levels decreased over the disease period, preformed flavonoid defenses and signals (phytoanticipins) at the point of inoculation (72 hours) was likely the key time point for a maximum UV-B induced flavonoid defense in plants. A significant negative correlation between spore count (log10) and flavonoid level was present at 24 (R=−0.680, p=0.002), 48 (R=−0.805, p<0.0001) and 96 (R=−0.756, p<0.0001) hours. At these time points, preformed phenolics were still significantly higher in UV-B than control plants of most lettuce cultivars. At time points later than 96 hours, where induced phenolics (phytoalexins) contribute to defense, the significant correlation was lost. The correlation between spore count and flavonoid level was strongest at 72 hours highlighting the importance of phytoanticipins in disease severity.

TABLE 29
Putative Identifications of Plant Foliar Secondary Metabolites, Profiled Using LC-MS

| | RT | RT | | | | Score | | Score | |
|---|---|---|---|---|---|---|---|---|---|
| Feature | LC- | LC- | M-H | | Error | (max = | | (max = | most abundant adducts |
| ID | MS1 | MS2 | M/Z | Predicted Formula | [mDa] | 5) | Predicted compound | 10) | present (m/z:adduct) |
| 1 | 0.46 | 0.48 | 304.91 | Unknown | | | Unknown | | 174.9527, 304.9147, |
| | | | | | | | | | 418.8948, 548.8559, |
| | | | | | | | | | 678.8115, 808.7748 |
| 2 | 0.54 | 0.56 | 341.12 | C12H22011 | −1.16 | 3.42 | Sucrose | 6.12 | 377.0863, 439.0882 |
| 3 | 0.61 | 0.63 | 191.02 | C6H807 | −0.37 | 3.3 | Citric acid | 6.08 | 133.0082, 421.0027, |
| | | | | | | | | | 275.0219 |
| 4 | 0.78 | 0.68 | 405.03 | C18H14095 | −0.62 | 2.69 | Unknown | | 436.9673, 383.0479, |
| | | | | | | | | | 426.9673 |
| 5 | 1.69 | 1.7 | 311.05 | C13H1209 | −0.74 | 3.11 | Caffeoyltartaric acid | 5.22 | 149.0116 (M − 162), |
| | | | | | | | | | 179.0400, |
| | | | | | | | | | 623.0938 (2M − H) |
| 6 | 2.47 | 2.63 | 353.1 | C16H1809 | −0.19 | 3.14 | Chlorogenic acid* | 5.52 | 191.0635 (M − 162), |
| | | | | | | | | | 707.1901 (2M − H), |
| | | | | | | | | | 1061.2890 (3M − H), |
| | | | | | | | | | 729.154 (2M − 2H + Na) |
| 7 | 2.88 | — | 725.13 | Unknown | | | Unknown | | 787.0558 |
| 8 | 3.01 | — | 711.14 | Unknown | | | Unknown | | |
| 9 | 3.16 | 3.12 | 353.09 | C16H1809 | −0.89 | 3.33 | Chlorogenic acid* | 5.91 | 191.0637 (M − 162) |
| 10 | 3.21 | 3.17 | 373.15 | C17H2609 | 1.71 | 3.21 | Deoxyloganin | 5.47 | |
| 11 | 3.39 | 3.31 | 431.18 | Unknown | | | Unknown | | 198.9358, 283.2703 |
| 12 | 3.65 | 3.56 | 295.05 | C13H1208 | −0.36 | 3.3 | Caffeoylmalic acid | 5.79 | 133.0152 (M − 162) |
| | | | | | | | | | 591.1070)2M − H) |
| 13 | 4.43 | 4.28 | 471.19 | C22H32011 | −1.01 | 3.12 | Possible Phenolic | | |
| | | | | | | | glycoside | | |
| 14 | 4.5 | 4.43 | 463.09 | C21H2012 | −1.3 | 3.37 | Quercetin 3-galactoside | 6.13 | 611.2421 |
| 15 | 4.67 | 4.54 | 427.2 | Unknown | | | Unknown | | |
| 16 | 4.79 | 4.98 | 473.08 | C22H18012 | −0.45 | 3.25 | Dicaffeoyltartaric acid/ | 5.43 | 311.0487 (M − 162), |
| | | | | | | | Chicoric acid | | 947.1581 (2M − H) |
| 17 | 5 | 5.09 | 477.33 | C21H18013 | −0.14 | 2.98 | Quercetin-3-Glucuronide | ** | 311.0396, 301.0363 |
| | | | | | | | (Miquelianin) | | |
| 18 | 5.09 | 5.25 | 461.07 | C21H18012 | −1.25 | 3.39 | Kaempferol | 6.06 | 923.1616 (2M − H), |
| | | | | | | | 3-glucuronide | | 311.0479, |
| | | | | | | | | | 285.0407(M − H − C6H806), |
| | | | | | | | | | 483.0544(M − 2H + Na) |
| 19 | 5.39 | 5.5 | 549.09 | C24H22015 | 0.76 | 3.13 | Quercetin 3-0 (6-malonyl)- | 5.37 | 505.0993 (M − H − 0O2), |
| | | | | | | | glucoside | | 1099.1945 (2M − H), |
| | | | | | | | | | 611.0154 (M-iospropH), |
| | | | | | | | | | 1143.12, 1122.2, |
| | | | | | | | | | 1153.103, 1396.706 |
| 20 | 5.62 | 5.7 | 515.13 | C25C24012 | −0.9 | 3.35 | 3,5-Dicaffeoylquinic acid | 5.59 | 353.0959 (M − 162), |
| | | | | | | | | | 1031.2572 (2M − H) |
| 21 | 6.16 | 6.29 | 533.09 | C24H22014 | 0.87 | ** | Luteolin 7-0 (6″ malonyl | ** | 489.1109 (M − H − 0O2) |
| | | | | | | | glucoside) | | |
| 22 | 6.91 | 6.77 | 415.18 | C20H3209 | −2.14 | 3.16 | Ethyl 7-epi-12- | 5.09 | 327.0833 |
| | | | | | | | hydroxyjasmonate | | |
| | | | | | | | glucoside | | |
| 23 | 7.54 | 7.56 | 481.12 | C25H22010 | −0.58 | 2.87 | lactucopicrin 15-oxalate | ** | 963.2419 (2M − H), |
| | | | | | | | | | 409.1382 (M − CO2CO − H), |
| 24 | 7.72 | 7.35 | 347.18 | C16H2808 | −1.86 | 3.11 | Unknown | | 257.0914 (M − 4- |
| | | | | | | | | | hydroxyphenylacetyl − H) |
| 25 | 8.21 | 8.16 | 581.17 | C30H30012 | −3.55 | 3.09 | Epicatechin 3-0- | 5.02 | |
| | | | | | | | (2-trans-cinnamoyl- | | |
| | | | | | | | beta-D-allopyranoside) | | |
| 26 | 8.71 | 8.34 | 349.19 | C16H3008 | −0.11 | 3.17 | methyl 9-(alpha-D- | 5.24 | 417.2174 |
| | | | | | | | galactosyloxy)nonanoate | | |
| 27 | 9.01 | 8.69 | 461.24 | C22H38010 | 2.52 | 3.1 | Unknown | | |
| 28 | 9.22 | 8.83 | 377.18 | Unknown | | | Unknown | | 809.2898, 1187.4960, |
| | | | | | | | | | 755.3709 (2M − H), |
| | | | | | | | | | 1177.5026, |
| | | | | | | | | | 778.3550, 291.1820, |
| | | | | | | | | | 333.1916 (M − H − 0O2), |
| | | | | | | | | | 799.2918, |
| 29 | 9.35 | 9.05 | 417.21 | C24H3406 | −3.8 | 3.07 | Unknown | | |
| 30 | 11.55 | — | 293.18 | Unknown | | | Unknown | | 236.1049, 221.1540 |
| 31 | 14.08 | 13.63 | 271.19 | Unknown | | | Unknown | | 371.1165, 565.3711, |
| | | | | | | | | | 471.0350, 199.1696 |
| 32 | 17.15 | 16.14 | 819.53 | Unknown | | | Unknown | | 836.5200, 891.4600 |
| 33 | 17.29 | 16.23 | 714.55 | C40H77N09 | 3.46 | 2.51 | Nitrogen containing lipid | | 760.5576 (M + FA − H), |
| | | | | | | | | | 777.5508 |
| | | | | | | | | | (M + CHOONH4 − H), |
| | | | | | | | | | 832.4901 |
| 34 | 17.44 | 16.45 | 959.6 | Unknown | | | Unknown | | 976.5923, 1027.5907, |
| | | | | | | | | | 1031.5367 |
| 35 | 18 | 16.66 | 821.55 | Unknown | | | Unknown | | 893.4773, 838.5316 |
| 36 | 18.39 | 17 | 837.48 | C40H72N7018P35 | −5.54 | 2.64 | Nitrogen containing lipid | | 937.4068, 905.4744, |
| | | | | | | | | | 922.4683 |

UV-B Increased the Abundance of Many Metabolic Features Present in Lettuce

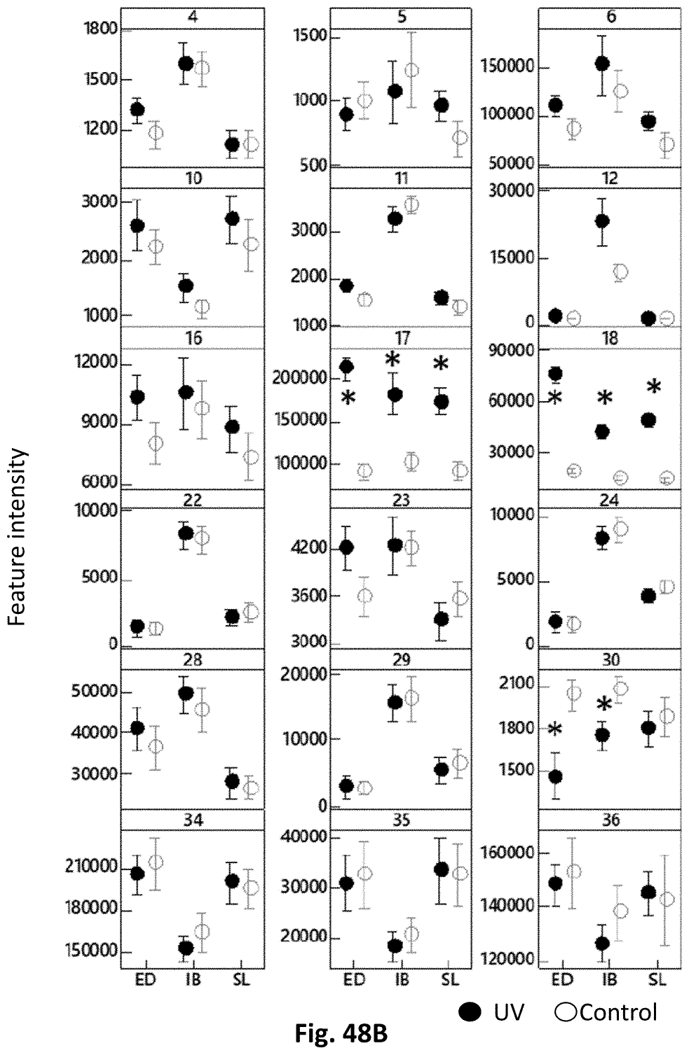

The metabolic features found in lettuce (L. sativa, cv. El Dorado, Iceberg and Salinas) were expressed at different intensities. These intensities are displayed for each feature in FIGS. 48A-48B. The most intense features, indicating the highest abundance, were feature IDs 2, 6, 17, 18, 19, 28, 31, 34, 35 and 36 (also reference Table 29). Although intensity indicates quantity, it did not indicate importance of the corresponding metabolite, as metabolites may be required in different amounts to cause a response. Following a UV-B treatment, many features (3, 4, 5, 11, 15, 22, 24, 25, 26, 27, 29, 31, and 35) experienced little or no change in feature intensity of UV-B treated compared to control lettuce plants. Many of these compounds, which were unaffected by UV-B, were altered by cultivar. Several features (6, 9, 10, 13, 18, and 28) exhibited an overall higher intensity in UV-B treated plants of each cultivar compared to control (pattern 1). Features which experienced a general UV-B increase had a range of putative identities including a phenolic acid, flavonoid, and terpene.

Other features (16, 17, 19, 20 and 21) followed a pattern of both cultivar and UV-B effect (pattern 2). Pattern 2 features had higher feature intensity in Iceberg than El Dorado and Salinas in control plants. In UV-B treated plants, all cultivars had a higher feature intensity than control plants. Putative identities of compounds, which fell into pattern 2, were all phenolic compounds including phenolic acids (chicoric acid and 3,5-Dicaffeoylquinic acid) or flavonoids (Quercetin-3-Glucuronide, Quercetin 3-O (6-malonyl)-glucoside and Luteolin 7-O (6″ malonyl glucoside)). Pattern 2 was of interest as it formed a pattern antagonistic to that of disease in which Iceberg had a lower disease severity than both El Dorado and Salinas, then following UV-B treatment, all disease was reduced. This makes features with pattern 2 quite promising in terms of negative correlations with spore count.

Another common instance (features 2, 7, 8, and 14) of combined cultivar and UV-B effect demonstrated an elevation in feature intensity in El Dorado plants, as well as increased levels of all cultivars following UV-B treatment (pattern 3). Putative identities of features which formed pattern 3 were largely unknown; however, two compounds were putatively identified as sucrose and Quercetin 3-galactoside. Although there were many features driven by both El Dorado and UV-B effect (pattern 3), as El Dorado was the most susceptible cultivar, these features did not form a pattern of interest. As increases to these features were higher in more susceptible cultivars, they were unlikely to have a role in disease defense.

UV-B resulted in the decrease of feature intensity in a number of features (30, 33, 34 and 36); however, these features were less common than UV-B up-regulation. Some features had individual cultivar characteristics and therefore did not fall into a pattern. This included increases to a feature intensity in one cultivar with no change (feature 12) or a decrease (feature 1, 23, and 32) in the others.

Several UV-B Induced Metabolites had a Strong Negative Correlation with Disease Severity

A bivariate correlation analysis was run to determine relationships between disease severity and metabolite level (as feature intensity) across all cultivars and treatments. All significant correlations (except feature ID 33) were negative indicating increases in feature intensity correlate with decreases in disease severity. The feature intensity of feature 33, however, had a positive correlation with not only spore count, but also disease ratings as DoI at early (8 DPI) and late (12 DPI) stage disease. The strongest negative correlations with spore count were at features 11, 19, and 20. Feature 11 had relatively low intensity values, with a noisy mass spectrum, so confidence in accuracy of feature values is not as strong as other feature groups. Features which correlated with spore count also tended to correlate with early and late DoI values, with the strongest correlations to sporulation rating as features 11, 22, and 24.

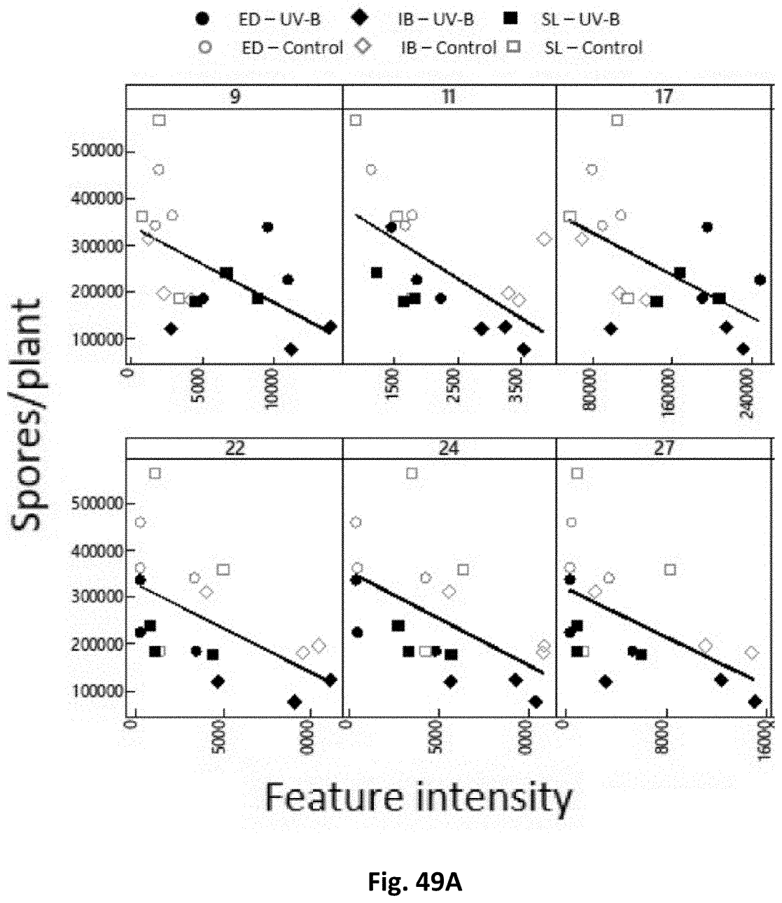

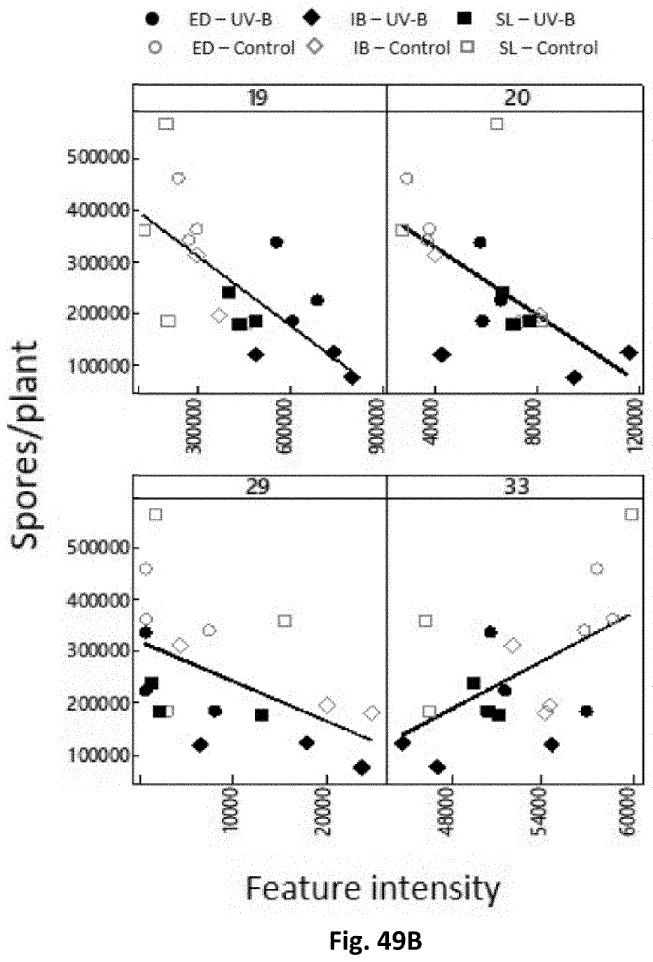

The correlation between feature intensity and spore count was plotted as linear regressions in scatter graphs as seen in FIGS. 49A-49B to determine how cultivar and treatment affected these significant correlations. Regressions of features 9, 17, and 19 (reference Table 29) were influenced by treatment. Control plants grouped in the top left due to a high spore count and low feature intensity while UV-B grouped in the bottom right with a low spore count and high feature intensity (opposite pattern for feature 33). When the two treatments were combined, this caused a strong correlation. However, when separated into treatments, several features (9, 1, and 19) lacked a correlation with spore count within control or UV-B. Other features (11, 22, 23, 24, 27, and 29) retained a significant negative correlation when only the UV-B treated plants were considered. Feature 11 regression was also influenced by cultivar effect, largely due to the high flavonoid level and low spore count of Iceberg plants. With the removal of Iceberg, correlation of feature 11 and spore count remained significant (r=−0.757, p=0.004). The equations of the linear slope were similar between all negative regressions.

The remaining features (11, 21, 23, 24, 27, 29) formed a group high in both the first and second component. These negatively correlated with disease severity (and feature 33) along the first component only and therefore were likely informative about the separation of Iceberg from the other cultivars. While these features might be important for disease defense, they were more likely to be driven by the low disease susceptibility of Iceberg plants rather than a UV-B treatment.

Several UV-B Induced Correlations Between Disease and Phenolics are Conserved Over an Increased Cultivar Range

Strong correlations between UV-B induced metabolic features and disease reduction were found over lettuce cultivars El Dorado, Iceberg and Salinas. To determine if these correlations are conserved in lettuce, an additional seven cultivars (La Brilliante, Emperor, Grand Rapids, Calicel, Greenway, Falcon, Desert Storm) underwent a similar method of UV-B treatment, metabolite analysis (LC-MS 2) and disease assessment. An additional completely resistant cultivar, Pedrola, was included to determine if UV-B affected any metabolic features key for cultivar dependent resistance. Due to time constraints, only one repeat (spread over two treatments) was completed for the additional seven cultivars. Metabolic features which negatively correlated with all 10 cultivars (LC-MS 1 and LC-MS) likely had a stronger role in a UV-B induced disease defense as are conserved across all cultivars.

Disease Severity was Affected by Cultivar and Treatment in Additional Seven Cultivars

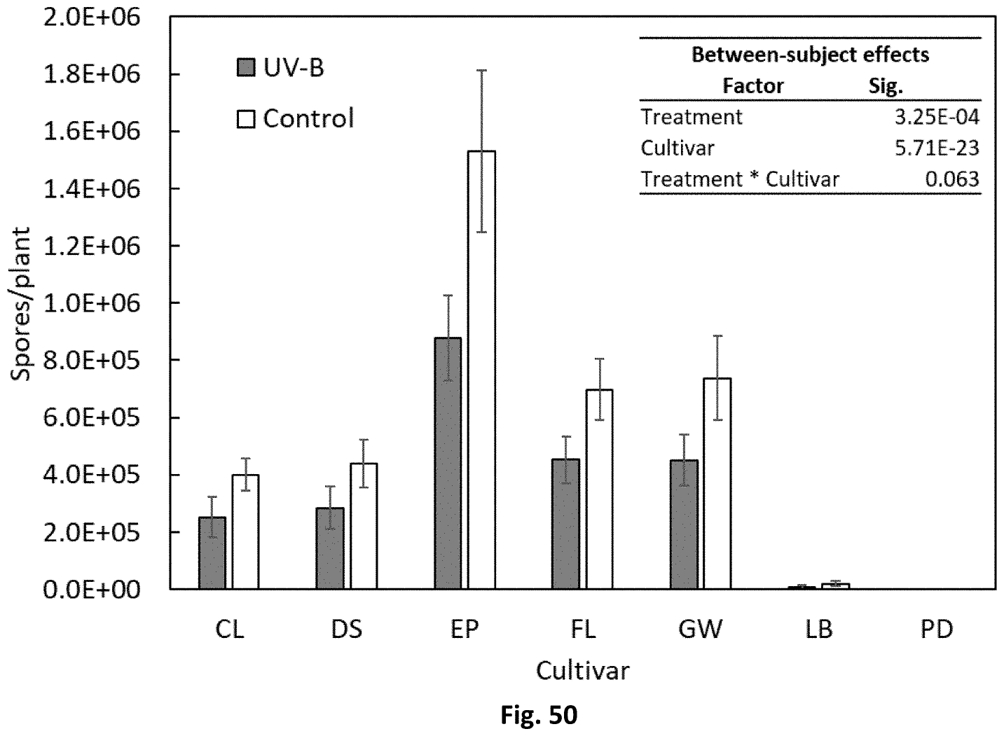

The disease severity, as calculated by spore count, in UV-B treated and untreated controls for 7 cultivars of lettuce Calicel (CL), Desert storm (DS), Emperor (EP), Falcon (FL), Greenway (GW), La Brillinate (LB), and Pedrola (PD) is depicted in FIG. 50. Disease severity (as spore count) was significantly affected by treatment (ANOVA, p<0.0001) and cultivar (ANOVA, p<0.0001). Additionally, a significant cultivar (ANOVA, p<0.0001) and treatment (ANOVA, p=0.006) effect on spore count was maintained when spore counts were analyzed per spore count.

Infiltration of UV-B Induced Phenolics Can Alter Disease Susceptibility

Phenolic compounds were identified as strongly negatively correlated with disease reduction. Three compounds (chlorogenic acid (CA), 3,5-dicaffeoylquinic acid (DCQA) and quercetin 3-O—(6, -O-malonyl)-b-D-glucoside (Q)) which had strong certainty of identification and strong disease correlations were infiltrated into lettuce cultivars El Dorado, Iceberg and Salinas. Three concentrations of each compound were used to achieve a 1.5, 2.5 or 4 fold increase in the compound compared to a standard crisphead/iceberg type lettuce plant. Following infiltration, the plants were inoculated with B. lactucae and the resulting downy mildew symptoms were assessed. These experiments attempted to link the correlations with the ability of the compound to reduce disease severity.

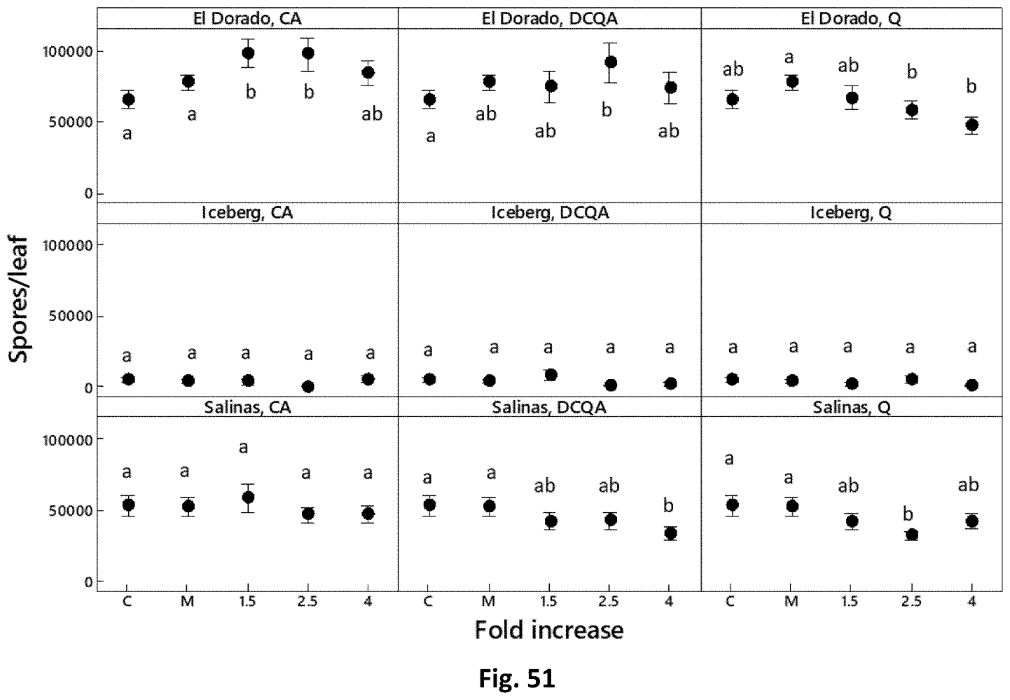

Infiltrated leaves were individually washed at 12 DPI, and the resulting spore suspension counted. As seen in FIG. 51, the spore count/leaf in three strains of lettuce (El Dorado, Iceberg, and Salinas) was compared between in leaves infiltrated with various levels of compound. Iceberg plants were unaffected by infiltration of any compound.

Infiltration with chlorogenic acid (CA) resulted in no change to leaf spore count in Iceberg and Salinas leaves regardless of concentration compared to control and mock. El Dorado leaves infiltrated with 1.5 or 2.5 fold of CA had a significantly higher leaf spore count than both control (49, 48% increase) and mock leaves (27, 26% increase) (ANOVA LSD, p<0.0005, p=0.024 respectively).

Infiltration with 3,5-dicaffeoylquinic acid (DCQA) had different effects in El Dorado than in Salinas. In El Dorado, leaves infiltrated with 2.5 fold of DCQA had higher leaf spores than in control (39% increase) but not mock. Other concentrations of DCQA in El Dorado were not significantly different. In Salinas, all infiltrations of DCQA had a reduced leaf spore count compared to control (20, 19, 37% decrease in 1.5, 2.5 and 4 fold respectively) and mock (19, 18, 36% decrease in 1.5, 2.5 and 4× respectively); however, only DCQA at a 4 fold increase was significantly lower (ANOVA LSD, control; p=0.034, mock; p=0.032). Infiltration of Salinas leaves with DCQA showed a trend of decreasing spore count with increasing DCQA concentration, where the highest level tested (4 fold increase) was the only high enough dose to result in a significant difference.

Both El Dorado and Salinas leaf counts were decreased by addition of Quercetin 3-O-(6,-O-malonyl)-b-D-glucoside (Q) at 2.5 fold compared to mock (decrease of 25% in El Dorado, 39% in Salinas) (ANOVA LSD, p=0.029, 0.024 respectively). In El Dorado, infiltration of 4 fold Q also resulted in a significant reduction of leaf spores compared to mock (ANOVA LSD, p=0.001). In El Dorado, spore count decreased with increasing Q concentration. However, in Salinas, leaf spore decrease was more of a threshold response in which a 2.5 fold increase in Q is the peak concentration for reduction of leaf spores, with lower or higher concentrations causing a lesser reduction.

Infiltration of Quercetin 3-O-(6,-O-Malonyl)-b-D-Glucoside Yields Similar Spore Count Reductions to UV-B Treatment

The UV-B treatment increased levels of chlorogenic acid (CA), 3,5- dicaffeoylquinic acid (DCQA) and Quercetin 3-O -(6,-O-malonyl)-b-D-glucoside (Q) by 1.2 to 2.6. In order to imitate this increase spread, infiltration fold increases of 1.5 and 2.5 fold were used. A fold increase of 4 was also included to indicate the effect if UV-B pretreatment could further increase the levels of these compounds. Although LC-MS indicated the relative increase of each compound by UV-B, these compounds were not increased in isolation. This means the comparison of individual phenolic changes and resulting spore count in the metabolomics data to the effect of infiltration of a singular compound (at a similar fold change to the metabolomics data) was not a direct comparison. With this limitation in mind, the infiltration of individual compounds can still provide some insight into the role the compound may have in a UV induced disease defense. As seen in Table 30, the different reductions in spore count between UV-B treated cultivars and cultivars infiltrated with a phenolic compound are listed for each compound and cultivar tested.

TABLE 30
Comparison of Decreases in Spore Count on Lettuce

| | | | | Fold increase of | | |
|---|---|---|---|---|---|---|
| | | UV-B Induced | | infiltrated compounds | | |
| | | Fold | % spore | (% mock spore count) | | |
| Cultivar | Compound | increase | count | 1.5 | 2.5 | 4 |
| El | CA | 1.3 | 65% | 127% | 126% | 109% |
| Dorado | DCQA | 1.78 | 65% | 97% | 118% | 95% |
| | Q | 2.34 | 65% | 86% | 75% | 61% |
| Salinas | CA | 1.37 | 55% | 113% | 89% | 89% |
| | DCQA | 1.24 | 55% | 81% | 82% | 64% |
| | Q | 2.62 | 55% | 80% | 61% | 81% |

Regression analysis of the metabolomics data (LC-MS1) indicated that spore count decreased as CA, DCQA and Q levels increased over all cultivars (El Dorado, Iceberg and Salinas). This suggests that these three compounds contributed to a UV-B induced disease defense. The leaf spore counts of El Dorado and Salinas alone were considered against metabolomic data in Table 30.

Higher concentrations of C (2.5 and 4 fold) resulted in a small (11%) decrease in spore count in Salinas. All concentrations of DCQA reduced leaf spore count in Salinas, with the greatest reduction at a concentration of 4 fold.

Infiltration of Q provided the most promising evidence for a role in UV-B induced disease defense. In metabolomics data, Q had the strongest negative relationship with spore count. Infiltration of Q alone at similar levels to that of a UV-B increase (2.5 fold) resulted in a decrease in spore count similar to that of a UV-B induced decrease (+/−10%) in both El Dorado and Salinas.

Infiltration data provided evidence that at levels induced by UV-B treatment, Q caused a decrease in spore count similar to that of the UV-B treatment.

In this example, various lettuce cultivars with varying flavonoid UV-B response and disease susceptibility were used to determine which phenolics including flavonoids play a role in a UV-B induced downy mildew defense using LC-MS and compound infiltration. This example demonstrated a role of UV-B induced flavonoids in a decreased disease susceptibility. This example also demonstrated that UV-B treatment is effective in increasing disease resistance across a variety of lettuce cultivars

### Example 9

### Pretreating of Seeds to Reduce Infection Rates in the Field

This example assesses the effectiveness of pre-treating seeds to improve disease resistance prior to planting in a field to reduce disease susceptibility.

Seeds are primed using PEG solution and are concurrently administered UV-B having a dose of 0 kJ m⁻² h⁻¹(control), 0.3 kJ m⁻² h⁻¹, 0.7 kJ m⁻² h⁻¹, 1.3 kJ m⁻² h⁻¹, 1.7 _{kJ m}⁻² h⁻¹, or 2.9 kJ m⁻² h⁻¹. UV-B is administered for up to 27 hours. After treatment, seeds are placed in a humidity chamber at 24° C., 50% relative humidity for 24 hours to dry. Once dried, seeds are stored in a refrigerator.

The seeds are placed on moistened filter paper in a plastic plant growth box. The box is sealed and is placed in a 15° C. controlled temperature room with a photoperiod of 14 hours. After 3 days, the seedlings are transplanted onto black tissue paper in Magenta GA7 boxes. The seedlings are then sown. A group of seeds administered UV-B are planted in a first field. A group of untreated seeds are planted in a second field. A group of seeds administered UV-B and a group of untreated seeds are planted in a third field.

After 2 weeks of growth, plants are infected with a disease. At each day from 7-10 days post inoculation, plants are sampled from each field to calculate disease measures, including spore count and disease severity. Plants derived from seeds that are pre-treated with UV-B radiation have a reduction in all disease measures compared to plants derived from untreated seeds. Furthermore, disease levels are also lower in the field containing a mixture of pre-treated plants and control plants when compared to the control field, although they are higher than in the field containing only UV-B treated plants.

As seen in this example, pre-treating seeds using UV-B radiation reduces their susceptibility to disease when planted in a field. Furthermore, this reduction in disease can improve the overall disease susceptibility of a field, even when the field includes plants that are not derived from UV-B treated seeds or seedlings.

### Example 10

### Pretreating of Seeds Using Various Doses to Reduce Infection Rates in the Field

This example assesses the effectiveness of pre-treating seeds to improve disease resistance prior to planting in a field to reduce disease susceptibility.

Seeds are primed using PEG solution and are concurrently administered UV-B having a dose of 0 kJ m⁻² h⁻¹(control), 2.6 kJ m⁻² h⁻¹, 3.6 kJ m⁻² h⁻¹, 4.1 kJ m⁻² h⁻¹, 4.8 kJ m⁻² h⁻¹, or 10.0 kJ m⁻² h⁻¹. UV-B is administered for up to 27 hours. After treatment, seeds are placed in a humidity chamber at 24° C., 50% relative humidity for 24 hours to dry. Once dried, seeds are stored in a refrigerator.

The seeds are placed on moistened filter paper in a plastic plant growth box. The box is sealed and is placed in a 15° C. controlled temperature room with a photoperiod of 14 hours. After 3 days, the seedlings are transplanted onto black tissue paper in Magenta GA7 boxes. The seedlings are then sown. A group of seeds administered UV-B are planted in a first field. A group of untreated seeds are planted in a second field. A group of seeds administered UV-B and a group of untreated seeds are planted in a third field.

After 2 weeks of growth, plants are infected with a disease. At each day from 7-10 days post inoculation, plants are sampled from each field to calculate disease measures, including spore count and disease severity. Plants derived from seeds that are pre-treated with UV-B radiation have a reduction in all disease measures compared to plants derived from untreated seeds. Furthermore, disease levels are also lower in the field containing a mixture of pre-treated plants and control plants when compared to the control field, although they are higher than in the field containing only UV-B treated plants.

As seen in this example, pre-treating seeds using UV-B radiation reduces their susceptibility to disease when planted in a field. Furthermore, this reduction in disease can improve the overall disease susceptibility of a field, even when the field includes plants that are not derived from UV-B treated seeds.

### Example 11

### Pretreating of Seedlings to Reduce Infection Rates in the Field

This example assesses reduction of infection rates in the field when seedlings are pretreated using UV-B.

Two-week-old seedlings are treated with a moving LED array (52.8 mm/s). Seedlings are treated using UV-B for three days with a 10 hour photo period in a growth chamber with a temperature of 17° C. Background lighting (PAR) is supplied by overhead stationary red and blue LEDs (100 μmol m⁻² s⁻¹). Control seedlings receive PAR from overhead stationary red and blue LEDs (100 μmol m⁻² s⁻¹) only. Seedlings are treated with UV-B for a period of three or seven days with a photo period of 16 hours under standard glasshouse conditions.

A group of seedlings administered UV-B are planted in a first field. A group of control seedlings are planted in a second field. A group of seedlings administered UV-B and a group of control seedlings are planted in a third field.

After 2 weeks of growth, plants are infected with a disease. At each day from 7-10 days post inoculation, plants are sampled from each field to calculate disease measures, including spore count and disease severity. Plants derived from seedlings that are pre-treated with UV-B radiation have a reduction in all disease measures compared to plants derived from control seedlings. Furthermore, disease levels are also lower in the field containing a mixture of pre-treated seedlings and control seedlings when compared to the control field, although they are higher than in the field containing only UV-B treated plants.

This example shows that pre-treating seedlings using UV-B radiation reduces their susceptibility to disease when planted in a field. Furthermore, this reduction in disease can improve the overall disease susceptibility of a field, even when the field includes plants that are not derived from UV-B treated seedlings.

### Example 12

### Analyzing Phenolic Levels in Seeds to Identify Disease Resistant Plants

This example assesses the effectiveness of pre-treating seeds to identify plants that will be disease resistant prior to planting in a field.

Seeds are primed using PEG solution and are concurrently administered UV-B having a dose of 0 kJ m⁻² h⁻¹(control), 1.3 kJ m⁻² h⁻¹, 1.7 kJ m⁻² h⁻¹, 2.9 kJ m⁻² h⁻¹, 2.6 kJ m⁻² h⁻¹, 3.6 kJ m⁻² h⁻¹, 4.1 kJ m⁻² h⁻¹, or 4.8 kJ m⁻² h⁻¹. UV-B is administered for up to 27 hours. After treatment, seeds are placed in a humidity chamber at 24° C., 50% relative humidity for 24 hours to dry. Once dried, seeds are stored in a refrigerator.

Metabolites from a subset of seeds from UV-B treated seeds are measured using a dualex. Various metabolites including sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), and methyl 9-(alpha-D-galactosyloxy)nonanoate are measured. The flavonoid index is also determined. Seeds that exhibit an increase in at least 30% of metabolites measured and flavonoid index are chosen for subsequent sowing in a field.

Plants grown in the field from UV-B treated seeds having increase metabolite expression or levels exhibit a greater reduction in disease including disease incidence and disease severity as compared to plants grown from control seeds.

This example shows that expression or levels of metabolites indicate disease susceptibility and can be used to identify disease resistant plants.

### Example 13

### Analyzing Phenolic Levels in Seedlings to Identify Disease Resistant Plants

This example assesses using metabolite levels including phenolic compounds to identify disease resistant seedlings for planting. This decreases the overall disease susceptibility of the plants in a field.

Lettuce (Lactuca sativa) plants are sown into black plastic trays with a cell size of 3 cm⁻². Following sowing, a single layer of grade 3 medium vermiculite (Auspari pty LTD, NSW) is spread over the tray. Sown trays are misted with water then placed in darkness at 14° C. for 48 hours for vernalization. Following vernalization, plants are moved to a controlled temperature room (CTR) and grown for 14 days. The CTR had a temperature of 17° C., and a 10 hour photoperiod supplied by 215 μmol m⁻² s⁻¹ white light from FL58W/965 super daylight deluxe fluorescent tubes (Slyvania Premium Extra, China). Water is applied daily to capillary matting underneath the trays.

Light treatments are applied through the use of a stationary LED array. Two-week-old CTR grown plants are treated with 215 μmol m⁻² s⁻¹ of PAR light through red and blue LEDs plus either 0.5 μmol m⁻² s⁻¹ UV-B light or no UV-B light (control) for a photoperiod of 10 hours for three days. Following light treatments, plants are allowed 14 hours recovery time in darkness.

Metabolites from a subset of plants from UV-B treated seedlings are measured using a dualex. Various metabolites including sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), and methyl 9-(alpha-D-galactosyloxy)nonanoate are measured. The flavonoid index is also determined. Plants that exhibit an increase in at least 30% of metabolites measured and flavonoid index are chosen for subsequent sowing in a field.

Plants grown in the field from UV-B treated seedlings having an increase in metabolite expression or levels exhibit a greater reduction in disease including disease incidence and disease severity as compared to plants grown from control seedlings.

This example shows that expression or levels of metabolites indicate disease susceptibility and can be used to identify disease resistant plants.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What we claim is:

1. A method for reducing disease in a crop, comprising:
administering light enriched for UV-B to a seed or seedling at least 1 day prior to disease exposure, wherein a dose of UV-B is administered in a range of about 0.1 kJ m⁻² h⁻¹ to about 20 kJ m⁻² h⁻¹; and wherein disease incidence, symptoms of disease, disease severity, disease damage, or combinations thereof is reduced by at least about 5%.

2. The method of claim 1, further comprising concurrently priming the seed using a priming medium and administering the light enriched for the UV-B.

3. The method of claim 2, wherein the priming medium is water, polyethylene glycol, or a combination thereof.

4. The method of any one of claims 1 to 3, wherein the light enriched for UV-B comprises a wavelength in a range of about 280 nm to about 290 nm.

5. The method of claim 1, wherein the light enriched for UV-B comprises a wavelength peaking at 280 nm.

6. The method of claim 1, wherein the light enriched for UV-B comprises a wavelength peaking at 300 nm.

7. The method of claim 1, wherein the dose of UV-B is in a range of about 0.3 kJ m⁻² h⁻¹ to about 3.0 kJ m⁻² h⁻¹.

8. The method of claim 1, wherein the dose of UV-B is in a range of about 2.0 kJ m⁻² h⁻¹ to about 12.0 kJ m⁻² h⁻¹.

9. The method of claim 1, wherein the dose of UV-B is in a range of about 0.1 kJ m⁻² h⁻¹ to about 1.0 kJ m⁻² h⁻¹.

10. The method of claim 1, wherein the dose of UV-B is about 0.1 kJ m⁻² h⁻¹, about 0.2 kJ m⁻² h⁻¹, about 0.3 kJ m⁻² h⁻¹, about 0.4 kJ m⁻² h⁻¹, about 0.5 kJ m⁻² h⁻¹, about 0.6 kJ m⁻² h⁻¹, about 0.7 kJ m⁻² h⁻¹, about 0.8 kJ m⁻² h⁻¹, about 0.9 kJ m⁻² h⁻¹, or about 1.0 kJ m⁻² h⁻¹.

11. The method of claim 1, wherein the light enriched for UV-B comprises a dose of UV-B in a range of about 2 kJ m⁻² d⁻¹ to about 10 kJ m⁻² d⁻¹.

12. The method of claim 1, wherein the light enriched for UV-B comprises a dose of UV-B in a range of about 1.2 kJ m⁻² d⁻¹ to about 7 kJ m⁻² d⁻¹.

13. The method of any one of claims 1 to 12, wherein a duration of administering UV-B is at least 10 hours, at least 15 hours, at least 20 hours, at least 25 hours, or at least 30 hours.

14. The method of any one of claims 1 to 12, wherein a duration of administering UV-B is at least 1 day or at least 14 days.

15. The method of any one of claims 1 to 12, wherein a duration of administering UV-B is about 1 day, about 2 days, about 3 days, about 4 days, about 5 days, about 6 days, or about 7 days.

16. The method of claim 1, wherein a photoperiod of the light administered is 10 hours.

17. The method of claim 1, wherein the light enriched for UV-B is administered at least 2 days, 3 days, 4 days, 5 days, 6 days, 7 days, 8 days, 9 days, or 10 days prior to the disease exposure.

18. The method of claim 1, wherein the disease incidence, symptoms of disease, disease severity, disease damage, or combinations thereof is reduced by at least about 10%, at least about 15%, at least about 30%, at least about 50%, or at least about 80%.

19. The method of claim 1, wherein sporulation is reduced, number of spores released is reduced, or a combination thereof.

20. The method of claim 19, wherein the sporulation, the number of spores released, or the combination thereof is reduced by at least about 10%, at least about 15%, at least about 30%, at least about 50%, or at least about 80%.

21. The method of claim 1, wherein the disease incidence is reduced at least 1 day, 2 days, 3 days, 4 days, 5 days, 6 days, 7 days, 8 days, 9 days, 10 days, 11 days, 12 days, 13 days, or 14 days post exposure.

22. The method any one of claims 1 to 21, wherein the disease is caused by a bacterium, insect pathogen, or combinations thereof.

23. The method of claim 1, wherein the disease exposure occurs after the seed is sown.

24. The method of claim 1, wherein administering light enriched for UV-B induces an increase in expression of one or more metabolites.

25. The method of claim 24, wherein the one or more metabolites is a phenolic compound.

26. The method of claim 24, wherein the one or more metabolites is a flavonoid.

27. The method of claim 24, wherein the one or more metabolites is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), methyl 9-(alpha-D-galactosyloxy)nonanoate, or combinations thereof.

28. The method of claim 24, wherein the one or more metabolites is quercetin 3-O (6-malonyl)-glucoside, kaempferol-3 glucuronide, 1,3 dicaffeolyquinic acid, or chlorogenic acid.

29. A method for reducing disease propagation from a first plant to a second plant, comprising:
a) administering light enriched for UV-B to a first plant material;
b) administering light enriched for UV-B to a second plant material;
c) sowing the first plant material; and
d) sowing the second material in proximity to the first plant material, wherein the disease propagation between the first plant to the second plant is reduced by at least 50%.

30. A method for improving subsequent plant performance, comprising:
determining whether a plant material will be susceptible to disease by:
obtaining or having obtained the plant material, wherein the plant material is administered light enriched for UV-B; and
performing or having performed an assay on the plant material to determine expression of one or more metabolites; and
if the plant material has expression of the one or more metabolites above a threshold expression of the one or more metabolites derived from a cohort of plant material not administered light enriched for UV-B, then sowing the plant material.

31. The method of claim 29 or 30, wherein the plant material is a seed or seedling.

32. The method of any one of claims 30 to 31, wherein the one or more metabolites is a phenolic compound.

33. The method of any one of claims 30 to 31, wherein the one or more metabolites is a flavonoid.

34. The method of any one of claims 30 to 31, wherein the one or more metabolites is sucrose, citric acid, caffeoyltartaric acid, chlorogenic acid, deoxyloganin, caffeoylmalic acid, phenolic glycoside, quercetin 3-galactoside, dicaffeoyltartaric acid, quercetin-3-glucuronide, kaempferol 3-glucuronide, quercetin 3-0 (6-malonyl)-glucoside, 3,5-dicaffeoylquinic acid, luteolin 7-0 (6″ malonyl glucoside), ethyl 7-epi-12-hydroxyjasmonate glucoside, lactucopicrin 15-oxalate, epicatechin 3-0-(2-trans-cinnamoyl-beta-D-allopyranoside), methyl 9-(alpha-D-galactosyloxy)nonanoate, or combinations thereof.

35. The method of any one of claims 30 to 31, wherein the one or more metabolites is quercetin 3-O (6-malonyl)-glucoside, kaempferol-3 glucuronide, 1,3 dicaffeolyquinic acid, or chlorogenic acid.

36. The method of claim 30, wherein the threshold expression is a percentage increase in the expression of the one or more metabolites as compared to the one or more metabolites derived from a cohort of plant material not administered light enriched for UV-B.

37. The method of claim 36, wherein the percentage increase is at least 30%.

38. The method of claim 30, wherein the threshold expression is a flavonoid index.

39. The method of claim 29 or 30, wherein the light enriched for UV-B comprises a wavelength in a range of about 280 nm to about 290 nm.

40. The method of claim 29 or 30, wherein the light enriched for UV-B comprises a wavelength peaking at 280 nm.

41. The method of claim 29 or 30, wherein the light enriched for UV-B comprises a wavelength peaking at 300 nm.

42. The method of claim 29 or 30, wherein a dose of UV-B is in a range of about 0.1 kJ m⁻² h⁻¹ to about 20 kJ m⁻² h⁻¹.

43. The method of claim 29 or 30, wherein a duration of administering UV-B is at least 10 hours, at least 15 hours, at least 20 hours, at least 25 hours, or at least 30 hours.

44. The method of claim 29 or 30, wherein a duration of administering UV-B is in a range of about 1 day, about 2 days, about 3 days, about 4 days, about 5 days, about 6 days, or about 7 days.

45. The method of claim 29 or 30, wherein the light enriched for UV-B comprises a dose of UV-B in a range of about 1.2 kJ m⁻² d⁻¹ to about 7 kJ m⁻² d⁻¹.

46. The method of claim 29 or 30, wherein a photoperiod of the light administered is 10 hours.

47. The method of claim 29 or 30, wherein the light comprises blue light, red light, or a combination thereof.

48. The method of claim 29 or 30, wherein the plant performance comprises reduction in disease incidence, reduction in symptoms of disease, reduction in disease severity, reduction in disease damage, or combinations thereof.

49. The method of claim 48, wherein the reduction in disease incidence, reduction in symptoms of disease, reduction in disease severity, reduction in disease damage, or combinations thereof comprises a reduction by at least about 5%, at least about 10%, at least about 15%, at least about 30%, at least about 50%, or at least about 80%.

50. The method of claim 29 or 30, wherein the disease is caused by a bacterium, insect, pathogen, or combinations thereof.
